(19) United States
(12) Patent Application Publication
(10) Pub. No.: US 2019/0082696 A1
(43) Pub. Date: Mar. 21, 2019

(54) METHOD FOR CONTROLLING PESTS OF PLANTS

(71) Applicant: BASF SE, Ludwigshafen am Rhein (DE)

(72) Inventors: Pascal BINDSCHAEDLER, Roemerberg (DE); Karsten KOERBER, Eppelheim (DE); Henricus Maria Martinus BASTIAANS, Neustadt (DE); Jochen DIETZ, Karlsruhe (DE); Wolfgang VON DEYN, Neustadt (DE); Juergen LANGEWALD, Mannheim (DE); Franz-Josef BRAUN, Durham, NC (US)

(21) Appl. No.: 16/083,265

(22) PCT Filed: Mar. 1, 2017
(86) PCT No.: PCT/EP2017/054732

§ 371 Date: Sep. 7, 2018

(30) Foreign Application Priority Data
Mar. 11, 2016 (EP) 16159865.1

(51) Int. Cl. A01N 43/90; A01N 53/00

(52) U.S. Cl. CPC A01N 43/90; A01N 53/00

(57) ABSTRACT

A method for controlling pests of plants comprises the step of contacting the plant, parts of it, its propagation material, the pests, their food supply, habitat or breeding grounds with one or more compounds of formula I

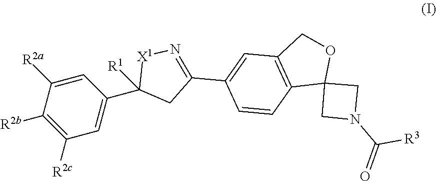

wherein the variables are defined as given in the description and claims.

The invention relates to a method for controlling pests of plants, comprising the step of contacting the plant, parts of it, its propagation material, the pests, their food supply, habitat or breeding grounds with one or more compounds of formula I

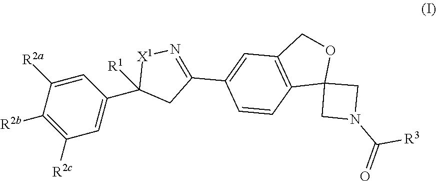

wherein
X¹ is O or CH₂;
R¹ halomethyl;
R^{2a} halogen, halomethyl, or halomethoxy;
R^{2b}, R^{2c} are independently H, or as defined for R^{2a};
R³ is selected from H, C₁-C₆-alkyl, C₁-C₆-haloalkyl, C₂-C₆-alkenyl, C₂-C₆-haloalkenyl, C₂-C₆-alkynyl, C₂-C₆-haloalkynyl which aliphatic groups are unsubstituted or substituted by one or more radicals R³¹; C₃-C₆-cycloalkyl, C₃-C₆-halocycloalkyl which cyclic groups are unsubstituted or substituted by one or more radicals R³²; C(═O)N(R³³)R³⁴, N(R³³)R³⁵, C(R³³)═NOR³⁵, C(R³³)═NN(R³³)C(=T)N(R³³)R³⁵; phenyl, 3- to 12-membered heterocyclyl, or hetaryl which rings are unsubstituted or partially or fully substituted by R^{A};
   T is O, or S;
   R³¹ is independently OH, cyano, C₁-C₆-alkoxy, C₁-C₆-haloalkoxy, S(O)ₙ—C₁-C₆-alkyl, S(O)ₙ—C₁-C₆-haloalkyl, C(═O)N(R³³)R³⁴, C(R³³)═NOR³⁵, C₃-C₆-cycloalkyl, or C₃-C₆-halocycloalkyl which cycles are unsubstituted or substituted by one or more R³¹¹; or phenyl, 3- to 12-membered heterocyclyl or hetaryl which rings are unsubstituted or partially or fully substituted by R^{A};
   R³¹ is independently OH, cyano, C₁-C₂-alkyl, or C₁-C₂-haloalkyl;
   R³² C₁-C₆-alkyl, C₁-C₆-haloalkyl, or a group as defined for R³¹;
   R³³ is H, or C₁-C₆-alkyl,
   R³⁴ is H, C₁-C₆-alkyl, C₁-C₆-haloalkyl, C₂-C₆-alkenyl, C₂-C₆-haloalkenyl, C₂-C₆-alkynyl, C₂-C₆-haloalkynyl, or C₃-C₆-cycloalkyl, C₃-C₆-halocycloalkyl, C₃-C₆-cycloalkylmethyl, or C₃-C₆-halocycloalkylmethyl which rings are unsubstituted or substituted by a cyano;
   R³⁵ H, C₁-C₆-alkyl, C₁-C₆-haloalkyl, C₂-C₄-alkenyl, C₂-C₄-alkynyl, CH₂—CN, C₃-C₆-cycloalkyl, C₃-C₆-halocycloalkyl, C₃-C₆-cycloalkylmethyl, C₃-C₆-halocycloalkylmethyl, phenyl, hetaryl, and hetarylmethyl which aromatic rings are unsubstituted or partially or fully substituted by R^{A};
   R^{A} is independently selected from halogen, cyano, NO₂, C₁-C₄-alkyl, C₁-C₄-haloalkyl, C₂-C₄-alkenyl, C₂-C₄-haloalkenyl, C₂-C₄-alkynyl, C₂-C₄-haloalkynyl, C₃-C₆-cycloalkyl, C₃-C₆-halocycloalkyl, C₁-C₄-alkoxy, C₁-C₄-haloalkoxy, S(O)ₙ—C₁-C₄-alkyl, S(O)ₙ—C₁-C₄-haloalkyl, C₁-C₄-alkylcarbonyl, C₁-C₄-haloalkylcarbonyl, C(═O)N(R³³)R³⁴; or
   two R^{A} present on the same carbon atom of a saturated or partially saturated ring may form together ═O or ═S; or
   two R^{A} present on the same S or SO ring member of a heterocyclic ring may together form a group ═N(C₁-C₆-alkyl), ═NO(C₁-C₆-alkyl), ═NN(H)(C₁-C₆-alkyl) or ═NN(C₁-C₆-alkyl)₂;
      and the N-oxides, stereoisomers and agriculturally acceptable salts thereof.
      The above compounds can be used in pure form or as mixtures.

Further embodiments of the present invention can be found in the claims, the description and the examples. It is to be understood that the features mentioned above and those still to be illustrated below of the subject matter of the invention can be applied not only in the respective given combination but also in other combinations without leaving the scope of the invention.

The compounds of formula I can be prepared by methods disclosed in WO 2012/120399 and WO 2014/039489.

Some of the compounds of formula I and their animal health effects are disclosed in WO 2012/120399, WO 2014/039489, and WO 2014/039422.

None of these prior art documents discloses an acceptable efficacy of compounds of formula I against pests of plants and propagation material from the infestation by pests.

It has now been found that compounds of formula I provide an efficient control against pests of plants. These compounds therefore represent an important solution for controlling pests of crops and propagation material from the infestation by pests, particularly where the pests are resistant to current methods.

Accordingly, in one aspect of the invention there is provided a method for controlling pests of plants, comprising the step of contacting the plant, parts of it, its propagation material, the pests, their food supply, habitat or breeding grounds with one or more compounds of formula I.

In a further aspect of the invention there is provided a method for controlling pests of plants, comprising the step of contacting the pests, their food supply habitat and/or breeding ground with one or more compounds of formula I and mixtures comprising compounds of formula I.

In further aspects, the present invention relates to an agricultural composition comprising at least one compound of formula I. In still further aspects, the present invention relates to a method for combating or controlling invertebrate pests and to a method for protecting growing plants from attack or infestation by invertebrate pests.

In a further aspect of the invention there is provided the use of one or more compounds of formula I for controlling pests in crops.

In yet a further aspect of the invention there is provided the use of one or more compounds of formula I for controlling pests of plants.

The compounds of formula (I) may exist in different geometric or optical isomers or tautomeric forms. This invention covers the use of all such isomers and tautomers and mixtures thereof in all proportions as well as isotopic forms such as deuterated compounds.

The compounds of formula I may contain one or more asymmetric carbon atoms.

If the synthesis of compounds of formula I yields mixtures of isomers, a separation is generally not necessarily required since in some cases the individual isomers can be interconverted during work-up for use or during application (for example under the action of light, acids or bases). Such conver-sions may also take place after use, for example in the treatment of plants in the treated plant, or in the harmful fungus to be controlled.

As already indicated above, the compounds of formula I may be present in the form of different structural isomers depending on the position of R¹. The present invention relates to every possible structural isomer as indicated in the compounds of formula I, and mixtures thereof.

Depending on the substitution pattern, the compounds according to the invention may have one or more centers of chirality, in which case they are present as mixtures of enantiomers or diastereomers. The invention provides both the single pure enantiomers or pure diastereomers of the compounds according to the invention, and their mixtures and the use according to the invention of the pure enantiomers or pure diastereomers of the compounds according to the invention or their mixtures. Suitable compounds according to the invention also include all possible geometrical stereoisomers (cis/trans isomers) and mixtures thereof. Cis/trans isomers may be present with respect to an alkene, carbon-nitrogen double-bond or amide group. The term “stereoisomer(s)” encompasses both optical isomers, such as enantiomers or diastereomers, the latter existing due to more than one center of chirality in the molecule, as well as geometrical isomers (cis/trans isomers). The present invention relates to every possible stereoisomer of the compounds of formula I, i.e. to single enantiomers or diastereomers, as well as to mixtures thereof.

The compounds of formula I may be amorphous or may exist in one or more different crystalline states (polymorphs) which may have different macroscopic properties such as stability or show different biological properties such as activities. The present invention relates to amorphous and crystalline compounds according to the invention, mixtures of different crystalline states of the respective compounds according to the invention, as well as amorphous or crystalline salts thereof.

Salts of the compounds according to the invention are agriculturally acceptable salts. They can be formed in a customary manner, e.g. by reacting the compound with an acid of the anion in question if the compounds according to the invention have a basic functionality or by reacting acidic compounds according to the invention with a suitable base.

Agriculturally useful salts of the compounds according to the invention encompass especially the acid addition salts of those acids whose cations and anions, respectively, have no adverse effect on the pesticidal action of the compounds according to the invention.

Suitable cations are in particular the ions of the alkali metals, preferably Li, Na and K, of the alkaline earth metals, preferably Ca, Mg and Ba, and of the transition metals, preferably Mn, Cu, Zn and Fe, and also ammonium (NH₄⁺) and substituted ammonium in which one to four of the H atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethyl-ammonium, bis(2-hydroxyethyl)ammonium, benzyltrimethylammonium and benzyltriethylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting compounds according to the invention with an acid of the corresponding anion, preferably of hydrochloric acid, hydrobromic acid, sulfuric acid, phosphoric acid or nitric acid.

The term “N-oxide” includes any compound of the present invention which has at least one tertiary nitrogen atom that is oxidized to an N-oxide moiety.

The term “halogen” denotes in each case fluorine, bromine, chlorine or iodine, in particular fluo-rine, chlorine or bromine.

The term “alkyl” as used herein and in the alkyl moieties of alkylamino, alkylcarbonyl, alkylthio, alkylsulfinyl, alkylsulfonyl and alkoxyalkyl denotes in each case a straight-chain or branched alkyl group having usually from 1 to 10 carbon atoms, frequently from 1 to 6 carbon atoms, preferably 1 to 4 carbon atoms, more preferably from 1 to 3 carbon atoms. Examples of an alkyl group are methyl, ethyl, n-propyl, iso-propyl, n-butyl, 2-butyl, iso-butyl, tert-butyl, n-pentyl, 1-methylbutyl, 2 methylbutyl, 3 methylbutyl, 2,2-di¬methylpropyl, 1 ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethyl¬butyl, 1,2-dimethylbutyl, 1,3-dimethyl¬butyl, 2,2-dimethylbutyl, 2,3-dimethylbutyl, 3,3-dimethyl¬butyl, 1-ethylbutyl, 2-ethylbutyl, 1,1,2-trimethylpropyl, 1,2,2-trimethylpropyl, 1-ethyl-1-methyl¬propyl, and 1-ethyl-2-methylpropyl.

The term “haloalkyl” as used herein and in the haloalkyl moieties of haloalkylcarbonyl, haloalkoxycarbonyl, haloalkylthio, haloalkylsulfonyl, haloalkylsulfinyl, haloalkoxy and haloalkoxyalkyl, denotes in each case a straight-chain or branched alkyl group having usually from 1 to 10 carbon atoms, frequently from 1 to 6 carbon atoms, preferably from 1 to 4 carbon atoms, wherein the hydrogen atoms of this group are partially or totally replaced with halogen atoms. Preferred haloalkyl moieties are selected from C₁-C₄-halo¬alkyl, more preferably from C₁-C₃-haloalkyl or C₁-C₂-haloalkyl, in particular from C₁-C₂-fluoroalkyl such as fluoromethyl, difluoromethyl, trifluoromethyl, 1-fluoroethyl, 2-fluoroethyl, 2,2 difluoroethyl, 2,2,2-trifluoroethyl, pentafluoroethyl, and the like.

The term “alkoxy” as used herein denotes in each case a straight-chain or branched alkyl group which is bonded via an oxygen atom and has usually from 1 to 10 carbon atoms, frequently from 1 to 6 carbon atoms, preferably 1 to 4 carbon atoms. Examples of an alkoxy group are methoxy, ethoxy, n-propoxy, iso-prop-oxy, n-butyloxy, 2-butyloxy, iso-butyloxy, tert.-butyloxy, and the like.

The term “alkoxyalkyl” as used herein refers to alkyl usually comprising 1 to 10, frequently 1 to 4, preferably 1 to 2 carbon atoms, wherein 1 carbon atom carries an alkoxy radical usually comprising 1 to 4, preferably 1 or 2 carbon atoms as defined above. Examples are CH₂OCH₃, CH₂—OC₂H₅, 2-(methoxy)ethyl, and 2-(ethoxy)ethyl.

The term “haloalkoxy” as used herein denotes in each case a straight-chain or branched alkoxy group having from 1 to 10 carbon atoms, frequently from 1 to 6 carbon atoms, preferably 1 to 4 carbon atoms, wherein the hydrogen atoms of this group are partially or totally replaced with halogen atoms, in particular fluorine atoms. Preferred haloalkoxy moieties include C₁-C₄-haloalkoxy, in particular C₁-C₂-fluoroalkoxy, such as fluoromethoxy, difluoromethoxy, trifluoromethoxy, 1 fluoroethoxy, 2-fluoroethoxy, 2,2 difluoroethoxy, 2,2,2-trifluoroethoxy, 2-chloro-2-fluoroethoxy, 2-chloro-2,2-difluoro-ethoxy, 2,2dichloro-2-fluorethoxy, 2,2,2-trichloroethoxy, penta¬fluoroethoxy and the like.

The term “alkylthio “(alkylsulfanyl: —S-alkyl)” as used herein refers to a straight-chain or branched saturated alkyl group having 1 to 10 carbon atoms, preferably 1 to 4 carbon atoms (═C₁-C₄-alkylthio), more preferably 1 to 3 carbon atoms, which is attached via a sulfur atom.

The term “haloalkylthio” as used herein refers to an alkylthio group as mentioned above where-in the hydrogen atoms are partially or fully substituted by fluorine, chlorine, bromine and/or iodine.

The term “alkylsulfinyl” (alkylsulfoxyl: —S(═O)—C₁-C₆-alkyl), as used herein refers to a straight-chain or branched saturated alkyl group (as mentioned above) having 1 to 10 carbon atoms, preferably 1 to 4 carbon atoms (═C₁-C₄-alkylsulfinyl), more preferably 1 to 3 carbon atoms bonded through the sulfur atom of the sulfinyl group at any position in the alkyl group.

The term “haloalkylsulfinyl” as used herein refers to an alkylsulfinyl group as mentioned above wherein the hydrogen atoms are partially or fully substituted by fluorine, chlorine, bromine and/or iodine.

The term “alkylsulfonyl” (—S(═O)₂-alkyl) as used herein refers to a straight-chain or branched saturated alkyl group having 1 to 10 carbon atoms, preferably 1 to 4 carbon atoms (═C₁-C₄-alkylsulfonyl), preferably 1 to 3 carbon atoms, which is bonded via the sulfur atom of the sulfonyl group at any position in the alkyl group.

The term “haloalkylsulfonyl” as used herein refers to an alkylsulfonyl group as mentioned above wherein the hydrogen atoms are partially or fully substituted by fluorine, chlorine, bromine and/or iodine.

The term “alkylcarbonyl” refers to an alkyl group as defined above, which is bonded via the carbon atom of a carbonyl group (C═O) to the remainder of the molecule.

The term “haloalkylcarbonyl” refers to an alkylcarbonyl group as mentioned above, wherein the hydrogen atoms are partially or fully substituted by fluorine, chlorine, bromine and/or iodine.

The term “alkoxycarbonyl” refers to an alkylcarbonyl group as defined above, which is bonded via an oxygen atom to the remainder of the molecule.

The term “haloalkoxycarbonyl” refers to an alkoxycarbonyl group as mentioned above, wherein the hydrogen atoms are partially or fully substituted by fluorine, chlorine, bromine and/or iodine.

The term “alkenyl” as used herein denotes in each case a singly unsaturated hydrocarbon radical having usually 2 to 10, frequently 2 to 6, preferably 2 to 4 carbon atoms, e.g. vinyl, allyl (2-propen-1-yl), 1-propen-1-yl, 2 propen-2-yl, methallyl (2-methylprop-2-en-1-yl), 2-buten-1-yl, 3-buten-1-yl, 2-penten-1-yl, 3-penten-1-yl, 4-penten-1-yl, 1-methylbut-2-en-1-yl, 2-ethylprop-2-en-1-yl and the like.

The term “haloalkenyl” as used herein refers to an alkenyl group as defined above, wherein the hydrogen atoms are partially or totally replaced with halogen atoms.

The term “alkynyl” as used herein denotes in each case a singly unsaturated hydrocarbon radical having usually 2 to 10, frequently 2 to 6, preferably 2 to 4 carbon atoms, e.g. ethynyl, propargyl (2-propyn-1-yl), 1-propyn-1-yl, 1-methylprop-2-yn-1-yl), 2-butyn-1-yl, 3-butyn-1-yl, 1-pentyn-1-yl, 3-pentyn-1-yl, 4-pentyn-1-yl, 1-methylbut-2-yn-1-yl, 1-ethylprop-2-yn-1-yl and the like.

The term “haloalkynyl” as used herein refers to an alkynyl group as defined above, wherein the hydrogen atoms are partially or totally replaced with halogen atoms.

The term “cycloalkyl” as used herein and in the cycloalkyl moieties of cycloalkoxy and cycloalkylthio denotes in each case a monocyclic cycloaliphatic radical having usually from 3 to 10 or from 3 to 6 carbon atoms, such as cyclopropyl, cyclobutyl, cyclopentyl, cyclohexyl, cycloheptyl, cyclooctyl, cyclononyl and cyclodecyl or cyclopropyl, cyclobutyl, cyclopentyl and cyclohexyl.

The “c” used in names of chemical group denote “cyclo”, for example “c-C₃H₄” which means “cyclopropyl”.

The term “halocycloalkyl” as used herein and in the halocycloalkyl moieties of halocycloalkoxy and halocycloalkylthio denotes in each case a monocyclic cycloaliphatic radical having usually from 3 to 10 C atoms or 3 to 6 C atoms, wherein at least one, e.g. 1, 2, 3, 4 or 5 of the hydrogen atoms, are replaced by halogen, in particular by fluorine or chlorine. Examples are 1- and 2-fluo-rocyclopropyl, 1,2-, 2,2- and 2,3-difluorocyclopropyl, 1,2,2-trifluorocyclopropyl, 2,2,3,3-tetrafluorocyclpropyl, 1- and 2-chlorocyclopropyl, 1,2-, 2,2- and 2,3-dichlorocyclopropyl, 1,2,2-trichlorocyclopropyl, 2,2,3,3-tetrachlorocyclpropyl, 1-, 2- and 3-fluorocyclopentyl, 1,2-, 2,2-, 2,3-, 3,3-, 3,4-, 2,5-difluorocyclopentyl, 1-, 2- and 3-chlorocyclopentyl, 1,2-, 2,2-, 2,3-, 3,3-, 3,4-, 2,5-dichlorocyclopentyl and the like.

The term “cycloalkenyl” as used herein and in the cycloalkenyl moieties of cycloalkenyloxy and cycloalkenylthio denotes in each case a monocyclic singly unsaturated non-aromatic radi-cal having usually from 3 to 10, e.g. 3 or 4 or from 5 to 10 carbon atoms, preferably from 3- to 8 carbon atoms. Exemplary cycloalkenyl groups include cyclopropenyl, cycloheptenyl or cy-clooctenyl.

The term “halocycloalkenyl” as used herein and in the halocycloalkenyl moieties of halocycloalkenyloxy and halocycloalkenylthio denotes in each case a monocyclic singly unsaturated nonaromatic radical having usually from 3 to 10, e.g. 3 or 4 or from 5 to 10 carbon atoms, preferably from 3- to 8 carbon atoms, wherein at least one, e.g. 1, 2, 3, 4 or 5 of the hydrogen atoms, are replaced by halogen, in particular by fluorine or chlorine. Examples are 3,3-difluorocyclopropen-1-yl and 3,3-dichlorocyclopropen-1-yl.

The term “cycloalkenylalkyl” refers to a cycloalkenyl group as defined above which is bonded via an alkyl group, such as a C₁-C₅-alkyl group or a C₁-C₄-alkyl group, in particular a methyl group (=cycloalkenylmethyl), to the remainder of the molecule.

The term “carbocycle” or “carbocyclyl” includes in general a 3- to 12-membered, preferably a 3- to 8-membered or a 5- to 8-membered, more preferably a 5- or 6-membered mono-cyclic, non-aromatic ring comprising 3 to 12, preferably 3 to 8 or 5 to 8, more preferably 5 or 6 carbon atoms. Preferably, the term “carbocycle” covers cycloalkyl and cycloalkenyl groups as defined above.

The term “heterocycle” or “heterocyclyl” includes in general 3- to 12-membered mono- or bicyclic, preferably 5- or 6-membered, in particular 6-membered monocyclic heterocyclic non-aromatic radicals. The heterocyclic non-aromatic radicals usually comprise 1, 2 or 3 hetero¬atoms selected from N, O and S as ring members, wherein S-atoms as ring members may be present as S, SO or SO₂. Examples of 5- or 6-membered heterocyclic radicals comprise saturated or unsaturated, non-aromatic heterocyclic rings, such as 2- and 3-azetidinyl, 2- and 3-oxetanyl, 2- and 3-thietanyl, 2- and 3-thietanyl-S-oxid (S-oxothietanyl), 2- and 3-thietanyl-S-dioxid (S-dioxothietanyl), 2- and 3-pyrrolidinyl, 2- and 3-tetrahydrofuranyl, 1,3-dioxolan-2-yl, thiolan-2-yl, S-oxothiolan-2-yl, S-di-oxo-thiolan-2-yl, 4- and 5-oxazolidinyl, 1,3-dioxan-2-yl, 1- and 3-thiopyran-2-yl, S-oxothiopyranyl, S-dioxothiopyranyl. The term “heterocyclyl” also includes bicyclic 8- to 10-membered heterocyclic radicals comprising as ring members 1, 2 or 3 heteroatoms selected from N, O and S, wherein a 5- or 6-membered heterocyclic ring is fused to a 5- or 6-membered carbo- or heterocyclic ring.

The term “hetaryl” includes 5- to 10-membered mono- or bicyclic, preferably monocyclic 5- or 6-membered heteroaromatic radicals comprising as ring members 1, 2, or 3 heteroatoms selected from N, O and S. Examples of 5- or 6 membered heteroaromatic radicals include pyridyl, i.e. 2-, 3-, and 4 pyridyl, pyrimidinyl, i.e. 2, 4- and 5-pyrimidinyl, pyrazinyl, pyridazinyl, i.e. 3- and 4 pyridazinyl, thienyl, i.e. 2- and 3-thienyl, furyl, i.e. 2- and 3-furyl, pyrrolyl, i.e. 1-, 2- and 3 pyrrolyl, oxazolyl, i.e. 2, 4- and 5-oxazolyl, isoxazol-yl, i.e. 3-, 4- and 5-isoxazolyl, thiazolyl, i.e. 2-, 3- and 5-thiazolyl, isothiazolyl, i.e. 3-, 4- and 5 isothiazolyl, pyrazolyl, i.e. 1-, 3-, 4- and 5-pyrazolyl, imidazolyl, i.e. 1-, 2-, 4- and 5-imidazolyl, oxadiazolyl, e.g. 2- and 5-[1,3,4]oxadiazolyl, thiadiazolyl, e.g. 1,3,4-thia-diazol-5-yl, 1,2,4-thiadiazol-3-yl, triazolyl, e.g. 1,3,4-triazol-2-yl, 1,2,4-triazol-3-yl. The term “hetaryl” also includes bicyclic 8- to 10-membered heteroaromatic radicals comprising as ring members 1, 2 or 3 heteroatoms selected from N, O and S, wherein a 5- or 6-membered heteroaromatic ring is fused to a phenyl ring or to a 5- or 6-membered heteroaromatic radical.

The term “genetically modified plant” refers to a plant in which the genetic material has been altered in a way that does not occur naturally by mating and/or natural recombination, examples of genetically modified plants of soybean are RR soybean and Intacta™ soybean.

In one aspect of the invention, the method comprises applying to plants, crops and/or propagation material, a compound of formula I, wherein the method is for controlling and/or preventing infestation by pests.

A further aspect the invention provides the use of the compounds of the invention for the general control of pests of plants.

In another aspect, the invention provides the use of the compounds of the invention for controlling pests that are resistant to one or more other insecticides.

In some embodiments, the invention relates to methods and uses, wherein the compound of the formula (I) as component I and at least one mixing partner as defined hereinafter is applied to plant or pests.

Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

The preferred transgenic plants or plant cultivars (obtained by genetic engineering) which are to be treated according to the invention include all plants which, by virtue of the genetic modification, received genetic material which imparts particularly advantageous, useful traits to these plants.

Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products.

Further and particularly emphasized examples of such traits are a better defense of the plants against animal and microbial pests, such as against insects, mites, phytopathogenic fungi, bacteria and/or viruses, and also increased tolerance of the plants to certain herbicidally active compounds.

Traits that are emphasized in particular are the increased defense of the plants against insects, arachnids, nematodes and slugs and snails by virtue of toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (referred to herein as “Bt plants”). Traits that are also particularly emphasized are the increased defense of the plants against fungi, bacteria and viruses by systemic acquired resistance (SAR), systemin, phytoalexins, elicitors and resistance genes and correspondingly expressed proteins and toxins.

Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants.

In another embodiment, present invention also relates to a method for controlling pests and/or increasing the plant health of a cultivated plant as compared to the respective non-modified control plant, comprising the application of the compound of the formula (I), to a plant with at least one modification, parts of such plant, plant propagation material, or at its locus of growth, wherein the cultivated plant is modified by at least one gene.

In a preferred embodiment, the variables of the compounds of the formula I have the following meanings, these meanings, both on their own and in combination with one another, being preferred embodiments of the compounds of the formula I.

In one embodiment the variables in formula I have the following meanings:

X¹ is O or CH₂; R¹ halomethyl; R^{2a} halogen, halomethyl, or halomethoxy; R^{2b}, R^{2c} are independently H, or as defined for R^{2a};
R³ is selected from H, C₁-C₆-alkyl, C₁-C₆-haloalkyl, C₂-C₆-alkenyl, C₂-C₆-haloalkenyl, C₂-C₆-alkynyl, C₂-C₆-haloalkynyl which aliphatic groups are unsubstituted or substituted by one or more radicals R³¹; C₃-C₆-cycloalkyl, C₃-C₆-halocycloalkyl which cyclic groups are unsubstituted or substituted by one or more radicals R³²; C(═O)N(R³³)R³⁴, N(R³³)R³⁵, CH═NOR³⁶; phenyl, 3- to 12-membered heterocyclyl, or 5- or 6-membered hetaryl which rings are unsubstituted or partially or fully substituted by R^{A};
R³¹ is independently OH, cyano, C₁-C₆-alkoxy, C₁-C₆-haloalkoxy, S(O)ₙ—C₁-C₆-alkyl, S(O)ₙ—C₁-C₆-haloalkyl, C(═O)N(R³³)R³⁴, C₃-C₆-cycloalkyl, or C₃-C₆-halocycloalkyl which cycles are unsubstituted or substituted by one or more R³¹¹; or
   phenyl, 3- to 12-membered heterocyclyl or 5- or 6-membered hetaryl which rings are unsubstituted or partially or fully substituted by R^{A};
R³¹¹ is independently OH, cyano, C₁-C₂-alkyl, or C₁-C₂-haloalkyl;
R³³ is H, or C₁-C₆-alkyl,
R³⁴ is H, C₁-C₆-alkyl, C₁-C₆-haloalkyl, C₂-C₆-alkenyl, C₂-C₆-haloalkenyl, C₂-C₆-alkynyl, C₂-C₆-haloalkynyl, or C₃-C₆-cycloalkyl, C₃-C₆-halocycloalkyl, C₃-C₆-cycloalkylmethyl, or C₃-C₆-halocycloalkylmethyl which rings are unsubstituted or substituted by a cyano;
R³⁵ H, C₁-C₆-alkyl, C₁-C₆-haloalkyl, C₂-C₄-alkenyl, C₂-C₄-alkynyl, CH₂—CN, C₃-C₆-cycloalkyl, C₃-C₆-halocycloalkyl, C₃-C₆-cycloalkylmethyl, C₃-C₆-halocycloalkylmethyl, phenyl and hetaryl which aromatic rings are unsubstituted or partially or fully substituted by R^{A};
R³² C₁-C₆-alkyl, C₁-C₆-haloalkyl, or a group as defined for R³¹;
R³⁶ is independently H, C₁-C₆-alkyl, or C₁-C₆-haloalkyl;
R^{A} is independently selected from halogen, cyano, NO₂, C₁-C₄-alkyl, C₁-C₄-haloalkyl, C₂-C₄-alkenyl, C₂-C₄-haloalkenyl, C₂-C₄-alkynyl, C₂-C₄-haloalkynyl, C₃-C₆-cycloalkyl, C₃-C₆-halocycloalkyl, C₁-C₄-alkoxy, C₁-C₄-haloalkoxy, S(O)ₙ—C₁-C₄-alkyl, S(O)ₙ—C₁-C₄-haloalkyl, C₁-C₄-alkylcarbonyl, C₁-C₄-haloalkylcarbonyl, C(═O)N(R³³)R³⁴; or
two R^{A} present on the same carbon atom of a saturated or partially saturated ring may form together ═O or ═S; or
two R^{A} present on the same S or SO ring member of a heterocyclic ring may together form a group ═N(C₁-C₆-alkyl), ═NO(C₁-C₆-alkyl), ═NN(H)(C₁-C₆-alkyl) or ═NN(C₁-C₆-alkyl)₂;

and the N-oxides, stereoisomers and agriculturally acceptable salts thereof.

In a preferred embodiment, the compounds I are present in form of a mixture of compounds I.A and I.B, where compound I.A is present in an amount of more than 50% by weight, in particular of at least 70% by weight, specifically of at least 90% by weight, based on the total weight of compounds I.A and I.B.

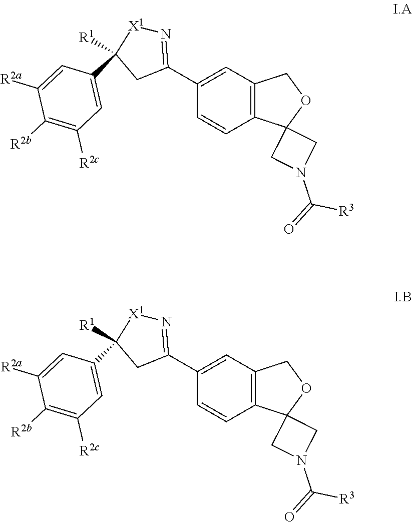

In one particularly preferred embodiment of the invention, the method comprises step of contacting the plant, parts of it, its propagation material, the pests, their food supply, habitat or breeding grounds a pesticidally effective amount of a compound of formula I.A.

In another preferred embodiment, the method according to the invention wherein X¹ is O.

In another preferred embodiment, the method according to the invention wherein X¹ is CH₂.

In another preferred embodiment, the method according to the invention wherein R¹ is preferably fluoromethyl, particularly CF₃.

In another preferred embodiment, the method according to the invention wherein R^{2a} is preferably selected from F, Cl, Br, CF₃, and OCF₃.

In another preferred embodiment, the method according to the invention wherein R^{2b} and R^{2c} are independently preferably selected from H, F, Cl, Br, CF₃, and OCF₃.

In another preferred embodiment, the method according to the invention wherein R³ is preferably selected from H, C₁-C₆-alkyl, C₁-C₆-haloalkyl, C₂-C₆-alkenyl, C₂-C₆-haloalkenyl, C₂-C₆-alkynyl, C₂-C₆-haloalkynyl which aliphatic groups are unsubstituted or substituted by one radical R³¹, C₃-C₆-cycloalkyl, C₃-C₆-halocycloalkyl which cyclic groups are unsubstituted or substituted by one radical R³²; heterocycle, or hetaryl which rings are unsubstituted or partially or fully substituted by R^{A};
R³¹ is independently OH, cyano, C₁-C₄-alkoxy, C₁-C₄-haloalkoxy, S(O)ₙ—C₁-C₄-alkyl, S(O)ₙ—C₁-C₄-haloalkyl, C₃-C₅-cycloalkyl, or C₃-C₅-halocycloalkyl which cycles are unsubstituted or substituted by one or more R³¹¹;
   R³¹¹ is independently OH, cyano, C₁-C₂-alkyl, or C₁-C₂-haloalkyl;
   n is 0, 1, or 2;
R³² C₁-C₂-alkyl, C₁-C₂-haloalkyl, OH, CN;
R^{A} is independently selected from halogen, cyano, NO₂, C₁-C₂-alkyl, C₁-C₂-haloalkyl, C₂-C₃-alkenyl, C₂-C₃-haloalkenyl, C₂-C₃-alkynyl, C₂-C₃-haloalkynyl, C₃-C₅-cycloalkyl, C₃-C₅-halocycloalkyl, C₁-C₃-alkoxy, C₁-C₃-haloalkoxy, S(O)ₙ—C₁-C₃-alkyl, S(O)ₙ—C₁-C₃-haloalkyl; or
   two R^{A} present on the same carbon atom of a saturated or partially saturated ring may form together ═O.

More preferably R³ is selected from C₁-C₄-alkyl, and C₁-C₄-haloalkyl, which aliphatic groups are unsubstituted or substituted by one radical R³¹; and C₃-C₅-cycloalkyl, C₃-C₅-halocycloalkyl which cyclic groups are unsubstituted or substituted by one radical R³²;
R³¹ is independently OH, cyano, C₁-C₄-alkoxy, C₁-C₄-haloalkoxy, S(O)ₙ—C₁-C₄-alkyl, S(O)ₙ—C₁-C₄-haloalkyl, C₃-C₅-cycloalkyl, or C₃-C₅-halocycloalkyl which cycles are unsubstituted or substituted by one or more R³¹¹;
   R³¹¹ is independently OH, cyano, C₁-C₂-alkyl, or C₁-C₂-haloalkyl;
   n is 0, 1, or 2;
R³² C₁-C₂-alkyl, C₁-C₂-haloalkyl, OH, CN;

Particularly preferred R³ is selected from C₁-C₃-alkyl, CH₂CF₃, CH₂CH₂CF₃, CH₂OH, CH₂-c-C₃H₅; cyclopropyl (c-C₃H₅), 1-CN-c-C₃H₄, 1-CF₃-c-C₃H₄, 1-OH-c-C₃H₄, 2,2, —F₂-c-C₃H₃, CH₂-c-C₃H₅, CH₂OCH₃, CH₂OC₂H₅, CH₂OCF₃, CH₂OCH₂CF₃, and CH₂SOₙCH₃, CH₂SOₙC₂H₅, wherein n is 0, 1, or 2; 1-pyrazolyl, 3-CH₃-1-pyrazolyl, 2-pyridyl, 3-thietan-yl, 3-thietan-yl-S-oxide, and 3-thietan-yl-S-dioxide.

Particularly preferred R³ is selected from C₁-C₃-alkyl, CH₂CF₃, CH₂CH₂CF₃, CH₂OH, CH₂-c-C₃H₅; cyclopropyl (c-C₃H₅), 1-CN-c-C₃H₄, 1-CF₃-c-C₃H₄, 1-OH-c-C₃H₄, 2,2, —F₂-c-C₃H₃, CH₂-c-C₃H₅, CH₂OCH₃, CH₂OC₂H₅, CH₂OCF₃, CH₂OCH₂CF₃, CH₂SOₙCH₃, CH₂SOₙC₂H₅, wherein n is 0, 1, or 2; CH₂C(R^{35a})═N—OR^{35a}, C(R^{35a})═NN(R^{35a})C(=T)N(R^{35a})R^{35a}, CH═N—OR^{35a}, wherein R^{35a} is C₁-C₃-alkyl, or benzyl substituted with halogen; 1-pyrazolyl, 6,7-dihydro-4H-pyrazolo[5,1-c][1,4]oxazine, 5,6-dihydro-4H-pyrrolo[1,2-b]pyrazole, 3-CH₃-1-pyrazolyl, 2-pyrazinyl, 2-pyridyl, 5-pyrimidinyl, 3-thietan-yl, 3-thietan-yl-S-oxide, and 3-thietan-yl-S-dioxide.

The present invention also relates to a mixture of at least one compound of the invention with at least one mixing partner as defined herein after. Preferred are binary mixtures of one compound of the invention as component I with one mixing partner as defined herein after as component II. Preferred weight ratios for such binary mixtures are from 5000:1 to 1:5000, preferably from 1000:1 to 1:1000, more preferably from 100:1 to 1:100, particularly preferably from 10:1 to 1:10. In such binary mixtures, components I and II may be used in equal amounts, or an excess of component I, or an excess of component II may be used.

Mixing partners can be selected from pesticides, in particular insecticides, nematicides, and acaricides, fungicides, herbicides, plant growth regulators, fertilizers, and the like. Preferred mixing partners are insecticides, nematicides and fungicides.

The following list M of pesticides, grouped and numbered according the Mode of Action Classification of the Insecticide Resistance Action Committee (IRAC), together with which The compounds of formula I can be used and with which potential synergistic effects might be produced, is intended to illustrate the possible combinations, but not to impose any limitation:

M.1 Acetylcholine esterase (AChE) inhibitors from the class of: M.1A carbamates, for example aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or from the class of M.1B organophosphates, for example acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion;

M.2. GABA-gated chloride channel antagonists such as: M.2A cyclodiene organochlorine compounds, as for example endosulfan or chlordane; or M.2B fiproles (phenylpyrazoles), as for example ethiprole, fipronil, flufiprole, pyrafluprole and pyriprole;

M.3 Sodium channel modulators from the class of M.3A pyrethroids, for example acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, heptafluthrin, imiprothrin, meperfluthrin, metofluthrin, momfluorothrin, permethrin, phenothrin, prallethrin, profluthrin, pyrethrin (pyrethrum), resmethrin, silafluofen, tefluthrin, tetramethylfluthrin, tetramethrin, tralomethrin and transfluthrin; or M.3B sodium channel modulators such as DDT or methoxychlor;

M.4 Nicotinic acetylcholine receptor agonists (nAChR) from the class of M.4A neonicotinoids, for example acetamiprid, clothianidin, cycloxaprid, dinotefuran, imidacloprid, nitenpyram, thiacloprid and thiamethoxam; or the compounds M.4A.2: (2E-)-1-[(6-Chloropyridin-3-yl)methyl]-N′-nitro-2-pentylidenehydrazinecarboximidamide; or M4.A.3: 1-[(6-Chloropyridin-3-yl)methyl]-7-methyl-8-nitro-5-propoxy-1,2,3,5,6,7-hexahydroimidazo[1,2-a]pyridine; or from the class M.4B nicotine;

M.5 Nicotinic acetylcholine receptor allosteric activators from the class of spinosyns, for example spinosad or spinetoram;

M.6 Chloride channel activators from the class of avermectins and milbemycins, for example abamectin, emamectin benzoate, ivermectin, lepimectin or milbemectin;

M.7 Juvenile hormone mimics, such as M.7A juvenile hormone analogues as hydroprene, kinoprene and methoprene; or others as M.7B fenoxycarb or M.7C pyriproxyfen;

M.8 miscellaneous non-specific (multi-site) inhibitors, for example M.8A alkyl halides as methyl bromide and other alkyl halides, or M.8B chloropicrin, or M.8C sulfuryl fluoride, or M.8D borax, or M.8E tartar emetic;

M.9 Selective homopteran feeding blockers, for example M.9B pymetrozine, or M.9C flonicamid;

M.10 Mite growth inhibitors, for example M.10A clofentezine, hexythiazox and diflovidazin, or M.10B etoxazole;

M.11 Microbial disruptors of insect midgut membranes, for example bacillus thuringiensis or bacillus sphaericus and the insecticdal proteins they produce such as bacillus thuringiensis subsp. israelensis, bacillus sphaericus, bacillus thuringiensis subsp. aizawai, bacillus thuringiensis subsp. kurstaki and bacillus thuringiensis subsp. tenebrionis, or the Bt crop proteins: Cry1Ab, Cry1Ac, Cry1Fa, Cry2Ab, mCry3A, Cry3Ab, Cry3Bb and Cry34/35Ab1;

M.12 Inhibitors of mitochondrial ATP synthase, for example M.12A diafenthiuron, or M.12B organotin miticides such as azocyclotin, cyhexatin or fenbutatin oxide, or M.12C propargite, or M.12D tetradifon;

M.13 Uncouplers of oxidative phosphorylation via disruption of the proton gradient, for example chlorfenapyr, DNOC or sulfluramid;

M.14 Nicotinic acetylcholine receptor (nAChR) channel blockers, for example nereistoxin analogues as bensultap, cartap hydrochloride, thiocyclam or thiosultap sodium;

M.15 Inhibitors of the chitin biosynthesis type 0, such as benzoylureas as for example bistrifluron, chlorfluazuron, diflubenzuron, flucycloxuron, flufenoxuron, hexaflumuron, lufenuron, novaluron, noviflumuron, teflubenzuron or triflumuron;

M.16 Inhibitors of the chitin biosynthesis type 1, as for example buprofezin;

M.17 Moulting disruptors, Dipteran, as for example cyromazine;

M.18 Ecdyson receptor agonists such as diacylhydrazines, for example methoxyfenozide, tebufenozide, halofenozide, fufenozide or chromafenozide;

M.19 Octopamin receptor agonists, as for example amitraz;

M.20 Mitochondrial complex III electron transport inhibitors, for example M.20A hydramethylnon, or M.20B acequinocyl, or M.20C fluacrypyrim;

M.21 Mitochondrial complex I electron transport inhibitors, for example M.21A METI acaricides and insecticides such as fenazaquin, fenpyroximate, pyrimidifen, pyridaben, tebufenpyrad or tolfenpyrad, or M.21B rotenone;

M.22 Voltage-dependent sodium channel blockers, for example M.22A indoxacarb, or M.22B metaflumizone, or M.22B.1: 2-[2-(4-Cyanophenyl)-1-[3-(trifluoromethyl)phenyl]ethylidene]-N-[4-(difluoromethoxy)phenyl]-hydrazinecarboxamide or M.22B.2: N-(3-Chloro-2-methylphenyl)-2-[(4-chlorophenyl)[4-[methyl(methylsulfonyl)amino]phenyl]methylene]-hydrazinecarboxamide;

M.23 Inhibitors of the of acetyl CoA carboxylase, such as Tetronic and Tetramic acid derivatives, for example spirodiclofen, spiromesifen or spirotetramat;

M.24 Mitochondrial complex IV electron transport inhibitors, for example M.24A phosphine such as aluminium phosphide, calcium phosphide, phosphine or zinc phosphide, or M.24B cyanide;

M.25 Mitochondrial complex II electron transport inhibitors, such as beta-ketonitrile derivatives, for example cyenopyrafen or cyflumetofen;

M.28 Ryanodine receptor-modulators from the class of diamides, as for example flubendiamide, chlorantraniliprole (Rynaxypyr®), cyantraniliprole (Cyazypyr®), tetraniliprole, or the phthalamide compounds M.28.1: (R)-3-Chlor-N1-{2-methyl-4-[1,2,2,2-tetrafluor-1-(trifluoromethyl)ethyl]phenyl}-N2-(1-methyl-2-methylsulfonylethyl)phthalamid and M.28.2: (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, or M.28.3: cyclaniliprole, or M.28.4: methyl-2-[3,5-dibromo-2-({[3-bromo-1-(3-chloropyridin-2-yl)-1H-pyrazol-5-yl]carbonyl}amino)benzoyl]-1,2-dimethylhydrazinecarboxylate; or a compound selected from M.28.5a) to M.28.5d) and M.28.5h) to M.28.5l): M.28.5a) N-[4,6-dichloro-2-[(diethyl-lambda-4-sulfanylidene)carbamoyl]-phenyl]-2-(3-chloro-2-pyridyl)-5-(trifluoromethyl)pyrazole-3-carboxamide; M.28.5b) N-[4-chloro-2-[(diethyl-lambda-4-sulfanylidene)carbamoyl]-6-methyl-phenyl]-2-(3-chloro-2-pyridyl)-5-(trifluoromethyl)pyrazole-3-carboxamide; M.28.5c) N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-carboxamide; M.28.5d) N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide; M.28.5h) N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide; M.28.5i) N-[2-(5-Amino-1,3,4-thiadiazol-2-yl)-4-chloro-6-methylphenyl]-3-bromo-1-(3-chloro-2-pyridinyl)-1H-pyrazole-5-carboxamide; M.28.5j) 3-Chloro-1-(3-chloro-2-pyridinyl)-N-[2,4-dichloro-6-[[(1-cyano-1-methylethyl)amino]carbonyl]phenyl]-1H-pyrazole-5-carboxamide; M.28.5k) 3-Bromo-N-[2,4-dichloro-6-(methylcarbamoyl)phenyl]-1-(3,5-dichloro-2-pyridyl)-1H-pyrazole-5-carboxamide; M.28.5l) N-[4-Chloro-2-[[(1,1-dimethylethyl)amino]carbonyl]-6-methylphenyl]-1-(3-chloro-2-pyridinyl)-3-(fluoromethoxy)-1H-pyrazole-5-carboxamide; or

M.28.6: cyhalodiamide; or;

M.29. insecticidal active compounds of unknown or uncertain mode of action, as for example afidopyropen, afoxolaner, azadirachtin, amidoflumet, benzoximate, bifenazate, broflanilide, bromopropylate, chinomethionat, cryolite, dicloromezotiaz, dicofol, flufenerim, flometoquin, fluensulfone, fluhexafon, fluopyram, flupyradifurone, fluralaner, metoxadiazone, piperonyl butoxide, pyflubumide, pyridalyl, pyrifluquinazon, sulfoxaflor, tioxazafen, triflumezopyrim, or M.29.3: 11-(4-chloro-2,6-dimethylphenyl)-12-hydroxy-1,4-dioxa-9-azadispiro[4.2.4.2]-tetradec-11-en-10-one, M.29.4: 3-(4′-fluoro-2,4-dimethylbiphenyl-3-yl)-4-hydroxy-8-oxa-1-azaspiro[4.5]dec-3-en-2-one, M.29.5: 1-[2-fluoro-4-methyl-5-[(2,2,2-trifluoroethyl)sulfinyl]phenyl]-3-(trifluoromethyl)-1H-1,2,4-triazole-5-amine, or actives on basis of bacillus firmus (Votivo, 1-1582); or of M.29.6, wherein the compound is selected from M.29.6a) to M.29.6k): M.29.6a) (E/Z)—N-[1-[(6-chloro-3-pyridyl)methyl]-2-pyridylidene]-2,2,2-trifluoro-acetamide; M.29.6b) (E/Z)—N-[1-[(6-chloro-5-fluoro-3-pyridyl)methyl]-2-pyridylidene]-2,2,2-trifluoro-acetamide; M.29.6c) (E/Z)-2,2,2-trifluoro-N-[1-[(6-fluoro-3-pyridyl)methyl]-2-pyridylidene]acetamide; M.29.6d) (E/Z)—N-[1-[(6-bromo-3-pyridyl)methyl]-2-pyridylidene]-2,2,2-trifluoro-acetamide; M.29.6e) (E/Z)—N-[1-[1-(6-chloro-3-pyridyl)ethyl]-2-pyridylidene]-2,2,2-trifluoro-acetamide; M.29.6f) (E/Z)—N-[1-[(6-chloro-3-pyridyl)methyl]-2-pyridylidene]-2,2-difluoro-acetamide; M.29.6g) (E/Z)-2-chloro-N-[1-[(6-chloro-3-pyridyl)methyl]-2-pyridylidene]-2,2-difluoro-acetamide; M.29.6h) (E/Z)—N-[1-[(2-chloropyrimidin-5-yl)methyl]-2-pyridylidene]-2,2,2-trifluoro-acetamide; M.29.6i) (E/Z)—N-[1-[(6-chloro-3-pyridyl)methyl]-2-pyridylidene]-2,2,3,3,3-pentafluoro-propanamide.); M.29.6j) N-[1-[(6-chloro-3-pyridyl)methyl]-2-pyridylidene]-2,2,2-trifluoro-thioacetamide; or M.29.6k) N-[1-[(6-chloro-3-pyridyl)methyl]-2-pyridylidene]-2,2,2-trifluoro-N′-isopropyl-acetamidine; or the compounds

M.29.8: fluazaindolizine; or the compounds

M.29.9.a): 4-[5-(3,5-dichlorophenyl)-5-(trifluoromethyl)-4H-isoxazol-3-yl]-2-methyl-N-(1-oxothietan-3-yl)benzamide; or M.29.9.b): fluxametamide; or

M.29.10: 5-[3-[2,6-dichloro-4-(3,3-dichloroallyloxy)phenoxy]propoxy]-1H-pyrazole; or

a compound selected from the group of M.29.11, wherein the compound is selected from M.29.11b) to M.29.11p): M.29.11.b) 3-(benzoylmethylamino)-N-[2-bromo-4-[1,2,2,3,3,3-hexafluoro-1-(trifluoromethyl)propyl]-6-(trifluoromethyl)phenyl]-2-fluoro-benzamide; M.29.11.c) 3-(benzoylmethylamino)-2-fluoro-N-[2-iodo-4-[1,2,2,2-tetrafluoro-1-(trifluoromethyl)ethyl]-6-(trifluoromethyl)phenyl]-benzamide; M.29.11.d) N-[3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide; M.29.11.e) N-[3-[[[2-bromo-4-[1,2,2,2-tetrafluoro-1-(trifluoromethyl)ethyl]-6-(trifluoromethyl)phenyl]amino]carbonyl]-2-fluorophenyl]-4-fluoro-N-methyl-benzamide; M.29.11.f) 4-fluoro-N-[2-fluoro-3-[[[2-iodo-4-[1,2,2,2-tetrafluoro-1-(trifluoromethyl)ethyl]-6-(trifluoromethyl)phenyl]amino]carbonyl]phenyl]-N-methylbenzamide; M.29.11.g) 3-fluoro-N-[2-fluoro-3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide; M.29.11.h) 2-chloro-N-[3-[[[2-iodo-4-[1,2,2,2-tetrafluoro-1-(trifluoromethyl)ethyl]-6-(trifluoromethyl)phenyl]amino]carbonyl]phenyl]-3-pyridinecarboxamide; M.29.11.i) 4-cyano-N-[2-cyano-5-[[2,6-dibromo-4-[1,2,2,3,3,3-hexafluoro-1-(trifluoromethyl)propyl]phenyl]carbamoyl]phenyl]-2-methyl-benzamide; M.29.11.j) 4-cyano-3-[(4-cyano-2-methyl-benzoyl)amino]-N-[2,6-dichloro-4-[1,2,2,3,3,3-hexafluoro-1-(trifluoromethyl)propyl]phenyl]-2-fluoro-benzamide; M.29.11.k) N-[5-[[2-chloro-6-cyano-4-[1,2,2,3,3,3-hexafluoro-1-(trifluoromethyl)propyl]phenyl]carbamoyl]-2-cyano-phenyl]-4-cyano-2-methyl-benzamide; M.29.11.j) N-[5-[[2-bromo-6-chloro-4-[2,2,2-trifluoro-1-hydroxy-1-(trifluoromethyl)ethyl]phenyl]carbamoyl]-2-cyano-phenyl]-4-cyano-2-methyl-benzamide; M.29.11.m) N-[5-[[2-bromo-6-chloro-4-[1,2,2,3,3,3-hexafluoro-1-(trifluoromethyl)propyl]phenyl]carbamoyl]-2-cyano-phenyl]-4-cyano-2-methyl-benzamide; M.29.11.n) 4-cyano-N-[2-cyano-5-[[2,6-dichloro-4-[1,2,2,3,3,3-hexafluoro-1-(trifluoromethyl)propyl]phenyl]carbamoyl]phenyl]-2-methyl-benzamide; M.29.11.o) 4-cyano-N-[2-cyano-5-[[2,6-dichloro-4-[1,2,2,2-tetrafluoro-1-(trifluoromethyl)ethyl]phenyl]carbamoyl]phenyl]-2-methyl-benzamide; M.29.11.p) N-[5-[[2-bromo-6-chloro-4-[1,2,2,2-tetrafluoro-1-(trifluoromethyl)ethyl]phenyl]carbamoyl]-2-cyano-phenyl]-4-cyano-2-methyl-benzamide; or

a compound selected from the group of M.29.12, wherein the compound is selected from M.29.12a) to M.29.12m): M.29.12.a) 2-(1,3-Dioxan-2-yl)-6-[2-(3-pyridinyl)-5-thiazolyl]-pyridine; M.29.12.b) 2-[6-[2-(5-Fluoro-3-pyridinyl)-5-thiazolyl]-2-pyridinyl]-pyrimidine; M.29.12.c) 2-[6-[2-(3-Pyridinyl)-5-thiazolyl]-2-pyridinyl]-pyrimidine; M.29.12.d) N-Methylsulfonyl-6-[2-(3-pyridyl)thiazol-5-yl]pyridine-2-carboxamide; M.29.12.e) N-Methylsulfonyl-6-[2-(3-pyridyl)thiazol-5-yl]pyridine-2-carboxamide; M.29.12.f) N-Ethyl-N-[4-methyl-2-(3-pyridyl)thiazol-5-yl]-3-methylthio-propanamide; M.29.12.g) N-Methyl-N-[4-methyl-2-(3-pyridyl)thiazol-5-yl]-3-methylthio-propanamide; M.29.12.h) N,2-Dimethyl-N-[4-methyl-2-(3-pyridyl)thiazol-5-yl]-3-methylthio-propanamide; M.29.12.i) N-Ethyl-2-methyl-N-[4-methyl-2-(3-pyridyl)thiazol-5-yl]-3-methylthio-propanamide; M.29.12.j) N-[4-Chloro-2-(3-pyridyl)thiazol-5-yl]-N-ethyl-2-methyl-3-methylthio-propanamide; M.29.12.k) N-[4-Chloro-2-(3-pyridyl)thiazol-5-yl]-N,2-dimethyl-3-methylthio-propanamide; M.29.12.l) N-[4-Chloro-2-(3-pyridyl)thiazol-5-yl]-N-methyl-3-methylthio-propanamide; M.29.12.m) N-[4-Chloro-2-(3-pyridyl)thiazol-5-yl]-N-ethyl-3-methylthio-propanamide; or the compounds

M.29.14a) 1-[(6-Chloro-3-pyridinyl)methyl]-1,2,3,5,6,7-hexahydro-5-methoxy-7-methyl-8-nitroimidazo[1,2-a]pyridine; or M.29.14b) 1-[(6-Chloropyridin-3-yl)methyl]-7-methyl-8-nitro-1,2,3,5,6,7-hexahydroimidazo[1,2-a]pyridin-5-ol; or the compounds

M.29.16a) 1-isopropyl-N,5-dimethyl-N-pyridazin-4-yl-pyrazole-4-carboxamide; or M.29.16b) 1-(1,2-dimethylpropyl)-N-ethyl-5-methyl-N-pyridazin-4-yl-pyrazole-4-carboxamide; M.29.16c) N,5-dimethyl-N-pyridazin-4-yl-1-(2,2,2-trifluoro-1-methyl-ethyl)pyrazole-4-carboxamide; M.29.16d) 1-[1-(1-cyanocyclopropyl)ethyl]-N-ethyl-5-methyl-N-pyridazin-4-yl-pyrazole-4-carboxamide; M.29.16e) N-ethyl-1-(2-fluoro-1-methyl-propyl)-5-methyl-N-pyridazin-4-yl-pyrazole-4-carboxamide; M.29.16f) 1-(1,2-dimethylpropyl)-N,5-dimethyl-N-pyridazin-4-yl-pyrazole-4-carboxamide; M.29.16g) 1-[1-(1-cyanocyclopropyl)ethyl]-N,5-dimethyl-N-pyridazin-4-yl-pyrazole-4-carboxamide; M.29.16h) N-methyl-1-(2-fluoro-1-methyl-propyl]-5-methyl-N-pyridazin-4-yl-pyrazole-4-carboxamide; M.29.16i) 1-(4,4-difluorocyclohexyl)-N-ethyl-5-methyl-N-pyridazin-4-yl-pyrazole-4-carboxamide; or M.29.16j) 1-(4,4-difluorocyclohexyl)-N,5-dimethyl-N-pyridazin-4-yl-pyrazole-4-carboxamide, or

M.29.17 a compound selected from M.29.17a) to M.29.17j): M.29.17a) N-(1-methylethyl)-2-(3-pyridinyl)-2H-indazole-4-carboxamide; M.29.17b) N-cyclopropyl-2-(3-pyridinyl)-2H-indazole-4-carboxamide; M.29.17c) N-cyclohexyl-2-(3-pyridinyl)-2H-indazole-4-carboxamide; M.29.17d) 2-(3-pyridinyl)-N-(2,2,2-trifluoroethyl)-2H-indazole-4-carboxamide; M.29.17e) 2-(3-pyridinyl)-N-[(tetrahydro-2-furanyl)methyl]-2H-indazole-5-carboxamide; M.29.17f) methyl 2-[[2-(3-pyridinyl)-2H-indazol-5-yl]carbonyl]hydrazinecarboxylate; M.29.17g) N-[(2,2-difluorocyclopropyl)methyl]-2-(3-pyridinyl)-2H-indazole-5-carboxamide; M.29.17h) N-(2,2-difluoropropyl)-2-(3-pyridinyl)-2H-indazole-5-carboxamide; M.29.17i) 2-(3-pyridinyl)-N-(2-pyrimidinylmethyl)-2H-indazole-5-carboxamide; M.29.17j) N-[(5-methyl-2-pyrazinyl)methyl]-2-(3-pyridinyl)-2H-indazole-5-carboxamide, or

M.29.18 a compound selected from M.29.18a) to M.29.18d): M.29.18a) N-[3-chloro-1-(3-pyridyl)pyrazol-4-yl]-N-ethyl-3-(3,3,3-trifluoropropylsulfanyl)propanamide; M.29.18b) N-[3-chloro-1-(3-pyridyl)pyrazol-4-yl]-N-ethyl-3-(3,3,3-trifluoropropylsulfinyl)propanamide; M.29.18c) N-[3-chloro-1-(3-pyridyl)pyrazol-4-yl]-3-[(2,2-difluorocyclopropyl)methylsulfanyl]-N-ethyl-propanamide; M.29.18d) N-[3-chloro-1-(3-pyridyl)pyrazol-4-yl]-3-[(2,2-difluorocyclopropyl)methylsulfinyl]-N-ethyl-propanamide; or M.29.19 sarolaner, or M.29.20 lotilaner.

M.30 ecdysone

The commercially available compounds of the group M listed above may be found in The Pesticide Manual, 16th Edition, C. MacBean, British Crop Protection Council (2013) among other publications. The online Pesticide Manual is updated regularly and is accessible through http://bcpcdata.com/pesticide-manual.html.

Another online data base for pesticides providing the ISO common names is http://www.alanwood.net/pesticides.

The M.4 neonicotinoid cycloxaprid is known from WO2010/069266 and WO2011/069456, the neonicotinoid M.4A.2, sometimes also to be named as guadipyr, is known from WO2013/003977, and the neonicotinoid M.4A.3 (approved as paichongding in China) is known from WO2007/101369. The metaflumizone analogue M.22B.1 is described in CN10171577 and the analogue M.22B.2 in CN102126994. The phthalamides M.28.1 and M.28.2 are both known from WO2007/101540. The anthranilamide M.28.3 is described in WO2005/077934. The hydrazide compound M.28.4 is described in WO2007/043677. The anthranilamides M.28.5a) to M.28.5d) and M.28.5h) are described in WO 2007/006670, WO2013/024009 and WO2013/024010, the anthranilamide M.28.5i) is described in WO2011/085575, M.28.5j) in WO2008/134969, M.28.5k) in US2011/046186 and M.28.5l) in WO2012/034403. The diamide compound M.28.6 can be found in WO2012/034472. The spiroketal-substituted cyclic ketoenol derivative M.29.3 is known from WO2006/089633 and the biphenyl-substituted spirocyclic ketoenol derivative M.29.4 from WO2008/067911. The triazoylphenylsulfide M.29.5 is described in WO2006/043635, and biological control agents on the basis of bacillus firmus are described in WO2009/124707. The compounds M.29.6a) to M.29.6i) listed under M.29.6 are described in WO2012/029672, and M.29.6j) and M.29.6k) in WO2013/129688. The nematicide M.29.8 is known from WO2013/055584. The isoxazoline M.29.9.a) is described in WO2013/050317. The isoxazoline M.29.9.b) is described in WO2014/126208. The pyridalyl-type analogue M.29.10 is known from WO2010/060379. The carboxamides broflanilide and M.29.11.b) to M.29.11.h) are described in WO2010/018714, and the carboxamides M.29.11i) to M.29.11.p) in WO2010/127926. The pyridylthiazoles M.29.12.a) to M.29.12.c) are known from WO2010/006713, M.29.12.d) and M.29.12.e) are known from WO2012/000896, and M.29.12.f) to M.29.12.m) from WO2010/129497. The compounds M.29.14a) and M.29.14b) are known from WO2007/101369. The pyrazoles M.29.16.a) to M.29.16h) are described in WO2010/034737, WO2012/084670, and WO2012/143317, respectively, and the pyrazoles M.29.16i) and M.29.16j) are described in U.S. 61/891,437. The pyridinylindazoles M.29.17a) to M.29.17.j) are described in WO2015/038503. The pyridylpyrazoles M.29.18a) to M.29.18d) are described in US2014/0213448. The isoxazoline M.29.19 is described in WO2014/036056. The isoxazoline M.29.20 is known from WO2014/090918.

In one preferred embodiment the mixing partner is selected from chlorpyrifos, methomyl, carbofuran, acephate from group M.1; ethiprole, fipronil or pyriprole from group M.2; lambda cyhalothrin, alpha-cypermethrin, permethrin, cyfluthrin, zeta-cypermethrin, tefluthrin, esfenvalerate, etofenprox, gamma-cyhalothrin, fenpropathrin, fenvalerate, fluvalinate, bifenthrin or deltamethrin from group M.3; dinotefuran, clothianidin, thiacloprid, imidacloprid or thiamethoxam from group M.4; spinosad from group M.5; ivermectin, abamectin, avermectin or emamectin from group M.6; flonicamid, pymetrozine from group M.9; chlorfenapyr from group M.13; teflubenzuron, lufenuron or novaluron from group M.15; buprofezin from group M.16; tebufenozide from group M.18; amitraz from group M.19; metaflumizone or indoxacarb from group M.22; spirotetramat from group M.23; cyflumetofen from group M.25; flubendiamide, chlorantraniliprole, cyantraniliprole, tetraniliprole or cyclaniliprole from group M.28; afidopyropen, broflanilide, bifenazate, sulfoxaflor or flupyradifuron from group M.29; ecdysone from group M.30.

In another preferred embodiment, the mixing partner is selected from pyrethroids for example lambda cyhalothrin, alpha-cypermethrin, bifenthrin and deltamethrin from group M.3; or neonicotinoids for example dinotefuran, clothianidin, thiacloprid, acetamiprid, imidacloprid or thiamethoxam from group M.4.

In a particularly preferred embodiment, the mixing partner is particularly selected from pyrethroids, for example lambda cyhalothrin, alpha-cypermethrin, bifenthrin and deltamethrin from group M.3.

The following list of fungicides, in conjunction with which the compounds of formula I can be used, is intended to illustrate the possible combinations but does not limit them:

A) Respiration Inhibitors
Inhibitors of complex III at Qₒ site (e. g. strobilurins): azoxystrobin (A.1.1), coumethoxystrobin (A.1.2), coumoxystrobin (A.1.3), dimoxystrobin (A.1.4), enestroburin (A.1.5), fenaminstrobin (A.1.6), fenoxystrobin/flufenoxystrobin (A.1.7), fluoxastrobin (A.1.8), kresoxim-methyl (A.1.9), mandestrobin (A.1.10), metominostrobin (A.1.11), orysastrobin (A.1.12), picoxy.strobin (A.1.13), pyraclostrobin (A.1.14), pyrametostrobin (A.1.15), pyraoxystrobin (A.1.16), trifloxystrobin (A.1.17), 2-(2-(3-(2,6-dichlorophenyl)-1-methyl-allylideneaminooxymethyl)-phenyl)-2-methoxyimino-N-methyl-acetamide (A.1.18), pyribencarb (A.1.19), triclopyricarb/chlorodincarb (A.1.20), famoxadone (A.1.21), fenamidone (A.1.21), methyl-N-[2-[(1,4-dimethyl-5-phenyl-pyrazol-3-yl)oxylmethyl]phenyl]-N-methoxy-carbamate (A.1.22), 1-[3-chloro-2-[[1-(4-chlorophenyl)-1H-pyrazol-3-yl]oxymethyl]phenyl]-4-methyl-tetrazol-5-one (A.1.23), 1-[3-bromo-2-[[1-(4-chlorophenyl)pyrazol-3-yl]oxymethyl]phenyl]-4-methyl-tetrazol-5-one (A.1.24), 1-[2-[[1-(4-chlorophenyl)pyrazol-3-yl]oxymethyl]-3-methyl-phenyl]-4-methyl-tetrazol-5-one (A.1.25), 1-[2-[[1-(4-chlorophenyl)pyrazol-3-yl]oxymethyl]-3-fluoro-phenyl]-4-methyl-tetrazol-5-one (A.1.26), 1-[2-[[1-(2,4-dichlorophenyl)pyrazol-3-yl]oxymethyl]-3-fluoro-phenyl]-4-methyl-tetrazol-5-one (A.1.27), 1-[2-[[4-(4-chlorophenyl)thiazol-2-yl]oxymethyl]-3-methyl-phenyl]-4-methyl-tetrazol-5-one (A.1.28), 1-[3-chloro-2-[[4-(p-tolyl)thiazol-2-yl]oxymethyl]phenyl]-4-methyl-tetrazol-5-one (A.1.29), 1-[3-cyclopropyl-2-[[2-methyl-4-(1-methylpyrazol-3-yl)phenoxy]methyl]phenyl]-4-methyl-tetrazol-5-one (A.1.30), 1-[3-(difluoromethoxy)-2-[[2-methyl-4-(1-methylpyrazol-3-yl)phenoxy]methyl]phenyl]-4-methyl-tetrazol-5-one (A.1.31), 1-methyl-4-[3-methyl-2-[[2-methyl-4-(1-methylpyrazol-3-yl)phenoxy]methyl]phenyl]tetrazol-5-one (A.1.32), 1-methyl-4-[3-methyl-2-[[1-[3-(trifluoromethyl)phenyl]-ethylideneamino]oxymethyl]phenyl]tetrazol-5-one (A.1.33), (Z,2E)-5-[1-(2,4-dichlorophenyl)pyrazol-3-yl]-oxy-2-methoxyimino-N,3-dimethyl-pent-3-enamide (A.1.34), (Z,2E)-5-[1-(4-chlorophenyl)pyrazol-3-yl]oxy-2-methoxyimino-N,3-dimethyl-pent-3-enamide (A.1.35), (Z,2E)-5-[1-(4-chloro-2-fluoro-phenyl)pyrazol-3-yl]oxy-2-methoxyimino-N,3-dimethyl-pent-3-enamide (A.1.36),
inhibitors of complex III at Qᵢ site: cyazofamid (A.2.1), amisulbrom (A.2.2), [(3S,6S,7R,8R)-8-benzyl-3-[(3-acetoxy-4-methoxy-pyridine-2-carbonyl)amino]-6-methyl-4,9-dioxo-1,5-dioxonan-7-yl] 2-methylpropanoate (A.2.3), [(3S,6S,7R,8R)-8-benzyl-3-[[3-(acetoxymethoxy)-4-methoxypyridine-2-carbonyl]amino]-6-methyl-4,9-dioxo-1,5-dioxonan-7-yl] 2-methylpropanoate (A.2.4), [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl] 2-methylpropanoate (A.2.5), [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl] 2-methylpropanoate (A.2.6); (3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate (A.2.7), (3S,6S,7R,8R)-8-benzyl-3-[3-[(isobutyryloxy)methoxy]-4-methoxypicolinamido]-6-methyl-4,9-dioxo-1,5-dioxonan-7-yl isobutyrate (A.2.8);
inhibitors of complex II (e. g. carboxamides): benodanil (A.3.1), benzovindiflupyr (A.3.2), bixafen (A.3.3), boscalid (A.3.4), carboxin (A.3.5), fenfuram (A.3.6), fluopyram (A.3.7), flutolanil (A.3.8), fluxapyroxad (A.3.9), furametpyr (A.3.10), isofetamid (A.3.11), isopyrazam (A.3.12), mepronil (A.3.13), oxycarboxin (A.3.14), penflufen (A.3.14), penthiopyrad (A.3.15), sedaxane (A.3.16), tecloftalam (A.3.17), thifluzamide (A.3.18), N-(4′-trifluoromethylthiobiphenyl-2-yl)-3-difluoromethyl-1-methyl-1H-pyrazole-4-carboxamide (A.3.19), N-(2-(1,3,3-trimethyl-butyl)-phenyl)-1,3-dimethyl-5-fluoro-1H-pyrazole-4-carboxamide (A.3.20), 3-(difluoromethyl)-1-methyl-N-(1,1,3-trimethylindan-4-yl)pyrazole-4-carboxamide (A.3.21), 3-(trifluoromethyl)-1-methyl-N-(1,1,3-trimethylindan-4-yl)pyrazole-4-carboxamide (A.3.22), 1,3-dimethyl-N-(1,1,3-trimethylindan-4-yl)pyrazole-4-carboxamide (A.3.23), 3-(trifluoromethyl)-1,5-dimethyl-N-(1,1,3-trimethylindan-4-yl)pyrazole-4-carboxamide (A.3.24), 1,3,5-trimethyl-N-(1,1,3-trimethylindan-4-yl)pyrazole-4-carboxamide (A.3.25), N-(7-fluoro-1,1,3-trimethyl-indan-4-yl)-1,3-dimethyl-pyrazole-4-carboxamide (A.3.26), N-[2-(2,4-dichlorophenyl)-2-methoxy-1-methyl-ethyl]-3-(difluoromethyl)-1-methyl-pyrazole-4-carboxamide (A.3.27);
other respiration inhibitors (e. g. complex I, uncouplers): diflumetorim (A.4.1), (5,8-difluoroquinazolin-4-yl)-{2-[2-fluoro-4-(4-trifluoromethylpyridin-2-yloxy)-phenyl]-ethyl}-amine (A.4.2); nitrophenyl derivates: binapacryl (A.4.3), dinobuton (A.4.4), dinocap (A.4.5), fluazinam (A.4.6); ferimzone (A.4.7); organometal compounds: fentin salts, such as fentin-acetate (A.4.8), fentin chloride (A.4.9) or fentin hydroxide (A.4.10); ametoctradin (A.4.11); and silthiofam (A.4.12);

B) Sterol Biosynthesis Inhibitors (SBI Fungicides)
C14 demethylase inhibitors (DMI fungicides): triazoles: azaconazole (B.1.1), bitertanol (B.1.2), bromuconazole (B.1.3), cyproconazole (B.1.4), difenoconazole (B.1.5), diniconazole (B.1.6), diniconazole-M (B.1.7), epoxiconazole (B.1.8), fenbuconazole (B.1.9), fluquinconazole (B.1.10), flusilazole (B.1.11), flutriafol (B.1.12), hexaconazole (B.1.13), imibenconazole (B.1.14), ipconazole (B.1.15), metconazole (B.1.17), myclobutanil (B.1.18), oxpoconazole (B.1.19), paclobutrazole (B.1.20), penconazole (B.1.21), propiconazole (B.1.22), prothioconazole (B.1.23), simeconazole (B.1.24), tebuconazole (B.1.25), tetraconazole (B.1.26), triadimefon (B.1.27), triadimenol (B.1.28), triticonazole (B.1.29), uniconazole (B.1.30), 1-[rel-(2S;3R)-3-(2-chlorophenyl)-2-(2,4-difluorophenyl)-oxiranylmethyl]-5-thiocyanato-1H-[1,2,4]triazolo (B.1.31), 2-[rel(2S;3R)-3-(2-chlorophenyl)-2-(2,4-difluorophenyl)-oxiranylmethyl]-2H-[1,2,4]triazole-3-thiol (B.1.32), 2-[2-chloro-4-(4-chlorophenoxy)phenyl]-1-(1,2,4-triazol-1-yl)pentan-2-ol (B.1.33), 1-[4-(4-chlorophenoxy)-2-(trifluoromethyl)phenyl]-1-cyclopropyl-2-(1,2,4-triazol-1-yl)ethanol (B.1.34), 2-[4-(4-chlorophenoxy)-2-(trifluoromethyl)phenyl]-1-(1,2,4-triazol-1-yl)butan-2-ol (B.1.35), 2-[2-chloro-4-(4-chlorophenoxy)phenyl]-1-(1,2,4-triazol-1-yl)butan-2-ol (B.1.36), 2-[4-(4-chlorophenoxy)-2-(trifluoromethyl)phenyl]-3-methyl-1-(1,2,4-triazol-1-yl)butan-2-ol (B.1.37), 2-[4-(4-chlorophenoxy)-2-(trifluoromethyl)phenyl]-1-(1,2,4-triazol-1-yl)propan-2-ol (B.1.38), 2-[2-chloro-4-(4-chlorophenoxy)phenyl]-3-methyl-1-(1,2,4-triazol-1-yl)butan-2-ol (B.1.39), 2-[4-(4-chlorophenoxy)-2-(trifluoromethyl)phenyl]-1-(1,2,4-triazol-1-yl)pentan-2-ol (B.1.40), 2-[4-(4-fluorophenoxy)-2-(trifluoromethyl)phenyl]-1-(1,2,4-triazol-1-yl)propan-2-ol (B.1.41), 2-[2-chloro-4-(4-chlorophenoxy)phenyl]-1-(1,2,4-triazol-1-yl)pent-3-yn-2-ol (B.1.51); imidazoles: imazalil (B.1.42), pefurazoate (B.1.43), prochloraz (B.1.44), triflumizol (B.1.45); pyrimidines, pyridines and piperazines: fenarimol (B.1.46), nuarimol (B.1.47), pyrifenox (B.1.48), triforine (B.1.49), [3-(4-chloro-2-fluoro-phenyl)-5-(2,4-difluorophenyl)isoxazol-4-yl]-(3-pyridyl)methanol (B.1.50);
Delta14-reductase inhibitors: aldimorph (B.2.1), dodemorph (B.2.2), dodemorph-acetate (B.2.3), fenpropimorph (B.2.4), tridemorph (B.2.5), fenpropidin (B.2.6), piperalin (B.2.7), spiroxamine (B.2.8);
Inhibitors of 3-keto reductase: fenhexamid (B.3.1);

C) Nucleic Acid Synthesis Inhibitors
phenylamides or acyl amino acid fungicides: benalaxyl (C.1.1), benalaxyl-M (C.1.2), kiralaxyl (C.1.3), metalaxyl (C.1.4), metalaxyl-M (mefenoxam, C.1.5), ofurace (C.1.6), oxadixyl (C.1.7);
others: hymexazole (C.2.1), octhilinone (C.2.2), oxolinic acid (C.2.3), bupirimate (C.2.4), 5-fluorocytosine (C.2.5), 5-fluoro-2-(p-tolylmethoxy)pyrimidin-4-amine (C.2.6), 5-fluoro-2-(4-fluorophenylmethoxy)pyrimidin-4-amine (C.2.7);

D) Inhibitors of Cell Division and Cytoskeleton
tubulin inhibitors, such as benzimidazoles, thiophanates: benomyl (D1.1), carbendazim (D1.2), fuberidazole (D1.3), thiabendazole (D1.4), thiophanate-methyl (D1.5); triazolopyrimidines: 5-chloro-7-(4-methylpiperidin-1-yl)-6-(2,4,6-trifluorophenyl)-[1,2,4]triazolo[1,5-a]pyrimidine (D1.6);
other cell division inhibitors: diethofencarb (D2.1), ethaboxam (D2.2), pencycuron (D2.3), fluopicolide (D2.4), zoxamide (D2.5), metrafenone (D2.6), pyriofenone (D2.7);

E) Inhibitors of Amino Acid and Protein Synthesis
methionine synthesis inhibitors (anilino-pyrimidines): cyprodinil (E.1.1), mepanipyrim (E.1.2), pyrimethanil (E.1.3);
protein synthesis inhibitors: blasticidin-S(E.2.1), kasugamycin (E.2.2), kasugamycin hydrochloride-hydrate (E.2.3), mildiomycin (E.2.4), streptomycin (E.2.5), oxytetracyclin (E.2.6), polyoxine (E.2.7), validamycin A (E.2.8);

F) Signal Transduction Inhibitors
MAP/histidine kinase inhibitors: fluoroimid (F.1.1), iprodione (F.1.2), procymidone (F.1.3), vinclozolin (F.1.4), fenpiclonil (F.1.5), fludioxonil (F.1.6);
G protein inhibitors: quinoxyfen (F.2.1);

G) Lipid and Membrane Synthesis Inhibitors
Phospholipid biosynthesis inhibitors: edifenphos (G.1.1), iprobenfos (G.1.2), pyrazophos (G.1.3), isoprothiolane (G.1.4);
lipid peroxidation: dicloran (G.2.1), quintozene (G.2.2), tecnazene (G.2.3), tolclofos-methyl (G.2.4), biphenyl (G.2.5), chloroneb (G.2.6), etridiazole (G.2.7);
phospholipid biosynthesis and cell wall deposition: dimethomorph (G.3.1), flumorph (G.3.2), mandipropamid (G.3.3), pyrimorph (G.3.4), benthiavalicarb (G.3.5), iprovalicarb (G.3.6), valifenalate (G.3.7) and N-(1-(1-(4-cyano-phenyl)ethanesulfonyl)-but-2-yl) carbamic acid-(4-fluorophenyl) ester (G.3.8);
compounds affecting cell membrane permeability and fatty acides: propamocarb (G.4.1);
fatty acid amide hydrolase inhibitors: oxathiapiprolin (G.5.1), 2-{3-[2-(1-{[3,5-bis(difluoromethyl-1H-pyrazol-1-yl]acetyl}piperidin-4-yl)-1,3-thiazol-4-yl]-4,5-dihydro-1,2-oxazol-5-yl}phenyl methanesulfonate (G.5.2), 2-{3-[2-(1-{[3,5-bis(difluoromethyl)-1H-pyrazol-1-yl]acetyl}piperidin-4-yl) 1,3-thiazol-4-yl]-4,5-dihydro-1,2-oxazol-5-yl}-3-chlorophenyl methanesulfonate (G.5.3);

H) Inhibitors with Multi Site Action
inorganic active substances: Bordeaux mixture (H.1.1), copper acetate (H.1.2), copper hydroxide (H.1.3), copper oxychloride (H.1.4), basic copper sulfate (H.1.5), sulfur (H.1.6);
thio- and dithiocarbamates: ferbam (H.2.1), mancozeb (H.2.2), maneb (H.2.3), metam (H.2.4), metiram (H.2.5), propineb (H.2.6), thiram (H.2.7), zineb (H.2.8), ziram (H.2.9);
organochlorine compounds (e. g. phthalimides, sulfamides, chloronitriles): anilazine (H.3.1), chlorothalonil (H.3.2), captafol (H.3.3), captan (H.3.4), folpet (H.3.5), dichlofluanid (H.3.6), dichlorophen (H.3.7), hexachlorobenzene (H.3.8), pentachlorphenole (H.3.9) and its salts, phthalide (H.3.10), tolylfluanid (H.3.11), N-(4-chloro-2-nitro-phenyl)-N-ethyl-4-methylbenzenesulfonamide (H.3.12);
guanidines and others: guanidine (H.4.1), dodine (H.4.2), dodine free base (H.4.3), guazatine (H.4.4), guazatine-acetate (H.4.5), iminoctadine (H.4.6), iminoctadine-triacetate (H.4.7), iminoctadine-tris(albesilate) (H.4.8), dithianon (H.4.9), 2,6-dimethyl-1H,5H-[1,4]dithiino[2,3-c:5,6-c′]dipyrrole-1,3,5,7(2H,6H)-tetraone (H.4.10);

I) Cell Wall Synthesis Inhibitors
inhibitors of glucan synthesis: validamycin (I.1.1), polyoxin B (I.1.2);
melanin synthesis inhibitors: pyroquilon (I.2.1), tricyclazole (I.2.2), carpropamid (I.2.3), dicyclomet (I.2.4), fenoxanil (I.2.5);

J) Plant Defence Inducers
acibenzolar-S-methyl (J.1.1), probenazole (J.1.2), isotianil (J.1.3), tiadinil (J.1.4), prohexadione-calcium (J.1.5); phosphonates: fosetyl (J.1.6), fosetyl-aluminum (J.1.7), phosphorous acid and its salts (J.1.8), potassium or sodium bicarbonate (J.1.9);

K) Unknown Mode of Action
bronopol (K.1.1), chinomethionat (K.1.2), cyflufenamid (K.1.3), cymoxanil (K.1.4), dazomet (K.1.5), debacarb (K.1.6), diclomezine (K.1.7), difenzoquat (K.1.8), difenzoquat-methylsulfate (K.1.9), diphenylamin (K.1.10), fenpyrazamine (K.1.11), flumetover (K.1.12), flusulfamide (K.1.13), flutianil (K.1.14), methasulfocarb (K.1.15), nitrapyrin (K.1.16), nitrothal-isopropyl (K.1.18), oxathiapiprolin (K.1.19), tolprocarb (K.1.20), oxin-copper (K.1.21), proquinazid (K.1.22), tebufloquin (K.1.23), tecloftalam (K.1.24), triazoxide (K.1.25), 2-butoxy-6-iodo-3-propylchromen-4-one (K.1.26), 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone (K.1.27), 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone (K.1.28), 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone (K.1.29), N-(cyclopropylmethoxy-imino-(6-difluoro-methoxy-2,3-difluoro-phenyl)-methyl)-2-phenyl acetamide (K.1.30), N′-(4-(4-chloro-3-trifluoromethyl-phenoxy)-2,5-dimethyl-phenyl)-N-ethyl-N-methyl formamidine (K.1.31), N′-(4-(4-fluoro-3-trifluoromethyl-phenoxy)-2,5-dimethyl-phenyl)-N-ethyl-N-methyl formamidine (K.1.32), N′-(2-methyl-5-trifluoromethyl-4-(3-trimethylsilanyl-propoxy)-phenyl)-N-ethyl-N-methyl formamidine (K.1.33), N′-(5-difluoromethyl-2-methyl-4-(3-trimethylsilanyl-propoxy)-phenyl)-N-ethyl-N-methyl formamidine (K.1.34), methoxy-acetic acid 6-tert-butyl-8-fluoro-2,3-dimethylquinolin-4-yl ester (K.1.35), 3-[5-(4-methylphenyl)-2,3-dimethyl-isoxazolidin-3-yl]-pyridine (K.1.36), 3-[5-(4-chloro-phenyl)-2,3-dimethyl-isoxazolidin-3-yl]-pyridine (pyrisoxazole) (K.1.37), N-(6-methoxy-pyridin-3-yl) cyclopropanecarboxylic acid amide (K.1.38), 5-chloro-1-(4,6-dimethoxy-pyrimidin-2-yl)-2-methyl-1H-benzoimidazole (K.1.39), 2-(4-chloro-phenyl)-N-[4-(3,4-dimethoxy-phenyl)-isoxazol-5-yl]-2-prop-2-ynyloxy-acetamide, ethyl (Z)-3-amino-2-cyano-3-phenyl-prop-2-enoate (K.1.40), picarbutrazox (K.1.41), pentyl N-[6-[[(Z)-[(1-methyltetrazol-5-yl)-phenyl-methylene]amino]oxymethyl]-2-pyridyl]carbamate (K.1.42), 2-[2-[(7,8-difluoro-2-methyl-3-quinolyl)oxy]-6-fluoro-phenyl]propan-2-ol (K.1.43), 2-[2-fluoro-6-[(8-fluoro-2-methyl-3-quinolyl)oxy]phen-yl]propan-2-ol (K.1.44), 3-(5-fluoro-3,3,4,4-tetramethyl-3,4-dihydroisoquinolin-1-yl)quinoline (K.1.45), 3-(4,4-difluoro-3,3-dimethyl-3,4-dihydroisoquinolin-1-yl)quinoline (K.1.46), 3-(4,4,5-trifluoro-3,3-dimethyl-3,4-dihydroisoquinolin-1-yl)quinoline (K.1.47), 9-fluoro-2,2-dimethyl-5-(3-quinolyl)-3H-1,4-benzoxazepine (K.1.48).

The fungicides described by common names, their preparation and their activity e.g. against harmful fungi is known (cf.: http://www.alanwood.net/pesticides/); these substances are commercially available.

The fungicides described by IUPAC nomenclature, their preparation and their pesticidal activity is also known (cf. Can. J. Plant Sci. 48(6), 587-94, 1968; EP-A 141 317; EP-A 152 031; EP-A 226 917; EP-A 243 970; EP-A 256 503; EP-A 428 941; EP-A 532 022; EP-A 1 028 125; EP-A 1 035 122; EP-A 1 201 648; EP-A 1 122 244, JP 2002316902; DE 19650197; DE 10021412; DE 102005009458; U.S. Pat. Nos. 3,296,272; 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 11/028657, WO2012/168188, WO 2007/006670, WO 2011/77514; WO13/047749, WO 10/069882, WO 13/047441, WO 03/16303, WO 09/90181, WO 13/007767, WO 13/010862, WO 13/127704, WO 13/024009, WO 13/024010 and WO 13/047441, WO 13/162072, WO 13/092224, WO 11/135833).

Suitable mixing partners for the compounds of the invention also include biopesticides.

Biopesticides have been defined as a form of pesticides based on micro-organisms (bacteria, fungi, viruses, nematodes, etc.) or natural products (compounds, such as metabolites, proteins, or extracts from biological or other natural sources) (U.S. Environmental Protection Agency: http://www.epa.gov/pesticides/biopesticides/). Biopesticides fall into two major classes, microbial and biochemical pesticides:

(1) Microbial pesticides consist of bacteria, fungi or viruses (and often include the metabolites that bacteria and fungi produce). Entomopathogenic nematodes are also classified as microbial pesticides, even though they are multi-cellular.

(2) Biochemical pesticides are naturally occurring substances or or structurally-similar and functionally identical to a naturally-occurring substance and extracts from biological sources that control pests or provide other crop protection uses as defined below, but have non-toxic mode of actions (such as growth or developmental regulation, attractents, repellents or defence activators (e.g. induced resistance) and are relatively non-toxic to mammals.

Biopesticides for use against crop diseases have already established themselves on a variety of crops. For example, biopesticides already play an important role in controlling downy mildew diseases. Their benefits include: a 0-Day Pre-Harvest Interval, the ability to use under moderate to severe disease pressure, and the ability to use in mixture or in a rotational program with other registered pesticides.

A major growth area for biopesticides is in the area of seed treatments and soil amendments. Biopesticidal seed treatments are e.g. used to control soil borne fungal pathogens that cause seed rots, damping-off, root rot and seedling blights. They can also be used to control internal seed borne fungal pathogens as well as fungal pathogens that are on the surface of the seed. Many biopesticidal products also show capacities to stimulate plant host defenses and other physiological processes that can make treated crops more resistant to a variety of biotic and abiotic stresses or can regulate plant growth. Many biopesticidal products also show capacities to stimulate plant health, plant growth and/or yield enhancing activity.

When mixtures comprising microbial pesticides are employed in seed treatment, the application rates with respect to plant propagation material preferably range from about 1×106 to 1×1012 (or more) CFU/seed. Preferably, the concentration is about 1×106 to about 1×109 CFU/seed. In the case of the microbial pesticides II, the application rates with respect to plant propagation material also preferably range from about 1×107 to 1×1014 (or more) CFU per 100 kg of seed, preferably from 1×109 to about 1×1012 CFU per 100 kg of seed.

Insecticidal compositions for use typically contain from 0.001 to 95 weight %, preferably from 0.1 to 45 weight %, and more preferably from 1 to 25 weight % of at least one repellent and/or insecticide.

Ready-to-use preparations contain the compounds acting against parasites, preferably ectoparasites, in concentrations of 10 ppm to 80 percent by weight, preferably from 0.1 to 65 percent by weight, more preferably from 1 to 50 percent by weight, most preferably from 5 to 40 percent by weight.

Preparations which are diluted before use contain the compounds acting against ectoparasites in concentrations of 0.5 to 90 percent by weight, preferably of 1 to 50 percent by weight.

The compounds of the invention may be applied in the methods of the invention in mixtures with fertilizers (for example nitrogen-, potassium- or phosphorus-containing fertilizers). Suitable formulation types include granules of fertilizer. The mixtures preferably contain up to 25% by weight of the compound of the invention.

An additional mixing partner may provide a composition having a broader spectrum of activity or increased persistence at a locus; synergize the activity or complement the activity (for example by increasing the speed of effect or overcoming repellency) of the compound of the invention; or help to overcome or prevent the development of resistance to individual components. The particular additional active ingredient will depend upon the intended utility of the composition.

With respect to the variables, the particularly preferred embodiments correspond to those of the compounds of the formula I.

Most preferred embodiments relate to each of following compounds of formula I, wherein the variables are as defined in the outset and the preferred embodiments and particularly in the following tables:

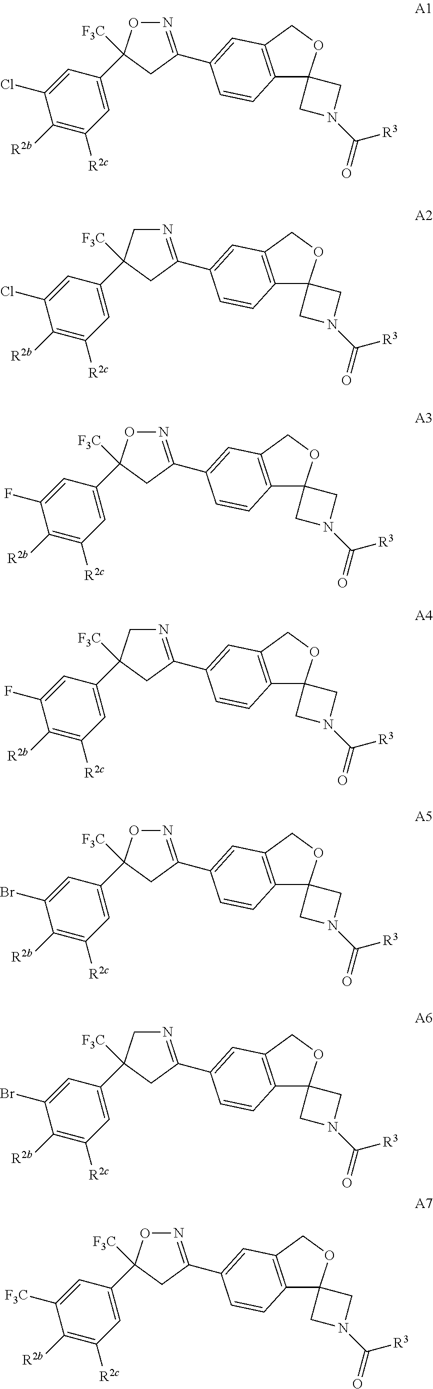

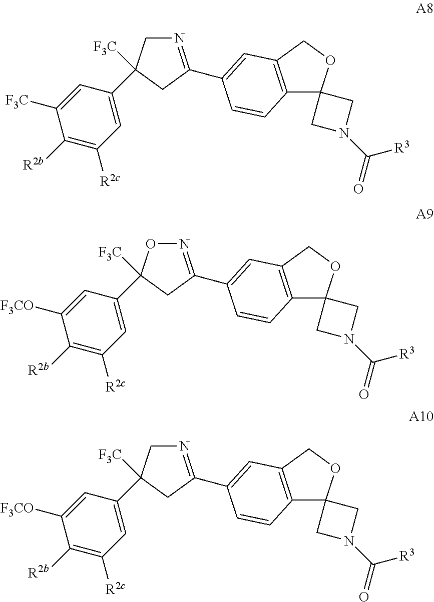

Preferred methods and uses of the invention applying the compound of formula I to plant and pests are given in Table A-1 to Table A-10.

Preferred methods and uses of the invention applying mixtures of the compound of formula I with mixing partners to plant and pests are given in Table 1-1 to Table 1-53, Table 2-1 to Table 2-53, Table 3-1 to Table 3-53, Table 4-1 to Table 4-53, Table 5-1 to Table 5-53, Table 6-1 to Table 6-53, Table 7-1 to Table 7-53, Table 8-1 to Table 8-53, Table 9-1 to Table 9-53 and Table 10-1 to Table 10-53.

Table A-1 Methods and uses, wherein compound A1 is applied to plant and/or pests and wherein R^{2b}, R^{2c} and R³ corresponds in each case to one row of Table T.

Table A-2 Methods and uses, wherein compound A2 is applied to plant and/or pests and wherein R^{2b}, R^{2c} and R³ corresponds in each case to one row of Table T.

Table A-3 Methods and uses, wherein compound A3 is applied to plant and/or pests and wherein R^{2b}, R^{2c} and R³ corresponds in each case to one row of Table T.

Table A-4 Methods and uses, wherein compound A4 is applied to plant and/or pests and wherein R^{2b}, R^{2c} and R³ corresponds in each case to one row of Table T.

Table A-5 Methods and uses, wherein compound A5 is applied to plant and/or pests and wherein R^{2b}, R^{2c} and R³ corresponds in each case to one row of Table T.

Table A-6 Methods and uses, wherein compound A6 is applied to plant and/or pests and wherein R^{2b}, R^{2c} and R³ corresponds in each case to one row of Table T.

Table A-7 Methods and uses, wherein compound A7 is applied to plant and/or pests and wherein R^{2b}, R^{2c} and R³ corresponds in each case to one row of Table T.

Table A-8 Methods and uses, wherein compound A8 is applied to plant and/or pests and wherein R^{2b}, R^{2c} and R³ corresponds in each case to one row of Table T.

Table A-9 Methods and uses, wherein compound A9 is applied to plant and/or pests and wherein R^{2b}, R^{2c} and R³ corresponds in each case to one row of Table T.

Table A-10 Methods and uses, wherein compound A10 is applied to plant and/or pests and wherein R^{2b}, R^{2c} and R³ corresponds in each case to one row of Table T.

Table 1-1 Methods and uses, wherein the mixture of compound A1 and Lambda cyhalothrin is applied to plant and/or pests and wherein R^{2b}, R^{2c} and R³ corresponds in each case to one row of Table T.

Table 1-2 Methods and uses, wherein the mixture of compound A1 and Bifenthrin is applied to plant and/or pests and wherein R^{2b}, R^{2c} and R³ corresponds in each case to one row of Table T.

Table 1-3 Methods and uses, wherein the mixture of compound A1 and Afidopyropen is applied to plant and/or pests and wherein R^{2b}, R^{2c} and R³ corresponds in each case to one row of Table T.

Table 1-4 Methods and uses, wherein the mixture of compound A1 and Broflanilide is applied to plant and/or pests and wherein R^{2b}, R^{2c} and R³ corresponds in each case to one row of Table T.

Table 1-5 Methods and uses, wherein the mixture of compound A1 and Flubendiamide is applied to plant and/or pests and wherein R^{2b}, R^{2c} and R³ corresponds in each case to one row of Table T.

Table 1-6 Methods and uses, wherein the mixture of compound A1 and Chlorfenapyr is applied to plant and/or pests and wherein R^{2b}, R^{2c} and R³ corresponds in each case to one row of Table T.

Table 1-7 Methods and uses, wherein the mixture of compound A1 and Ethiprole is applied to plant and/or pests and wherein R^{2b}, R^{2c} and R³ corresponds in each case to one row of Table T.

Table 1-8 Methods and uses, wherein the mixture of compound A1 and Dinotefuran is applied to plant and/or pests and wherein R^{2b}, R^{2c} and R³ corresponds in each case to one row of Table T.

Table 1-9 Methods and uses, wherein the mixture of compound A1 and Sulfoxaflor is applied to plant and/or pests and wherein R^{2b}, R^{2c} and R³ corresponds in each case to one row of Table T.

Table 1-10 Methods and uses, wherein the mixture of compound A1 and Clothianidin is applied to plant and/or pests and wherein R^{2b}, R^{2c} and R³ corresponds in each case to one row of Table T.

Table 1-11 Methods and uses, wherein the mixture of compound A1 and Thiacloprid is applied to plant and/or pests and wherein R^{2b}, R^{2c} and R³ corresponds in each case to one row of Table T.

Table 1-12 Methods and uses, wherein the mixture of compound A1 and Flupyradifuron is applied to plant and/or pests and wherein R^{2b}, R^{2c} and R³ corresponds in each case to one row of Table T.

Table 1-13 Methods and uses, wherein the mixture of compound A1 and Imidacloprid is applied to plant and/or pests and wherein R^{2b}, R^{2c} and R³ corresponds in each case to one row of Table T.

Table 1-14 Methods and uses, wherein the mixture of compound A1 and Fipronil is applied to plant and/or pests and wherein R^{2b}, R^{2c} and R³ corresponds in each case to one row of Table T.

Table 1-15 Methods and uses, wherein the mixture of compound A1 and Ivermectin is applied to plant and/or pests and wherein R^{2b}, R^{2c} and R³ corresponds in each case to one row of Table T.

Table 1-16 Methods and uses, wherein the mixture of compound A1 and Abamectin is applied to plant and/or pests and wherein R^{2b}, R^{2c} and R³ corresponds in each case to one row of Table T.

Table 1-17 Methods and uses, wherein the mixture of compound A1 and Spinosad is applied to plant and/or pests and wherein R^{2b}, R^{2c} and R³ corresponds in each case to one row of Table T.

Table 1-18 Methods and uses, wherein the mixture of compound A1 and Thiamethoxam is applied to plant and/or pests and wherein R^{2b}, R^{2c} and R³ corresponds in each case to one row of Table T.

Table 1-19 Methods and uses, wherein the mixture of compound A1 and Indoxacarb is applied plant and/or pests and wherein R^{2b}, R^{2c} and R³ corresponds in each case to one row of Table T.

Table 1-20 Methods and uses, wherein the mixture of compound A1 and Deltamethrin is applied to plant and/or pests and wherein R^{2b}, R^{2c} and R³ corresponds in each case to one row of Table T.

Table 1-21 Methods and uses, wherein the mixture of compound A1 and Metaflumizone is applied to plant and/or pests and wherein R^{2b}, R^{2c} and R³ corresponds in each case to one row of Table T.

Table 1-22 Methods and uses, wherein the mixture of compound A1 and Avermectin is applied to plant and/or pests and wherein R^{2b}, R^{2c} and R³ corresponds in each case to one row of Table T.

Table 1-23 Methods and uses, wherein the mixture of compound A1 and Emamectin is applied to plant and/or pests and wherein R^{2b}, R^{2c} and R³ corresponds in each case to one row of Table T.

Table 1-24 Methods and uses, wherein the mixture of compound A1 and Methomyl is applied to plant and/or pests and wherein R^{2b}, R^{2c} and R³ corresponds in each case to one row of Table T.

Table 1-25 Methods and uses, wherein the mixture of compound A1 and Lufenuron is applied to plant and/or pests and wherein R^{2b}, R^{2c} and R³ corresponds in each case to one row of Table T.

Table 1-26 Methods and uses, wherein the mixture of compound A1 and Buprofezin is applied to plant and/or pests and wherein R^{2b}, R^{2c} and R³ corresponds in each case to one row of Table T.

Table 1-27 Methods and uses, wherein the mixture of compound A1 and Teflubenzuron is applied to plant and/or pests and wherein R^{2b}, R^{2c} and R³ corresponds in each case to one row of Table T.

Table 1-28 Methods and uses, wherein the mixture of compound A1 and Chlorantraniliprole is applied to plant and/or pests and wherein R^{2b}, R^{2c} and R³ corresponds in each case to one row of Table T.

Table 1-29 Methods and uses, wherein the mixture of compound A1 and Cyantraniliprole is applied to plant and/or pests and wherein R^{2b}, R^{2c} and R³ corresponds in each case to one row of Table T.

Table 1-30 Methods and uses, wherein the mixture of compound A1 and Tetraniliprole is applied to plant and/or pests and wherein R^{2b}, R^{2c} and R³ corresponds in each case to one row of Table T.

Table 1-31 Methods and uses, wherein the mixture of compound A1 and Cyclaniliprole is applied to plant and/or pests and wherein R^{2b}, R^{2c} and R³ corresponds in each case to one row of Table T.

Table 1-32 Methods and uses, wherein the mixture of compound A1 and Flonicamid is applied to plant and/or pests and wherein R^{2b}, R^{2c} and R³ corresponds in each case to one row of Table T.

Table 1-33 Methods and uses, wherein the mixture of compound A1 and Pymetrozine is applied to plant and/or pests and wherein R^{2b}, R^{2c} and R³ corresponds in each case to one row of Table T.

Table 1-34 Methods and uses, wherein the mixture of compound A1 and Spirotetramat is applied plant and/or pests and wherein R^{2b}, R^{2c} and R³ corresponds in each case to one row of Table T.

Table 1-35 Methods and uses, wherein the mixture of compound A1 and alpha-cypermethrin is applied plant and/or pests and wherein R^{2b}, R^{2c} and R³ corresponds in each case to one row of Table T.

Table 1-36 Methods and uses, wherein the mixture of compound A1 and Acetamiprid is applied plant and/or pests and wherein R^{2b}, R^{2c} and R³ corresponds in each case to one row of Table T.

Table 1-37 Methods and uses, wherein the mixture of compound A1 and Chlorpyrifos is applied plant and/or pests and wherein R^{2b}, R^{2c} and R³ corresponds in each case to one row of Table T.

Table 1-38 Methods and uses, wherein the mixture of compound A1 and Acephate is applied plant and/or pests and wherein R^{2b}, R^{2c} and R³ corresponds in each case to one row of Table T.

Table 1-39 Methods and uses, wherein the mixture of compound A1 and Permethrin is applied plant and/or pests and wherein R^{2b}, R^{2c} and R³ corresponds in each case to one row of Table T.

Table 1-40 Methods and uses, wherein the mixture of compound A1 and Cypermethrin is applied plant and/or pests and wherein R^{2b}, R^{2c} and R³ corresponds in each case to one row of Table T.

Table 1-41 Methods and uses, wherein the mixture of compound A1 and Cyfluthrin is applied plant and/or pests and wherein R^{2b}, R^{2c} and R³ corresponds in each case to one row of Table T.

Table 1-42 Methods and uses, wherein the mixture of compound A1 and Zeta-cypermethrin is applied plant and/or pests and wherein R^{2b}, R^{2c} and R³ corresponds in each case to one row of Table T.

Table 1-43 Methods and uses, wherein the mixture of compound A1 and Tefluthrin is applied plant and/or pests and wherein R^{2b}, R^{2c} and R³ corresponds in each case to one row of Table T.

Table 1-44 Methods and uses, wherein the mixture of compound A1 and Esfenvalerate is applied plant and/or pests and wherein R^{2b}, R^{2c} and R³ corresponds in each case to one row of Table T.

Table 1-45 Methods and uses, wherein the mixture of compound A1 and Etofenprox is applied plant and/or pests and wherein R^{2b}, R^{2c} and R³ corresponds in each case to one row of Table T.

Table 1-46 Methods and uses, wherein the mixture of compound A1 and Gamma-cyhalothrin is applied plant and/or pests and wherein R^{2b}, R^{2c} and R³ corresponds in each case to one row of Table T.

Table 1-47 Methods and uses, wherein the mixture of compound A1 and Fenpropathrin is applied plant and/or pests and wherein R^{2b}, R^{2c} and R³ corresponds in each case to one row of Table T.

Table 1-48 Methods and uses, wherein the mixture of compound A1 and Fenvalerate is applied plant and/or pests and wherein R^{2b}, R^{2c} and R³ corresponds in each case to one row of Table T.

Table 1-49 Methods and uses, wherein the mixture of compound A1 and Fluvalinate is applied plant and/or pests and wherein R^{2b}, R^{2c} and R³ corresponds in each case to one row of Table T.

Table 1-50 Methods and uses, wherein the mixture of compound A1 and Carbofuran is applied plant and/or pests and wherein R^{2b}, R^{2c} and R³ corresponds in each case to one row of Table T.

Table 1-51 Methods and uses, wherein the mixture of compound A1 and Novaluron is applied plant and/or pests and wherein R^{2b}, R^{2c} and R³ corresponds in each case to one row of Table T.

Table 1-52 Methods and uses, wherein the mixture of compound A1 and Cyflumetofen is applied plant and/or pests and wherein R^{2b}, R^{2c} and R³ corresponds in each case to one row of Table T.

Table 1-53 Methods and uses, wherein the mixture of compound A1 and Bifenazate is applied plant and/or pests and wherein R^{2b}, R^{2c} and R³ corresponds in each case to one row of Table T.

Table 2-1 Methods and uses, wherein the mixture of compound A2 and Lambda cyhalothrin is applied to plant and/or pests and wherein R^{2b}, R^{2c} and R³ corresponds in each case to one row of Table T.

Table 2-2 Methods and uses, wherein the mixture of compound A2 and Bifenthrin is applied to plant and/or pests and wherein R^{2b}, R^{2c} and R³ corresponds in each case to one row of Table T.

Table 2-3 Methods and uses, wherein the mixture of compound A2 and Afidopyropen is applied to plant and/or pests and wherein R^{2b}, R^{2c} and R³ corresponds in each case to one row of Table T.

Table 2-4 Methods and uses, wherein the mixture of compound A2 and Broflanilide is applied to plant and/or pests and wherein R^{2b}, R^{2c} and R³ corresponds in each case to one row of Table T.

Table 2-5 Methods and uses, wherein the mixture of compound A2 and Flubendiamide is applied to plant and/or pests and wherein R^{2b}, R^{2c} and R³ corresponds in each case to one row of Table T.

Table 2-6 Methods and uses, wherein the mixture of compound A2 and Chlorfenapyr is applied to plant and/or pests and wherein R^{2b}, R^{2c} and R³ corresponds in each case to one row of Table T.

Table 2-7 Methods and uses, wherein the mixture of compound A2 and Ethiprole is applied to plant and/or pests and wherein R^{2b}, R^{2c} and R³ corresponds in each case to one row of Table T.

Table 2-8 Methods and uses, wherein the mixture of compound A2 and Dinotefuran is applied to plant and/or pests and wherein R^{2b}, R^{2c} and R³ corresponds in each case to one row of Table T.

Table 2-9 Methods and uses, wherein the mixture of compound A2 and Sulfoxaflor is applied to plant and/or pests and wherein R^{2b}, R^{2c} and R³ corresponds in each case to one row of Table T.

Table 2-10 Methods and uses, wherein the mixture of compound A2 and Clothianidin is applied to plant and/or pests and wherein R^{2b}, R^{2c} and R³ corresponds in each case to one row of Table T.

Table 2-11 Methods and uses, wherein the mixture of compound A2 and Thiacloprid is applied to plant and/or pests and wherein R^{2b}, R^{2c} and R³ corresponds in each case to one row of Table T.

Table 2-12 Methods and uses, wherein the mixture of compound A2 and Flupyradifuron is applied to plant and/or pests and wherein R^{2b}, R^{2c} and R³ corresponds in each case to one row of Table T.

Table 2-13 Methods and uses, wherein the mixture of compound A2 and Imidacloprid is applied to plant and/or pests and wherein R^{2b}, R^{2c} and R³ corresponds in each case to one row of Table T.

Table 2-14 Methods and uses, wherein the mixture of compound A2 and Fipronil is applied to plant and/or pests and wherein R^{2b}, R^{2c} and R³ corresponds in each case to one row of Table T.

Table 2-15 Methods and uses, wherein the mixture of compound A2 and Ivermectin is applied to plant and/or pests and wherein R^{2b}, R^{2c} and R³ corresponds in each case to one row of Table T.

Table 2-16 Methods and uses, wherein the mixture of compound A2 and Abamectin is applied to plant and/or pests and wherein R^{2b}, R^{2c} and R³ corresponds in each case to one row of Table T.

Table 2-17 Methods and uses, wherein the mixture of compound A2 and Spinosad is applied to plant and/or pests and wherein R^{2b}, R^{2c} and R³ corresponds in each case to one row of Table T.

Table 2-18 Methods and uses, wherein the mixture of compound A2 and Thiamethoxam is applied to plant and/or pests and wherein R^{2b}, R^{2c} and R³ corresponds in each case to one row of Table T.

Table 2-19 Methods and uses, wherein the mixture of compound A2 and Indoxacarb is applied plant and/or pests and wherein R^{2b}, R^{2c} and R³ corresponds in each case to one row of Table T.

Table 2-20 Methods and uses, wherein the mixture of compound A2 and Deltamethrin is applied to plant and/or pests and wherein R^{2b}, R^{2c} and R³ corresponds in each case to one row of Table T.

Table 2-21 Methods and uses, wherein the mixture of compound A2 and Metaflumizone is applied to plant and/or pests and wherein R^{2b}, R^{2c} and R³ corresponds in each case to one row of Table T.

Table 2-22 Methods and uses, wherein the mixture of compound A2 and Avermectin is applied to plant and/or pests and wherein R^{2b}, R^{2c} and R³ corresponds in each case to one row of Table T.

Table 2-23 Methods and uses, wherein the mixture of compound A2 and Emamectin is applied to plant and/or pests and wherein R^{2b}, R^{2c} and R³ corresponds in each case to one row of Table T.

Table 2-24 Methods and uses, wherein the mixture of compound A2 and Methomyl is applied to plant and/or pests and wherein R^{2b}, R^{2c} and R³ corresponds in each case to one row of Table T.

Table 2-25 Methods and uses, wherein the mixture of compound A2 and Lufenuron is applied to plant and/or pests and wherein R^{2b}, R^{2c} and R³ corresponds in each case to one row of Table T.

Table 2-26 Methods and uses, wherein the mixture of compound A2 and Buprofezin is applied to plant and/or pests and wherein R^{2b}, R^{2c} and R³ corresponds in each case to one row of Table T.

Table 2-27 Methods and uses, wherein the mixture of compound A2 and Teflubenzuron is applied to plant and/or pests and wherein R^{2b}, R^{2c} and R³ corresponds in each case to one row of Table T.

Table 2-28 Methods and uses, wherein the mixture of compound A2 and Chlorantraniliprole is applied to plant and/or pests and wherein R^{2b}, R^{2c} and R³ corresponds in each case to one row of Table T.

Table 2-29 Methods and uses, wherein the mixture of compound A2 and Cyantraniliprole is applied to plant and/or pests and wherein R^{2b}, R^{2c} and R³ corresponds in each case to one row of Table T.

Table 2-30 Methods and uses, wherein the mixture of compound A2 and Tetraniliprole is applied to plant and/or pests and wherein R^{2b}, R^{2c} and R³ corresponds in each case to one row of Table T.

Table 2-31 Methods and uses, wherein the mixture of compound A2 and Cyclaniliprole is applied to plant and/or pests and wherein R^{2b}, R^{2c} and R³ corresponds in each case to one row of Table T.

Table 2-32 Methods and uses, wherein the mixture of compound A2 and Flonicamid is applied to plant and/or pests and wherein R^{2b}, R^{2c} and R³ corresponds in each case to one row of Table T.

Table 2-33 Methods and uses, wherein the mixture of compound A2 and Pymetrozine is applied to plant and/or pests and wherein R^{2b}, R^{2c} and R³ corresponds in each case to one row of Table T.

Table 2-34 Methods and uses, wherein the mixture of compound A2 and Spirotetramat is applied plant and/or pests and wherein R^{2b}, R^{2c} and R³ corresponds in each case to one row of Table T.

Table 2-35 Methods and uses, wherein the mixture of compound A2 and alpha-cypermethrin is applied plant and/or pests which corresponds in each case to one row of Table T.

Table 2-36 Methods and uses, wherein the mixture of compound A2 and Acetamiprid is applied plant and/or pests which corresponds in each case to one row of Table T.

Table 2-37 Methods and uses, wherein the mixture of compound A2 and Chlorpyrifos is applied plant and/or pests which corresponds in each case to one row of Table T.

Table 2-38 Methods and uses, wherein the mixture of compound A2 and Acephate is applied plant and/or pests which corresponds in each case to one row of Table T.

Table 2-39 Methods and uses, wherein the mixture of compound A2 and Permethrin is applied plant and/or pests which corresponds in each case to one row of Table T.

Table 2-40 Methods and uses, wherein the mixture of compound A2 and Cypermethrin is applied plant and/or pests which corresponds in each case to one row of Table T.

Table 2-41 Methods and uses, wherein the mixture of compound A2 and Cyfluthrin is applied plant and/or pests which corresponds in each case to one row of Table T.

Table 2-42 Methods and uses, wherein the mixture of compound A2 and Zeta-cypermethrin is applied plant and/or pests which corresponds in each case to one row of Table T.

Table 2-43 Methods and uses, wherein the mixture of compound A2 and Tefluthrin is applied plant and/or pests which corresponds in each case to one row of Table T.

Table 2-44 Methods and uses, wherein the mixture of compound A2 and Esfenvalerate is applied plant and/or pests which corresponds in each case to one row of Table T.

Table 2-45 Methods and uses, wherein the mixture of compound A2 and Etofenprox is applied plant and/or pests which corresponds in each case to one row of Table T.

Table 2-46 Methods and uses, wherein the mixture of compound A2 and Gamma-cyhalothrin is applied plant and/or pests which corresponds in each case to one row of Table T.

Table 2-47 Methods and uses, wherein the mixture of compound A2 and Fenpropathrin is applied plant and/or pests which corresponds in each case to one row of Table T.

Table 2-48 Methods and uses, wherein the mixture of compound A2 and Fenvalerate is applied plant and/or pests which corresponds in each case to one row of Table T.

Table 2-49 Methods and uses, wherein the mixture of compound A2 and Fluvalinate is applied plant and/or pests which corresponds in each case to one row of Table T.

Table 2-50 Methods and uses, wherein the mixture of compound A2 and Carbofuran is applied plant and/or pests which corresponds in each case to one row of Table T.

Table 2-51 Methods and uses, wherein the mixture of compound A2 and Novaluron is applied plant and/or pests which corresponds in each case to one row of Table T.

Table 2-52 Methods and uses, wherein the mixture of compound A2 and Cyflumetofen is applied plant and/or pests which corresponds in each case to one row of Table T.

Table 2-53 Methods and uses, wherein the mixture of compound A2 and Bifenazate is applied plant and/or pests which corresponds in each case to one row of Table T.

Table 3-1 Methods and uses, wherein the mixture of compound A3 and Lambda cyhalothrin is applied to plant and/or pests and wherein R^{2b}, R^{2c} and R³ corresponds in each case to one row of Table T.

Table 3-2 Methods and uses, wherein the mixture of compound A3 and Bifenthrin is applied to plant and/or pests and wherein R^{2b}, R^{2c} and R³ corresponds in each case to one row of Table T.

Table 3-3 Methods and uses, wherein the mixture of compound A3 and Afidopyropen is applied to plant and/or pests and wherein R^{2b}, R^{2c} and R³ corresponds in each case to one row of Table T.

Table 3-4 Methods and uses, wherein the mixture of compound A3 and Broflanilide is applied to plant and/or pests and wherein R^{2b}, R^{2c} and R³ corresponds in each case to one row of Table T.

Table 3-5 Methods and uses, wherein the mixture of compound A3 and Flubendiamide is applied to plant and/or pests and wherein R^{2b}, R^{2c} and R³ corresponds in each case to one row of Table T.

Table 3-6 Methods and uses, wherein the mixture of compound A3 and Chlorfenapyr is applied to plant and/or pests and wherein R^{2b}, R^{2c} and R³ corresponds in each case to one row of Table T.

Table 3-7 Methods and uses, wherein the mixture of compound A3 and Ethiprole is applied to plant and/or pests and wherein R^{2b}, R^{2c} and R³ corresponds in each case to one row of Table T.

Table 3-8 Methods and uses, wherein the mixture of compound A3 and Dinotefuran is applied to plant and/or pests and wherein R^{2b}, R^{2c} and R³ corresponds in each case to one row of Table T.

Table 3-9 Methods and uses, wherein the mixture of compound A3 and Sulfoxaflor is applied to plant and/or pests and wherein R^{2b}, R^{2c} and R³ corresponds in each case to one row of Table T.

Table 3-10 Methods and uses, wherein the mixture of compound A3 and Clothianidin is applied to plant and/or pests and wherein R^{2b}, R^{2c} and R³ corresponds in each case to one row of Table T.

Table 3-11 Methods and uses, wherein the mixture of compound A3 and Thiacloprid is applied to plant and/or pests and wherein R^{2b}, R^{2c} and R³ corresponds in each case to one row of Table T.

Table 3-12 Methods and uses, wherein the mixture of compound A3 and Flupyradifuron is applied to plant and/or pests and wherein R^{2b}, R^{2c} and R³ corresponds in each case to one row of Table T.

Table 3-13 Methods and uses, wherein the mixture of compound A3 and Imidacloprid is applied to plant and/or pests and wherein R^{2b}, R^{2c} and R³ corresponds in each case to one row of Table T.

Table 3-14 Methods and uses, wherein the mixture of compound A3 and Fipronil is applied to plant and/or pests and wherein R^{2b}, R^{2c} and R³ corresponds in each case to one row of Table T.

Table 3-15 Methods and uses, wherein the mixture of compound A3 and Ivermectin is applied to plant and/or pests and wherein R^{2b}, R^{2c} and R³ corresponds in each case to one row of Table T.

Table 3-16 Methods and uses, wherein the mixture of compound A3 and Abamectin is applied to plant and/or pests and wherein R^{2b}, R^{2c} and R³ corresponds in each case to one row of Table T.

Table 3-17 Methods and uses, wherein the mixture of compound A3 and Spinosad is applied to plant and/or pests and wherein R^{2b}, R^{2c} and R³ corresponds in each case to one row of Table T.

Table 3-18 Methods and uses, wherein the mixture of compound A3 and Thiamethoxam is applied to plant and/or pests and wherein R^{2b}, R^{2c} and R³ corresponds in each case to one row of Table T.

Table 3-19 Methods and uses, wherein the mixture of compound A3 and Indoxacarb is applied plant and/or pests and wherein R^{2b}, R^{2c} and R³ corresponds in each case to one row of Table T.

Table 3-20 Methods and uses, wherein the mixture of compound A3 and Deltamethrin is applied to plant and/or pests and wherein R^{2b}, R^{2c} and R³ corresponds in each case to one row of Table T.

Table 3-21 Methods and uses, wherein the mixture of compound A3 and Metaflumizone is applied to plant and/or pests and wherein R^{2b}, R^{2c} and R³ corresponds in each case to one row of Table T.

Table 3-22 Methods and uses, wherein the mixture of compound A3 and Avermectin is applied to plant and/or pests and wherein R^{2b}, R^{2c} and R³ corresponds in each case to one row of Table T.

Table 3-23 Methods and uses, wherein the mixture of compound A3 and Emamectin is applied to plant and/or pests and wherein R^{2b}, R^{2c} and R³ corresponds in each case to one row of Table T.

Table 3-24 Methods and uses, wherein the mixture of compound A3 and Methomyl is applied to plant and/or pests and wherein R^{2b}, R^{2c} and R³ corresponds in each case to one row of Table T.

Table 3-25 Methods and uses, wherein the mixture of compound A3 and Lufenuron is applied to plant and/or pests and wherein R^{2b}, R^{2c} and R³ corresponds in each case to one row of Table T.

Table 3-26 Methods and uses, wherein the mixture of compound A3 and Buprofezin is applied to plant and/or pests and wherein R^{2b}, R^{2c} and R³ corresponds in each case to one row of Table T.

Table 3-27 Methods and uses, wherein the mixture of compound A3 and Teflubenzuron is applied to plant and/or pests and wherein R^{2b}, R^{2c} and R³ corresponds in each case to one row of Table T.

Table 3-28 Methods and uses, wherein the mixture of compound A3 and Chlorantraniliprole is applied to plant and/or pests and wherein R^{2b}, R^{2c} and R³ corresponds in each case to one row of Table T.

Table 3-29 Methods and uses, wherein the mixture of compound A3 and Cyantraniliprole is applied to plant and/or pests and wherein R^{2b}, R^{2c} and R³ corresponds in each case to one row of Table T.

Table 3-30 Methods and uses, wherein the mixture of compound A3 and Tetraniliprole is applied to plant and/or pests and wherein R^{2b}, R^{2c} and R³ corresponds in each case to one row of Table T.

Table 3-31 Methods and uses, wherein the mixture of compound A3 and Cyclaniliprole is applied to plant and/or pests and wherein R^{2b}, R^{2c} and R³ corresponds in each case to one row of Table T.

Table 3-32 Methods and uses, wherein the mixture of compound A3 and Flonicamid is applied to plant and/or pests and wherein R^{2b}, R^{2c} and R³ corresponds in each case to one row of Table T.

Table 3-33 Methods and uses, wherein the mixture of compound A3 and Pymetrozine is applied to plant and/or pests and wherein R^{2b}, R^{2c} and R³ corresponds in each case to one row of Table T.

Table 3-34 Methods and uses, wherein the mixture of compound A3 and Spirotetramat is applied plant and/or pests and wherein R^{2b}, R^{2c} and R³ corresponds in each case to one row of Table T.

Table 3-35 Methods and uses, wherein the mixture of compound A3 and alpha-cypermethrin is applied plant and/or pests which corresponds in each case to one row of Table T.

Table 3-36 Methods and uses, wherein the mixture of compound A3 and Acetamiprid is applied plant and/or pests which corresponds in each case to one row of Table T.

Table 3-37 Methods and uses, wherein the mixture of compound A3 and Chlorpyrifos is applied plant and/or pests which corresponds in each case to one row of Table T.

Table 3-38 Methods and uses, wherein the mixture of compound A3 and Acephate is applied plant and/or pests which corresponds in each case to one row of Table T.

Table 3-39 Methods and uses, wherein the mixture of compound A3 and Permethrin is applied plant and/or pests which corresponds in each case to one row of Table T.

Table 3-40 Methods and uses, wherein the mixture of compound A3 and Cypermethrin is applied plant and/or pests which corresponds in each case to one row of Table T.

Table 3-41 Methods and uses, wherein the mixture of compound A3 and Cyfluthrin is applied plant and/or pests which corresponds in each case to one row of Table T.

Table 3-42 Methods and uses, wherein the mixture of compound A3 and Zeta-cypermethrin is applied plant and/or pests which corresponds in each case to one row of Table T.

Table 3-43 Methods and uses, wherein the mixture of compound A3 and Tefluthrin is applied plant and/or pests which corresponds in each case to one row of Table T.

Table 3-44 Methods and uses, wherein the mixture of compound A3 and Esfenvalerate is applied plant and/or pests which corresponds in each case to one row of Table T.

Table 3-45 Methods and uses, wherein the mixture of compound A3 and Etofenprox is applied plant and/or pests which corresponds in each case to one row of Table T.

Table 3-46 Methods and uses, wherein the mixture of compound A3 and Gamma-cyhalothrin is applied plant and/or pests which corresponds in each case to one row of Table T.

Table 3-47 Methods and uses, wherein the mixture of compound A3 and Fenpropathrin is applied plant and/or pests which corresponds in each case to one row of Table T.

Table 3-48 Methods and uses, wherein the mixture of compound A3 and Fenvalerate is applied plant and/or pests which corresponds in each case to one row of Table T.

Table 3-49 Methods and uses, wherein the mixture of compound A3 and Fluvalinate is applied plant and/or pests which corresponds in each case to one row of Table T.

Table 3-50 Methods and uses, wherein the mixture of compound A3 and Carbofuran is applied plant and/or pests which corresponds in each case to one row of Table T.

Table 3-51 Methods and uses, wherein the mixture of compound A3 and Novaluron is applied plant and/or pests which corresponds in each case to one row of Table T.

Table 3-52 Methods and uses, wherein the mixture of compound A3 and Cyflumetofen is applied plant and/or pests which corresponds in each case to one row of Table T.

Table 3-53 Methods and uses, wherein the mixture of compound A3 and Bifenazate is applied plant and/or pests which corresponds in each case to one row of Table T.

Table 4-1 Methods and uses, wherein the mixture of compound A4 and Lambda cyhalothrin is applied to plant and/or pests and wherein R^{2b}, R^{2c} and R³ corresponds in each case to one row of Table T.

Table 4-2 Methods and uses, wherein the mixture of compound A4 and Bifenthrin is applied to plant and/or pests and wherein R^{2b}, R^{2c} and R³ corresponds in each case to one row of Table T.

Table 4-3 Methods and uses, wherein the mixture of compound A4 and Afidopyropen is applied to plant and/or pests and wherein R^{2b}, R^{2c} and R³ corresponds in each case to one row of Table T.

Table 4-4 Methods and uses, wherein the mixture of compound A4 and Broflanilide is applied to plant and/or pests and wherein R^{2b}, R^{2c} and R³ corresponds in each case to one row of Table T.

Table 4-5 Methods and uses, wherein the mixture of compound A4 and Flubendiamide is applied to plant and/or pests and wherein R^{2b}, R^{2c} and R³ corresponds in each case to one row of Table T.

Table 4-6 Methods and uses, wherein the mixture of compound A4 and Chlorfenapyr is applied to plant and/or pests and wherein R^{2b}, R^{2c} and R³ corresponds in each case to one row of Table T.

Table 4-7 Methods and uses, wherein the mixture of compound A4 and Ethiprole is applied to plant and/or pests and wherein R^{2b}, R^{2c} and R³ corresponds in each case to one row of Table T.

Table 4-8 Methods and uses, wherein the mixture of compound A4 and Dinotefuran is applied to plant and/or pests and wherein R^{2b}, R^{2c} and R³ corresponds in each case to one row of Table T.

Table 4-9 Methods and uses, wherein the mixture of compound A4 and Sulfoxaflor is applied to plant and/or pests and wherein R^{2b}, R^{2c} and R³ corresponds in each case to one row of Table T.

Table 4-10 Methods and uses, wherein the mixture of compound A4 and Clothianidin is applied to plant and/or pests and wherein R^{2b}, R^{2c} and R³ corresponds in each case to one row of Table T.

Table 4-11 Methods and uses, wherein the mixture of compound A4 and Thiacloprid is applied to plant and/or pests and wherein R^{2b}, R^{2c} and R³ corresponds in each case to one row of Table T.

Table 4-12 Methods and uses, wherein the mixture of compound A4 and Flupyradifuron is applied to plant and/or pests and wherein R^{2b}, R^{2c} and R³ corresponds in each case to one row of Table T.

Table 4-13 Methods and uses, wherein the mixture of compound A4 and Imidacloprid is applied to plant and/or pests and wherein R^{2b}, R^{2c} and R³ corresponds in each case to one row of Table T.

Table 4-14 Methods and uses, wherein the mixture of compound A4 and Fipronil is applied to plant and/or pests and wherein R^{2b}, R^{2c} and R³ corresponds in each case to one row of Table T.

Table 4-15 Methods and uses, wherein the mixture of compound A4 and Ivermectin is applied to plant and/or pests and wherein R^{2b}, R^{2c} and R³ corresponds in each case to one row of Table T.

Table 4-16 Methods and uses, wherein the mixture of compound A4 and Abamectin is applied to plant and/or pests and wherein R^{2b}, R^{2c} and R³ corresponds in each case to one row of Table T.

Table 4-17 Methods and uses, wherein the mixture of compound A4 and Spinosad is applied to plant and/or pests and wherein R^{2b}, R^{2c} and R³ corresponds in each case to one row of Table T.

Table 4-18 Methods and uses, wherein the mixture of compound A4 and Thiamethoxam is applied to plant and/or pests and wherein R^{2b}, R^{2c} and R³ corresponds in each case to one row of Table T.

Table 4-19 Methods and uses, wherein the mixture of compound A4 and Indoxacarb is applied plant and/or pests and wherein R^{2b}, R^{2c} and R³ corresponds in each case to one row of Table T.

Table 4-20 Methods and uses, wherein the mixture of compound A4 and Deltamethrin is applied to plant and/or pests and wherein R^{2b}, R^{2c} and R³ corresponds in each case to one row of Table T.

Table 4-21 Methods and uses, wherein the mixture of compound A4 and Metaflumizone is applied to plant and/or pests and wherein R^{2b}, R^{2c} and R³ corresponds in each case to one row of Table T.

Table 4-22 Methods and uses, wherein the mixture of compound A4 and Avermectin is applied to plant and/or pests and wherein R^{2b}, R^{2c} and R³ corresponds in each case to one row of Table T.

Table 4-23 Methods and uses, wherein the mixture of compound A4 and Emamectin is applied to plant and/or pests and wherein R^{2b}, R^{2c} and R³ corresponds in each case to one row of Table T.

Table 4-24 Methods and uses, wherein the mixture of compound A4 and Methomyl is applied to plant and/or pests and wherein R^{2b}, R^{2c} and R³ corresponds in each case to one row of Table T.

Table 4-25 Methods and uses, wherein the mixture of compound A4 and Lufenuron is applied to plant and/or pests and wherein R^{2b}, R^{2c} and R³ corresponds in each case to one row of Table T.

Table 4-26 Methods and uses, wherein the mixture of compound A4 and Buprofezin is applied to plant and/or pests and wherein R^{2b}, R^{2c} and R³ corresponds in each case to one row of Table T.

Table 4-27 Methods and uses, wherein the mixture of compound A4 and Teflubenzuron is applied to plant and/or pests and wherein R^{2b}, R^{2c} and R³ corresponds in each case to one row of Table T.

Table 4-28 Methods and uses, wherein the mixture of compound A4 and Chlorantraniliprole is applied to plant and/or pests and wherein R^{2b}, R^{2c} and R³ corresponds in each case to one row of Table T.

Table 4-29 Methods and uses, wherein the mixture of compound A4 and Cyantraniliprole is applied to plant and/or pests and wherein R^{2b}, R^{2c} and R³ corresponds in each case to one row of Table T.

Table 4-30 Methods and uses, wherein the mixture of compound A4 and Tetraniliprole is applied to plant and/or pests and wherein R^{2b}, R^{2c} and R³ corresponds in each case to one row of Table T.

Table 4-31 Methods and uses, wherein the mixture of compound A4 and Cyclaniliprole is applied to plant and/or pests and wherein R^{2b}, R^{2c} and R³ corresponds in each case to one row of Table T.

Table 4-32 Methods and uses, wherein the mixture of compound A4 and Flonicamid is applied to plant and/or pests and wherein R^{2b}, R^{2c} and R³ corresponds in each case to one row of Table T.

Table 4-33 Methods and uses, wherein the mixture of compound A4 and Pymetrozine is applied to plant and/or pests and wherein R^{2b}, R^{2c} and R³ corresponds in each case to one row of Table T.

Table 4-34 Methods and uses, wherein the mixture of compound A4 and Spirotetramat is applied plant and/or pests and wherein R^{2b}, R^{2c} and R³ corresponds in each case to one row of Table T.

Table 4-35 Methods and uses, wherein the mixture of compound A4 and alpha-cypermethrin is applied plant and/or pests which corresponds in each case to one row of Table T.

Table 4-36 Methods and uses, wherein the mixture of compound A4 and Acetamiprid is applied plant and/or pests which corresponds in each case to one row of Table T.

Table 4-37 Methods and uses, wherein the mixture of compound A4 and Chlorpyrifos is applied plant and/or pests which corresponds in each case to one row of Table T.

Table 4-38 Methods and uses, wherein the mixture of compound A4 and Acephate is applied plant and/or pests which corresponds in each case to one row of Table T.

Table 4-39 Methods and uses, wherein the mixture of compound A4 and Permethrin is applied plant and/or pests which corresponds in each case to one row of Table T.

Table 4-40 Methods and uses, wherein the mixture of compound A4 and Cypermethrin is applied plant and/or pests which corresponds in each case to one row of Table T.

Table 4-41 Methods and uses, wherein the mixture of compound A4 and Cyfluthrin is applied plant and/or pests which corresponds in each case to one row of Table T.

Table 4-42 Methods and uses, wherein the mixture of compound A4 and Zeta-cypermethrin is applied plant and/or pests which corresponds in each case to one row of Table T.

Table 4-43 Methods and uses, wherein the mixture of compound A4 and Tefluthrin is applied plant and/or pests which corresponds in each case to one row of Table T.

Table 4-44 Methods and uses, wherein the mixture of compound A4 and Esfenvalerate is applied plant and/or pests which corresponds in each case to one row of Table T.

Table 4-45 Methods and uses, wherein the mixture of compound A4 and Etofenprox is applied plant and/or pests which corresponds in each case to one row of Table T.

Table 4-46 Methods and uses, wherein the mixture of compound A4 and Gamma-cyhalothrin is applied plant and/or pests which corresponds in each case to one row of Table T.

Table 4-47 Methods and uses, wherein the mixture of compound A4 and Fenpropathrin is applied plant and/or pests which corresponds in each case to one row of Table T.

Table 4-48 Methods and uses, wherein the mixture of compound A4 and Fenvalerate is applied plant and/or pests which corresponds in each case to one row of Table T.

Table 4-49 Methods and uses, wherein the mixture of compound A4 and Fluvalinate is applied plant and/or pests which corresponds in each case to one row of Table T.

Table 4-50 Methods and uses, wherein the mixture of compound A4 and Carbofuran is applied plant and/or pests which corresponds in each case to one row of Table T.

Table 4-51 Methods and uses, wherein the mixture of compound A4 and Novaluron is applied plant and/or pests which corresponds in each case to one row of Table T.

Table 4-52 Methods and uses, wherein the mixture of compound A4 and Cyflumetofen is applied plant and/or pests which corresponds in each case to one row of Table T.

Table 4-53 Methods and uses, wherein the mixture of compound A4 and Bifenazate is applied plant and/or pests which corresponds in each case to one row of Table T.

Table 5-1 Methods and uses, wherein the mixture of compound A5 and Lambda cyhalothrin is applied to plant and/or pests and wherein R^{2b}, R^{2c} and R³ corresponds in each case to one row of Table T.

Table 5-2 Methods and uses, wherein the mixture of compound A5 and Bifenthrin is applied to plant and/or pests and wherein R^{2b}, R^{2c} and R³ corresponds in each case to one row of Table T.

Table 5-3 Methods and uses, wherein the mixture of compound A5 and Afidopyropen is applied to plant and/or pests and wherein R^{2b}, R^{2c} and R³ corresponds in each case to one row of Table T.

Table 5-4 Methods and uses, wherein the mixture of compound A5 and Broflanilide is applied to plant and/or pests and wherein R^{2b}, R^{2c} and R³ corresponds in each case to one row of Table T.

Table 5-5 Methods and uses, wherein the mixture of compound A5 and Flubendiamide is applied to plant and/or pests and wherein R^{2b}, R^{2c} and R³ corresponds in each case to one row of Table T.

Table 5-6 Methods and uses, wherein the mixture of compound A5 and Chlorfenapyr is applied to plant and/or pests and wherein R^{2b}, R^{2c} and R³ corresponds in each case to one row of Table T.

Table 5-7 Methods and uses, wherein the mixture of compound A5 and Ethiprole is applied to plant and/or pests and wherein R^{2b}, R^{2c} and R³ corresponds in each case to one row of Table T.

Table 5-8 Methods and uses, wherein the mixture of compound A5 and Dinotefuran is applied to plant and/or pests and wherein R^{2b}, R^{2c} and R³ corresponds in each case to one row of Table T.

Table 5-9 Methods and uses, wherein the mixture of compound A5 and Sulfoxaflor is applied to plant and/or pests and wherein R^{2b}, R^{2c} and R³ corresponds in each case to one row of Table T.

Table 5-10 Methods and uses, wherein the mixture of compound A5 and Clothianidin is applied to plant and/or pests and wherein R^{2b}, R^{2c} and R³ corresponds in each case to one row of Table T.

Table 5-11 Methods and uses, wherein the mixture of compound A5 and Thiacloprid is applied to plant and/or pests and wherein R^{2b}, R^{2c} and R³ corresponds in each case to one row of Table T.

Table 5-12 Methods and uses, wherein the mixture of compound A5 and Flupyradifuron is applied to plant and/or pests and wherein R^{2b}, R^{2c} and R³ corresponds in each case to one row of Table T.

Table 5-13 Methods and uses, wherein the mixture of compound A5 and Imidacloprid is applied to plant and/or pests and wherein R^{2b}, R^{2c} and R³ corresponds in each case to one row of Table T.

Table 5-14 Methods and uses, wherein the mixture of compound A5 and Fipronil is applied to plant and/or pests and wherein R^{2b}, R^{2c} and R³ corresponds in each case to one row of Table T.

Table 5-15 Methods and uses, wherein the mixture of compound A5 and Ivermectin is applied to plant and/or pests and wherein R^{2b}, R^{2c} and R³ corresponds in each case to one row of Table T.

Table 5-16 Methods and uses, wherein the mixture of compound A5 and Abamectin is applied to plant and/or pests and wherein R^{2b}, R^{2c} and R³ corresponds in each case to one row of Table T.

Table 5-17 Methods and uses, wherein the mixture of compound A5 and Spinosad is applied to plant and/or pests and wherein R^{2b}, R^{2c} and R³ corresponds in each case to one row of Table T.

Table 5-18 Methods and uses, wherein the mixture of compound A5 and Thiamethoxam is applied to plant and/or pests and wherein R^{2b}, R^{2c} and R³ corresponds in each case to one row of Table T.

Table 5-19 Methods and uses, wherein the mixture of compound A5 and Indoxacarb is applied plant and/or pests and wherein R^{2b}, R^{2c} and R³ corresponds in each case to one row of Table T.

Table 5-20 Methods and uses, wherein the mixture of compound A5 and Deltamethrin is applied to plant and/or pests and wherein R^{2b}, R^{2c} and R³ corresponds in each case to one row of Table T.

Table 5-21 Methods and uses, wherein the mixture of compound A5 and Metaflumizone is applied to plant and/or pests and wherein R^{2b}, R^{2c} and R³ corresponds in each case to one row of Table T.

Table 5-22 Methods and uses, wherein the mixture of compound A5 and Avermectin is applied to plant and/or pests and wherein R^{2b}, R^{2c} and R³ corresponds in each case to one row of Table T.

Table 5-23 Methods and uses, wherein the mixture of compound A5 and Emamectin is applied to plant and/or pests and wherein R^{2b}, R^{2c} and R³ corresponds in each case to one row of Table T.

Table 5-24 Methods and uses, wherein the mixture of compound A5 and Methomyl is applied to plant and/or pests and wherein R^{2b}, R^{2c} and R³ corresponds in each case to one row of Table T.

Table 5-25 Methods and uses, wherein the mixture of compound A5 and Lufenuron is applied to plant and/or pests and wherein R^{2b}, R^{2c} and R³ corresponds in each case to one row of Table T.

Table 5-26 Methods and uses, wherein the mixture of compound A5 and Buprofezin is applied to plant and/or pests and wherein R^{2b}, R^{2c} and R³ corresponds in each case to one row of Table T.

Table 5-27 Methods and uses, wherein the mixture of compound A5 and Teflubenzuron is applied to plant and/or pests and wherein R^{2b}, R^{2c} and R³ corresponds in each case to one row of Table T.

Table 5-28 Methods and uses, wherein the mixture of compound A5 and Chlorantraniliprole is applied to plant and/or pests and wherein R^{2b}, R^{2c} and R³ corresponds in each case to one row of Table T.

Table 5-29 Methods and uses, wherein the mixture of compound A5 and Cyantraniliprole is applied to plant and/or pests and wherein R^{2b}, R^{2c} and R³ corresponds in each case to one row of Table T.

Table 5-30 Methods and uses, wherein the mixture of compound A5 and Tetraniliprole is applied to plant and/or pests and wherein R^{2b}, R^{2c} and R³ corresponds in each case to one row of Table T.

Table 5-31 Methods and uses, wherein the mixture of compound A5 and Cyclaniliprole is applied to plant and/or pests and wherein R^{2b}, R^{2c} and R³ corresponds in each case to one row of Table T.

Table 5-32 Methods and uses, wherein the mixture of compound A5 and Flonicamid is applied to plant and/or pests and wherein R^{2b}, R^{2c} and R³ corresponds in each case to one row of Table T.

Table 5-33 Methods and uses, wherein the mixture of compound A5 and Pymetrozine is applied to plant and/or pests and wherein R^{2b}, R^{2c} and R³ corresponds in each case to one row of Table T.

Table 5-34 Methods and uses, wherein the mixture of compound A5 and Spirotetramat is applied plant and/or pests and wherein R^{2b}, R^{2c} and R³ corresponds in each case to one row of Table T.

Table 5-35 Methods and uses, wherein the mixture of compound A5 and alpha-cypermethrin is applied plant and/or pests which corresponds in each case to one row of Table T.

Table 5-36 Methods and uses, wherein the mixture of compound A5 and Acetamiprid is applied plant and/or pests which corresponds in each case to one row of Table T.

Table 5-37 Methods and uses, wherein the mixture of compound A5 and Chlorpyrifos is applied plant and/or pests which corresponds in each case to one row of Table T.

Table 5-38 Methods and uses, wherein the mixture of compound A5 and Acephate is applied plant and/or pests which corresponds in each case to one row of Table T.

Table 5-39 Methods and uses, wherein the mixture of compound A5 and Permethrin is applied plant and/or pests which corresponds in each case to one row of Table T.

Table 5-40 Methods and uses, wherein the mixture of compound A5 and Cypermethrin is applied plant and/or pests which corresponds in each case to one row of Table T.

Table 5-41 Methods and uses, wherein the mixture of compound A5 and Cyfluthrin is applied plant and/or pests which corresponds in each case to one row of Table T.

Table 5-42 Methods and uses, wherein the mixture of compound A5 and Zeta-cypermethrin is applied plant and/or pests which corresponds in each case to one row of Table T.

Table 5-43 Methods and uses, wherein the mixture of compound A5 and Tefluthrin is applied plant and/or pests which corresponds in each case to one row of Table T.

Table 5-44 Methods and uses, wherein the mixture of compound A5 and Esfenvalerate is applied plant and/or pests which corresponds in each case to one row of Table T.

Table 5-45 Methods and uses, wherein the mixture of compound A5 and Etofenprox is applied plant and/or pests which corresponds in each case to one row of Table T.

Table 5-46 Methods and uses, wherein the mixture of compound A5 and Gamma-cyhalothrin is applied plant and/or pests which corresponds in each case to one row of Table T.

Table 5-47 Methods and uses, wherein the mixture of compound A5 and Fenpropathrin is applied plant and/or pests which corresponds in each case to one row of Table T.

Table 5-48 Methods and uses, wherein the mixture of compound A5 and Fenvalerate is applied plant and/or pests which corresponds in each case to one row of Table T.

Table 5-49 Methods and uses, wherein the mixture of compound A5 and Fluvalinate is applied plant and/or pests which corresponds in each case to one row of Table T.

Table 5-50 Methods and uses, wherein the mixture of compound A5 and Carbofuran is applied plant and/or pests which corresponds in each case to one row of Table T.

Table 5-51 Methods and uses, wherein the mixture of compound A5 and Novaluron is applied plant and/or pests which corresponds in each case to one row of Table T.

Table 5-52 Methods and uses, wherein the mixture of compound A5 and Cyflumetofen is applied plant and/or pests which corresponds in each case to one row of Table T.

Table 5-53 Methods and uses, wherein the mixture of compound A5 and Bifenazate is applied plant and/or pests which corresponds in each case to one row of Table T.

Table 6-1 Methods and uses, wherein the mixture of compound A6 and Lambda cyhalothrin is applied to plant and/or pests and wherein R^{2b}, R^{2c} and R³ corresponds in each case to one row of Table T.

Table 6-2 Methods and uses, wherein the mixture of compound A6 and Bifenthrin is applied to plant and/or pests and wherein R^{2b}, R^{2c} and R³ corresponds in each case to one row of Table T.

Table 6-3 Methods and uses, wherein the mixture of compound A6 and Afidopyropen is applied to plant and/or pests and wherein R^{2b}, R^{2c} and R³ corresponds in each case to one row of Table T.

Table 6-4 Methods and uses, wherein the mixture of compound A6 and Broflanilide is applied to plant and/or pests and wherein R^{2b}, R^{2c} and R³ corresponds in each case to one row of Table T.

Table 6-5 Methods and uses, wherein the mixture of compound A6 and Flubendiamide is applied to plant and/or pests and wherein R^{2b}, R^{2c} and R³ corresponds in each case to one row of Table T.

Table 6-6 Methods and uses, wherein the mixture of compound A6 and Chlorfenapyr is applied to plant and/or pests and wherein R^{2b}, R^{2c} and R³ corresponds in each case to one row of Table T.

Table 6-7 Methods and uses, wherein the mixture of compound A6 and Ethiprole is applied to plant and/or pests and wherein R^{2b}, R^{2c} and R³ corresponds in each case to one row of Table T.

Table 6-8 Methods and uses, wherein the mixture of compound A6 and Dinotefuran is applied to plant and/or pests and wherein R^{2b}, R^{2c} and R³ corresponds in each case to one row of Table T.

Table 6-9 Methods and uses, wherein the mixture of compound A6 and Sulfoxaflor is applied to plant and/or pests and wherein R^{2b}, R^{2c} and R³ corresponds in each case to one row of Table T.

Table 6-10 Methods and uses, wherein the mixture of compound A6 and Clothianidin is applied to plant and/or pests and wherein R^{2b}, R^{2c} and R³ corresponds in each case to one row of Table T.

Table 6-11 Methods and uses, wherein the mixture of compound A6 and Thiacloprid is applied to plant and/or pests and wherein R^{2b}, R^{2c} and R³ corresponds in each case to one row of Table T.

Table 6-12 Methods and uses, wherein the mixture of compound A6 and Flupyradifuron is applied to plant and/or pests and wherein R^{2b}, R^{2c} and R³ corresponds in each case to one row of Table T.

Table 6-13 Methods and uses, wherein the mixture of compound A6 and Imidacloprid is applied to plant and/or pests and wherein R^{2b}, R^{2c} and R³ corresponds in each case to one row of Table T.

Table 6-14 Methods and uses, wherein the mixture of compound A6 and Fipronil is applied to plant and/or pests and wherein R^{2b}, R^{2c} and R³ corresponds in each case to one row of Table T.

Table 6-15 Methods and uses, wherein the mixture of compound A6 and Ivermectin is applied to plant and/or pests and wherein R^{2b}, R^{2c} and R³ corresponds in each case to one row of Table T.

Table 6-16 Methods and uses, wherein the mixture of compound A6 and Abamectin is applied to plant and/or pests and wherein R^{2b}, R^{2c} and R³ corresponds in each case to one row of Table T.

Table 6-17 Methods and uses, wherein the mixture of compound A6 and Spinosad is applied to plant and/or pests and wherein R^{2b}, R^{2c} and R³ corresponds in each case to one row of Table T.

Table 6-18 Methods and uses, wherein the mixture of compound A6 and Thiamethoxam is applied to plant and/or pests and wherein R^{2b}, R^{2c} and R³ corresponds in each case to one row of Table T.

Table 6-19 Methods and uses, wherein the mixture of compound A6 and Indoxacarb is applied plant and/or pests and wherein R^{2b}, R^{2c} and R³ corresponds in each case to one row of Table T.

Table 6-20 Methods and uses, wherein the mixture of compound A6 and Deltamethrin is applied to plant and/or pests and wherein R^{2b}, R^{2c} and R³ corresponds in each case to one row of Table T.

Table 6-21 Methods and uses, wherein the mixture of compound A6 and Metaflumizone is applied to plant and/or pests and wherein R^{2b}, R^{2c} and R³ corresponds in each case to one row of Table T.

Table 6-22 Methods and uses, wherein the mixture of compound A6 and Avermectin is applied to plant and/or pests and wherein R^{2b}, R^{2c} and R³ corresponds in each case to one row of Table T.

Table 6-23 Methods and uses, wherein the mixture of compound A6 and Emamectin is applied to plant and/or pests and wherein R^{2b}, R^{2c} and R³ corresponds in each case to one row of Table T.

Table 6-24 Methods and uses, wherein the mixture of compound A6 and Methomyl is applied to plant and/or pests and wherein R^{2b}, R^{2c} and R³ corresponds in each case to one row of Table T.

Table 6-25 Methods and uses, wherein the mixture of compound A6 and Lufenuron is applied to plant and/or pests and wherein R^{2b}, R^{2c} and R³ corresponds in each case to one row of Table T.

Table 6-26 Methods and uses, wherein the mixture of compound A6 and Buprofezin is applied to plant and/or pests and wherein R^{2b}, R^{2c} and R³ corresponds in each case to one row of Table T.

Table 6-27 Methods and uses, wherein the mixture of compound A6 and Teflubenzuron is applied to plant and/or pests and wherein R^{2b}, R^{2c} and R³ corresponds in each case to one row of Table T.

Table 6-28 Methods and uses, wherein the mixture of compound A6 and Chlorantraniliprole is applied to plant and/or pests and wherein R^{2b}, R^{2c} and R³ corresponds in each case to one row of Table T.

Table 6-29 Methods and uses, wherein the mixture of compound A6 and Cyantraniliprole is applied to plant and/or pests and wherein R^{2b}, R^{2c} and R³ corresponds in each case to one row of Table T.

Table 6-30 Methods and uses, wherein the mixture of compound A6 and Tetraniliprole is applied to plant and/or pests and wherein R^{2b}, R^{2c} and R³ corresponds in each case to one row of Table T.

Table 6-31 Methods and uses, wherein the mixture of compound A6 and Cyclaniliprole is applied to plant and/or pests and wherein R^{2b}, R^{2c} and R³ corresponds in each case to one row of Table T.

Table 6-32 Methods and uses, wherein the mixture of compound A6 and Flonicamid is applied to plant and/or pests and wherein R^{2b}, R^{2c} and R³ corresponds in each case to one row of Table T.

Table 6-33 Methods and uses, wherein the mixture of compound A6 and Pymetrozine is applied to plant and/or pests and wherein R^{2b}, R^{2c} and R³ corresponds in each case to one row of Table T.

Table 6-34 Methods and uses, wherein the mixture of compound A6 and Spirotetramat is applied plant and/or pests and wherein R^{2b}, R^{2c} and R³ corresponds in each case to one row of Table T.

Table 6-35 Methods and uses, wherein the mixture of compound A6 and alpha-cypermethrin is applied plant and/or pests and wherein R^{2b}, R^{2c} and R³ corresponds in each case to one row of Table T.

Table 6-36 Methods and uses, wherein the mixture of compound A6 and Acetamiprid is applied plant and/or pests and wherein R^{2b}, R^{2c} and R³ corresponds in each case to one row of Table T.

Table 6-37 Methods and uses, wherein the mixture of compound A6 and Chlorpyrifos is applied plant and/or pests and wherein R^{2b}, R^{2c} and R³ corresponds in each case to one row of Table T.

Table 6-38 Methods and uses, wherein the mixture of compound A6 and Acephate is applied plant and/or pests and wherein R^{2b}, R^{2c} and R³ corresponds in each case to one row of Table T.

Table 6-39 Methods and uses, wherein the mixture of compound A6 and Permethrin is applied plant and/or pests and wherein R^{2b}, R^{2c} and R³ corresponds in each case to one row of Table T.

Table 6-40 Methods and uses, wherein the mixture of compound A6 and Cypermethrin is applied plant and/or pests and wherein R^{2b}, R^{2c} and R³ corresponds in each case to one row of Table T.

Table 6-41 Methods and uses, wherein the mixture of compound A6 and Cyfluthrin is applied plant and/or pests and wherein R^{2b}, R^{2c} and R³ corresponds in each case to one row of Table T.

Table 6-42 Methods and uses, wherein the mixture of compound A6 and Zeta-cypermethrin is applied plant and/or pests and wherein R^{2b}, R^{2c} and R³ corresponds in each case to one row of Table T.

Table 6-43 Methods and uses, wherein the mixture of compound A6 and Tefluthrin is applied plant and/or pests and wherein R^{2b}, R^{2c} and R³ corresponds in each case to one row of Table T.

Table 6-44 Methods and uses, wherein the mixture of compound A6 and Esfenvalerate is applied plant and/or pests and wherein R^{2b}, R^{2c} and R³ corresponds in each case to one row of Table T.

Table 6-45 Methods and uses, wherein the mixture of compound A6 and Etofenprox is applied plant and/or pests and wherein R^{2b}, R^{2c} and R³ corresponds in each case to one row of Table T.

Table 6-46 Methods and uses, wherein the mixture of compound A6 and Gamma-cyhalothrin is applied plant and/or pests and wherein R^{2b}, R^{2c} and R³ corresponds in each case to one row of Table T.

Table 6-47 Methods and uses, wherein the mixture of compound A6 and Fenpropathrin is applied plant and/or pests and wherein R^{2b}, R^{2c} and R³ corresponds in each case to one row of Table T.

Table 6-48 Methods and uses, wherein the mixture of compound A6 and Fenvalerate is applied plant and/or pests and wherein R^{2b}, R^{2c} and R³ corresponds in each case to one row of Table T.

Table 6-49 Methods and uses, wherein the mixture of compound A6 and Fluvalinate is applied plant and/or pests and wherein R^{2b}, R^{2c} and R³ corresponds in each case to one row of Table T.

Table 6-50 Methods and uses, wherein the mixture of compound A6 and Carbofuran is applied plant and/or pests and wherein R^{2b}, R^{2c} and R³ corresponds in each case to one row of Table T.

Table 6-51 Methods and uses, wherein the mixture of compound A6 and Novaluron is applied plant and/or pests and wherein R^{2b}, R^{2c} and R³ corresponds in each case to one row of Table T.

Table 6-52 Methods and uses, wherein the mixture of compound A6 and Cyflumetofen is applied plant and/or pests and wherein R^{2b}, R^{2c} and R³ corresponds in each case to one row of Table T.

Table 6-53 Methods and uses, wherein the mixture of compound A6 and Bifenazate is applied plant and/or pests and wherein R^{2b}, R^{2c} and R³ corresponds in each case to one row of Table T.

Table 7-1 Methods and uses, wherein the mixture of compound A7 and Lambda cyhalothrin is applied to plant and/or pests and wherein R^{2b}, R^{2c} and R³ corresponds in each case to one row of Table T.

Table 7-2 Methods and uses, wherein the mixture of compound A7 and Bifenthrin is applied to plant and/or pests and wherein R^{2b}, R^{2c} and R³ corresponds in each case to one row of Table T.

Table 7-3 Methods and uses, wherein the mixture of compound A7 and Afidopyropen is applied to plant and/or pests and wherein R^{2b}, R^{2c} and R³ corresponds in each case to one row of Table T.

Table 7-4 Methods and uses, wherein the mixture of compound A7 and Broflanilide is applied to plant and/or pests and wherein R^{2b}, R^{2c} and R³ corresponds in each case to one row of Table T.

Table 7-5 Methods and uses, wherein the mixture of compound A7 and Flubendiamide is applied to plant and/or pests and wherein R^{2b}, R^{2c} and R³ corresponds in each case to one row of Table T.

Table 7-6 Methods and uses, wherein the mixture of compound A7 and Chlorfenapyr is applied to plant and/or pests and wherein R^{2b}, R^{2c} and R³ corresponds in each case to one row of Table T.

Table 7-7 Methods and uses, wherein the mixture of compound A7 and Ethiprole is applied to plant and/or pests and wherein R^{2b}, R^{2c} and R³ corresponds in each case to one row of Table T.

Table 7-8 Methods and uses, wherein the mixture of compound A7 and Dinotefuran is applied to plant and/or pests and wherein R^{2b}, R^{2c} and R³ corresponds in each case to one row of Table T.

Table 7-9 Methods and uses, wherein the mixture of compound A7 and Sulfoxaflor is applied to plant and/or pests and wherein R^{2b}, R^{2c} and R³ corresponds in each case to one row of Table T.

Table 7-10 Methods and uses, wherein the mixture of compound A7 and Clothianidin is applied to plant and/or pests and wherein R^{2b}, R^{2c} and R³ corresponds in each case to one row of Table T.

Table 7-11 Methods and uses, wherein the mixture of compound A7 and Thiacloprid is applied to plant and/or pests and wherein R^{2b}, R^{2c} and R³ corresponds in each case to one row of Table T.

Table 7-12 Methods and uses, wherein the mixture of compound A7 and Flupyradifuron is applied to plant and/or pests and wherein R^{2b}, R^{2c} and R³ corresponds in each case to one row of Table T.

Table 7-13 Methods and uses, wherein the mixture of compound A7 and Imidacloprid is applied to plant and/or pests and wherein R^{2b}, R^{2c} and R³ corresponds in each case to one row of Table T.

Table 7-14 Methods and uses, wherein the mixture of compound A7 and Fipronil is applied to plant and/or pests and wherein R^{2b}, R^{2c} and R³ corresponds in each case to one row of Table T.

Table 7-15 Methods and uses, wherein the mixture of compound A7 and Ivermectin is applied to plant and/or pests and wherein R^{2b}, R^{2c} and R³ corresponds in each case to one row of Table T.

Table 7-16 Methods and uses, wherein the mixture of compound A7 and Abamectin is applied to plant and/or pests and wherein R^{2b}, R^{2c} and R³ corresponds in each case to one row of Table T.

Table 7-17 Methods and uses, wherein the mixture of compound A7 and Spinosad is applied to plant and/or pests and wherein R^{2b}, R^{2c} and R³ corresponds in each case to one row of Table T.

Table 7-18 Methods and uses, wherein the mixture of compound A7 and Thiamethoxam is applied to plant and/or pests and wherein R^{2b}, R^{2c} and R³ corresponds in each case to one row of Table T.

Table 7-19 Methods and uses, wherein the mixture of compound A7 and Indoxacarb is applied plant and/or pests and wherein R^{2b}, R^{2c} and R³ corresponds in each case to one row of Table T.

Table 7-20 Methods and uses, wherein the mixture of compound A7 and Deltamethrin is applied to plant and/or pests and wherein R^{2b}, R^{2c} and R³ corresponds in each case to one row of Table T.

Table 7-21 Methods and uses, wherein the mixture of compound A7 and Metaflumizone is applied to plant and/or pests and wherein R^{2b}, R^{2c} and R³ corresponds in each case to one row of Table T.

Table 7-22 Methods and uses, wherein the mixture of compound A7 and Avermectin is applied to plant and/or pests and wherein R^{2b}, R^{2c} and R³ corresponds in each case to one row of Table T.

Table 7-23 Methods and uses, wherein the mixture of compound A7 and Emamectin is applied to plant and/or pests and wherein R^{2b}, R^{2c} and R³ corresponds in each case to one row of Table T.

Table 7-24 Methods and uses, wherein the mixture of compound A7 and Methomyl is applied to plant and/or pests and wherein R^{2b}, R^{2c} and R³ corresponds in each case to one row of Table T.

Table 7-25 Methods and uses, wherein the mixture of compound A7 and Lufenuron is applied to plant and/or pests and wherein R^{2b}, R^{2c} and R³ corresponds in each case to one row of Table T.

Table 7-26 Methods and uses, wherein the mixture of compound A7 and Buprofezin is applied to plant and/or pests and wherein R^{2b}, R^{2c} and R³ corresponds in each case to one row of Table T.

Table 7-27 Methods and uses, wherein the mixture of compound A7 and Teflubenzuron is applied to plant and/or pests and wherein R^{2b}, R^{2c} and R³ corresponds in each case to one row of Table T.

Table 7-28 Methods and uses, wherein the mixture of compound A7 and Chlorantraniliprole is applied to plant and/or pests and wherein R^{2b}, R^{2c} and R³ corresponds in each case to one row of Table T.

Table 7-29 Methods and uses, wherein the mixture of compound A7 and Cyantraniliprole is applied to plant and/or pests and wherein R^{2b}, R^{2c} and R³ corresponds in each case to one row of Table T.

Table 7-30 Methods and uses, wherein the mixture of compound A7 and Tetraniliprole is applied to plant and/or pests and wherein R^{2b}, R^{2c} and R³ corresponds in each case to one row of Table T.

Table 7-31 Methods and uses, wherein the mixture of compound A7 and Cyclaniliprole is applied to plant and/or pests and wherein R^{2b}, R^{2c} and R³ corresponds in each case to one row of Table T.

Table 7-32 Methods and uses, wherein the mixture of compound A7 and Flonicamid is applied to plant and/or pests and wherein R^{2b}, R^{2c} and R³ corresponds in each case to one row of Table T.

Table 7-33 Methods and uses, wherein the mixture of compound A7 and Pymetrozine is applied to plant and/or pests and wherein R^{2b}, R^{2c} and R³ corresponds in each case to one row of Table T.

Table 7-34 Methods and uses, wherein the mixture of compound A7 and Spirotetramat is applied plant and/or pests and wherein R^{2b}, R^{2c} and R³ corresponds in each case to one row of Table T.

Table 7-35 Methods and uses, wherein the mixture of compound A7 and alpha-cypermethrin is applied plant and/or pests which corresponds in each case to one row of Table T.

Table 7-36 Methods and uses, wherein the mixture of compound A7 and Acetamiprid is applied plant and/or pests which corresponds in each case to one row of Table T.

Table 7-37 Methods and uses, wherein the mixture of compound A7 and Chlorpyrifos is applied plant and/or pests which corresponds in each case to one row of Table T.

Table 7-38 Methods and uses, wherein the mixture of compound A7 and Acephate is applied plant and/or pests which corresponds in each case to one row of Table T.

Table 7-39 Methods and uses, wherein the mixture of compound A7 and Permethrin is applied plant and/or pests which corresponds in each case to one row of Table T.

Table 7-40 Methods and uses, wherein the mixture of compound A7 and Cypermethrin is applied plant and/or pests which corresponds in each case to one row of Table T.

Table 7-41 Methods and uses, wherein the mixture of compound A7 and Cyfluthrin is applied plant and/or pests which corresponds in each case to one row of Table T.

Table 7-42 Methods and uses, wherein the mixture of compound A7 and Zeta-cypermethrin is applied plant and/or pests which corresponds in each case to one row of Table T.

Table 7-43 Methods and uses, wherein the mixture of compound A7 and Tefluthrin is applied plant and/or pests which corresponds in each case to one row of Table T.

Table 7-44 Methods and uses, wherein the mixture of compound A7 and Esfenvalerate is applied plant and/or pests which corresponds in each case to one row of Table T.

Table 7-45 Methods and uses, wherein the mixture of compound A7 and Etofenprox is applied plant and/or pests which corresponds in each case to one row of Table T.

Table 7-46 Methods and uses, wherein the mixture of compound A7 and Gamma-cyhalothrin is applied plant and/or pests which corresponds in each case to one row of Table T.

Table 7-47 Methods and uses, wherein the mixture of compound A7 and Fenpropathrin is applied plant and/or pests which corresponds in each case to one row of Table T.

Table 7-48 Methods and uses, wherein the mixture of compound A7 and Fenvalerate is applied plant and/or pests which corresponds in each case to one row of Table T.

Table 7-49 Methods and uses, wherein the mixture of compound A7 and Fluvalinate is applied plant and/or pests which corresponds in each case to one row of Table T.

Table 7-50 Methods and uses, wherein the mixture of compound A7 and Carbofuran is applied plant and/or pests which corresponds in each case to one row of Table T.

Table 7-51 Methods and uses, wherein the mixture of compound A7 and Novaluron is applied plant and/or pests which corresponds in each case to one row of Table T.

Table 7-52 Methods and uses, wherein the mixture of compound A7 and Cyflumetofen is applied plant and/or pests which corresponds in each case to one row of Table T.

Table 7-53 Methods and uses, wherein the mixture of compound A7 and Bifenazate is applied plant and/or pests which corresponds in each case to one row of Table T.

Table 8-1 Methods and uses, wherein the mixture of compound A8 and Lambda cyhalothrin is applied to plant and/or pests and wherein R^{2b}, R^{2c} and R³ corresponds in each case to one row of Table T.

Table 8-2 Methods and uses, wherein the mixture of compound A8 and Bifenthrin is applied to plant and/or pests and wherein R^{2b}, R^{2c} and R³ corresponds in each case to one row of Table T.

Table 8-3 Methods and uses, wherein the mixture of compound A8 and Afidopyropen is applied to plant and/or pests and wherein R^{2b}, R^{2c} and R³ corresponds in each case to one row of Table T.

Table 8-4 Methods and uses, wherein the mixture of compound A8 and Broflanilide is applied to plant and/or pests and wherein R^{2b}, R^{2c} and R³ corresponds in each case to one row of Table T.

Table 8-5 Methods and uses, wherein the mixture of compound A8 and Flubendiamide is applied to plant and/or pests and wherein R^{2b}, R^{2c} and R³ corresponds in each case to one row of Table T.

Table 8-6 Methods and uses, wherein the mixture of compound A8 and Chlorfenapyr is applied to plant and/or pests and wherein R^{2b}, R^{2c} and R³ corresponds in each case to one row of Table T.

Table 8-7 Methods and uses, wherein the mixture of compound A8 and Ethiprole is applied to plant and/or pests and wherein R^{2b}, R^{2c} and R³ corresponds in each case to one row of Table T.

Table 8-8 Methods and uses, wherein the mixture of compound A8 and Dinotefuran is applied to plant and/or pests and wherein R^{2b}, R^{2c} and R³ corresponds in each case to one row of Table T.

Table 8-9 Methods and uses, wherein the mixture of compound A8 and Sulfoxaflor is applied to plant and/or pests and wherein R^{2b}, R^{2c} and R³ corresponds in each case to one row of Table T.

Table 8-10 Methods and uses, wherein the mixture of compound A8 and Clothianidin is applied to plant and/or pests and wherein R^{2b}, R^{2c} and R³ corresponds in each case to one row of Table T.

Table 8-11 Methods and uses, wherein the mixture of compound A8 and Thiacloprid is applied to plant and/or pests and wherein R^{2b}, R^{2c} and R³ corresponds in each case to one row of Table T.

Table 8-12 Methods and uses, wherein the mixture of compound A8 and Flupyradifuron is applied to plant and/or pests and wherein R^{2b}, R^{2c} and R³ corresponds in each case to one row of Table T.

Table 8-13 Methods and uses, wherein the mixture of compound A8 and Imidacloprid is applied to plant and/or pests and wherein R^{2b}, R^{2c} and R³ corresponds in each case to one row of Table T.

Table 8-14 Methods and uses, wherein the mixture of compound A8 and Fipronil is applied to plant and/or pests and wherein R^{2b}, R^{2c} and R³ corresponds in each case to one row of Table T.

Table 8-15 Methods and uses, wherein the mixture of compound A8 and Ivermectin is applied to plant and/or pests and wherein R^{2b}, R^{2c} and R³ corresponds in each case to one row of Table T.

Table 8-16 Methods and uses, wherein the mixture of compound A8 and Abamectin is applied to plant and/or pests and wherein R^{2b}, R^{2c} and R³ corresponds in each case to one row of Table T.

Table 8-17 Methods and uses, wherein the mixture of compound A8 and Spinosad is applied to plant and/or pests and wherein R^{2b}, R^{2c} and R³ corresponds in each case to one row of Table T.

Table 8-18 Methods and uses, wherein the mixture of compound A8 and Thiamethoxam is applied to plant and/or pests and wherein R^{2b}, R^{2c} and R³ corresponds in each case to one row of Table T.

Table 8-19 Methods and uses, wherein the mixture of compound A8 and Indoxacarb is applied plant and/or pests and wherein R^{2b}, R^{2c} and R³ corresponds in each case to one row of Table T.

Table 8-20 Methods and uses, wherein the mixture of compound A8 and Deltamethrin is applied to plant and/or pests and wherein R^{2b}, R^{2c} and R³ corresponds in each case to one row of Table T.

Table 8-21 Methods and uses, wherein the mixture of compound A8 and Metaflumizone is applied to plant and/or pests and wherein R^{2b}, R^{2c} and R³ corresponds in each case to one row of Table T.

Table 8-22 Methods and uses, wherein the mixture of compound A8 and Avermectin is applied to plant and/or pests and wherein R^{2b}, R^{2c} and R³ corresponds in each case to one row of Table T.

Table 8-23 Methods and uses, wherein the mixture of compound A8 and Emamectin is applied to plant and/or pests and wherein R^{2b}, R^{2c} and R³ corresponds in each case to one row of Table T.

Table 8-24 Methods and uses, wherein the mixture of compound A8 and Methomyl is applied to plant and/or pests and wherein R^{2b}, R^{2c} and R³ corresponds in each case to one row of Table T.

Table 8-25 Methods and uses, wherein the mixture of compound A8 and Lufenuron is applied to plant and/or pests and wherein R^{2b}, R^{2c} and R³ corresponds in each case to one row of Table T.

Table 8-26 Methods and uses, wherein the mixture of compound A8 and Buprofezin is applied to plant and/or pests and wherein R^{2b}, R^{2c} and R³ corresponds in each case to one row of Table T.

Table 8-27 Methods and uses, wherein the mixture of compound A8 and Teflubenzuron is applied to plant and/or pests and wherein R^{2b}, R^{2c} and R³ corresponds in each case to one row of Table T.

Table 8-28 Methods and uses, wherein the mixture of compound A8 and Chlorantraniliprole is applied to plant and/or pests and wherein R^{2b}, R^{2c} and R³ corresponds in each case to one row of Table T.

Table 8-29 Methods and uses, wherein the mixture of compound A8 and Cyantraniliprole is applied to plant and/or pests and wherein R^{2b}, R^{2c} and R³ corresponds in each case to one row of Table T.

Table 8-30 Methods and uses, wherein the mixture of compound A8 and Tetraniliprole is applied to plant and/or pests and wherein R^{2b}, R^{2c} and R³ corresponds in each case to one row of Table T.

Table 8-31 Methods and uses, wherein the mixture of compound A8 and Cyclaniliprole is applied to plant and/or pests and wherein R^{2b}, R^{2c} and R³ corresponds in each case to one row of Table T.

Table 8-32 Methods and uses, wherein the mixture of compound A8 and Flonicamid is applied to plant and/or pests and wherein R^{2b}, R^{2c} and R³ corresponds in each case to one row of Table T.

Table 8-33 Methods and uses, wherein the mixture of compound A8 and Pymetrozine is applied to plant and/or pests and wherein R^{2b}, R^{2c} and R³ corresponds in each case to one row of Table T.

Table 8-34 Methods and uses, wherein the mixture of compound A8 and Spirotetramat is applied plant and/or pests and wherein R^{2b}, R^{2c} and R³ corresponds in each case to one row of Table T.

Table 8-35 Methods and uses, wherein the mixture of compound A8 and alpha-cypermethrin is applied plant and/or pests which corresponds in each case to one row of Table T.

Table 8-36 Methods and uses, wherein the mixture of compound A8 and Acetamiprid is applied plant and/or pests which corresponds in each case to one row of Table T.

Table 8-37 Methods and uses, wherein the mixture of compound A8 and Chlorpyrifos is applied plant and/or pests which corresponds in each case to one row of Table T.

Table 8-38 Methods and uses, wherein the mixture of compound A8 and Acephate is applied plant and/or pests which corresponds in each case to one row of Table T.

Table 8-39 Methods and uses, wherein the mixture of compound A8 and Permethrin is applied plant and/or pests which corresponds in each case to one row of Table T.

Table 8-40 Methods and uses, wherein the mixture of compound A8 and Cypermethrin is applied plant and/or pests which corresponds in each case to one row of Table T.

Table 8-41 Methods and uses, wherein the mixture of compound A8 and Cyfluthrin is applied plant and/or pests which corresponds in each case to one row of Table T.

Table 8-42 Methods and uses, wherein the mixture of compound A8 and Zeta-cypermethrin is applied plant and/or pests which corresponds in each case to one row of Table T.

Table 8-43 Methods and uses, wherein the mixture of compound A8 and Tefluthrin is applied plant and/or pests which corresponds in each case to one row of Table T.

Table 8-44 Methods and uses, wherein the mixture of compound A8 and Esfenvalerate is applied plant and/or pests which corresponds in each case to one row of Table T.

Table 8-45 Methods and uses, wherein the mixture of compound A8 and Etofenprox is applied plant and/or pests which corresponds in each case to one row of Table T.

Table 8-46 Methods and uses, wherein the mixture of compound A8 and Gamma-cyhalothrin is applied plant and/or pests which corresponds in each case to one row of Table T.

Table 8-47 Methods and uses, wherein the mixture of compound A8 and Fenpropathrin is applied plant and/or pests which corresponds in each case to one row of Table T.

Table 8-48 Methods and uses, wherein the mixture of compound A8 and Fenvalerate is applied plant and/or pests which corresponds in each case to one row of Table T.

Table 8-49 Methods and uses, wherein the mixture of compound A8 and Fluvalinate is applied plant and/or pests which corresponds in each case to one row of Table T.

Table 8-50 Methods and uses, wherein the mixture of compound A8 and Carbofuran is applied plant and/or pests which corresponds in each case to one row of Table T.

Table 8-51 Methods and uses, wherein the mixture of compound A8 and Novaluron is applied plant and/or pests which corresponds in each case to one row of Table T.

Table 8-52 Methods and uses, wherein the mixture of compound A8 and Cyflumetofen is applied plant and/or pests which corresponds in each case to one row of Table T.

Table 8-53 Methods and uses, wherein the mixture of compound A8 and Bifenazate is applied plant and/or pests which corresponds in each case to one row of Table T.

Table 9-1 Methods and uses, wherein the mixture of compound A9 and Lambda cyhalothrin is applied to plant and/or pests and wherein R^{2b}, R^{2c} and R³ corresponds in each case to one row of Table T.

Table 9-2 Methods and uses, wherein the mixture of compound A9 and Bifenthrin is applied to plant and/or pests and wherein R^{2b}, R^{2c} and R³ corresponds in each case to one row of Table T.

Table 9-3 Methods and uses, wherein the mixture of compound A9 and Afidopyropen is applied to plant and/or pests and wherein R^{2b}, R^{2c} and R³ corresponds in each case to one row of Table T.

Table 9-4 Methods and uses, wherein the mixture of compound A9 and Broflanilide is applied to plant and/or pests and wherein R^{2b}, R^{2c} and R³ corresponds in each case to one row of Table T.

Table 9-5 Methods and uses, wherein the mixture of compound A9 and Flubendiamide is applied to plant and/or pests and wherein R^{2b}, R^{2c} and R³ corresponds in each case to one row of Table T.

Table 9-6 Methods and uses, wherein the mixture of compound A9 and Chlorfenapyr is applied to plant and/or pests and wherein R^{2b}, R^{2c} and R³ corresponds in each case to one row of Table T.

Table 9-7 Methods and uses, wherein the mixture of compound A9 and Ethiprole is applied to plant and/or pests and wherein R^{2b}, R^{2c} and R³ corresponds in each case to one row of Table T.

Table 9-8 Methods and uses, wherein the mixture of compound A9 and Dinotefuran is applied to plant and/or pests and wherein R^{2b}, R^{2c} and R³ corresponds in each case to one row of Table T.

Table 9-9 Methods and uses, wherein the mixture of compound A9 and Sulfoxaflor is applied to plant and/or pests and wherein R^{2b}, R^{2c} and R³ corresponds in each case to one row of Table T.

Table 9-10 Methods and uses, wherein the mixture of compound A9 and Clothianidin is applied to plant and/or pests and wherein R^{2b}, R^{2c} and R³ corresponds in each case to one row of Table T.

Table 9-11 Methods and uses, wherein the mixture of compound A9 and Thiacloprid is applied to plant and/or pests and wherein R^{2b}, R^{2c} and R³ corresponds in each case to one row of Table T.

Table 9-12 Methods and uses, wherein the mixture of compound A9 and Flupyradifuron is applied to plant and/or pests and wherein R^{2b}, R^{2c} and R³ corresponds in each case to one row of Table T.

Table 9-13 Methods and uses, wherein the mixture of compound A9 and Imidacloprid is applied to plant and/or pests and wherein R^{2b}, R^{2c} and R³ corresponds in each case to one row of Table T.

Table 9-14 Methods and uses, wherein the mixture of compound A9 and Fipronil is applied to plant and/or pests and wherein R^{2b}, R^{2c} and R³ corresponds in each case to one row of Table T.

Table 9-15 Methods and uses, wherein the mixture of compound A9 and Ivermectin is applied to plant and/or pests and wherein R^{2b}, R^{2c} and R³ corresponds in each case to one row of Table T.

Table 9-16 Methods and uses, wherein the mixture of compound A9 and Abamectin is applied to plant and/or pests and wherein R^{2b}, R^{2c} and R³ corresponds in each case to one row of Table T.

Table 9-17 Methods and uses, wherein the mixture of compound A9 and Spinosad is applied to plant and/or pests and wherein R^{2b}, R^{2c} and R³ corresponds in each case to one row of Table T.

Table 9-18 Methods and uses, wherein the mixture of compound A9 and Thiamethoxam is applied to plant and/or pests and wherein R^{2b}, R^{2c} and R³ corresponds in each case to one row of Table T.

Table 9-19 Methods and uses, wherein the mixture of compound A9 and Indoxacarb is applied plant and/or pests and wherein R^{2b}, R^{2c} and R³ corresponds in each case to one row of Table T.

Table 9-20 Methods and uses, wherein the mixture of compound A9 and Deltamethrin is applied to plant and/or pests and wherein R^{2b}, R^{2c} and R³ corresponds in each case to one row of Table T.

Table 9-21 Methods and uses, wherein the mixture of compound A9 and Metaflumizone is applied to plant and/or pests and wherein R^{2b}, R^{2c} and R³ corresponds in each case to one row of Table T.

Table 9-22 Methods and uses, wherein the mixture of compound A9 and Avermectin is applied to plant and/or pests and wherein R^{2b}, R^{2c} and R³ corresponds in each case to one row of Table T.

Table 9-23 Methods and uses, wherein the mixture of compound A9 and Emamectin is applied to plant and/or pests and wherein R^{2b}, R^{2c} and R³ corresponds in each case to one row of Table T.

Table 9-24 Methods and uses, wherein the mixture of compound A9 and Methomyl is applied to plant and/or pests and wherein R^{2b}, R^{2c} and R³ corresponds in each case to one row of Table T.

Table 9-25 Methods and uses, wherein the mixture of compound A9 and Lufenuron is applied to plant and/or pests and wherein R^{2b}, R^{2c} and R³ corresponds in each case to one row of Table T.

Table 9-26 Methods and uses, wherein the mixture of compound A9 and Buprofezin is applied to plant and/or pests and wherein R^{2b}, R^{2c} and R³ corresponds in each case to one row of Table T.

Table 9-27 Methods and uses, wherein the mixture of compound A9 and Teflubenzuron is applied to plant and/or pests and wherein R^{2b}, R^{2c} and R³ corresponds in each case to one row of Table T.

Table 9-28 Methods and uses, wherein the mixture of compound A9 and Chlorantraniliprole is applied to plant and/or pests and wherein R^{2b}, R^{2c} and R³ corresponds in each case to one row of Table T.

Table 9-29 Methods and uses, wherein the mixture of compound A9 and Cyantraniliprole is applied to plant and/or pests and wherein R^{2b}, R^{2c} and R³ corresponds in each case to one row of Table T.

Table 9-30 Methods and uses, wherein the mixture of compound A9 and Tetraniliprole is applied to plant and/or pests and wherein R^{2b}, R^{2c} and R³ corresponds in each case to one row of Table T.

Table 9-31 Methods and uses, wherein the mixture of compound A9 and Cyclaniliprole is applied to plant and/or pests and wherein R^{2b}, R^{2c} and R³ corresponds in each case to one row of Table T.

Table 9-32 Methods and uses, wherein the mixture of compound A9 and Flonicamid is applied to plant and/or pests and wherein R^{2b}, R^{2c} and R³ corresponds in each case to one row of Table T.

Table 9-33 Methods and uses, wherein the mixture of compound A9 and Pymetrozine is applied to plant and/or pests and wherein R^{2b}, R^{2c} and R³ corresponds in each case to one row of Table T.

Table 9-34 Methods and uses, wherein the mixture of compound A9 and Spirotetramat is applied plant and/or pests and wherein R^{2b}, R^{2c} and R³ corresponds in each case to one row of Table T.

Table 9-35 Methods and uses, wherein the mixture of compound A9 and alpha-cypermethrin is applied plant and/or pests and wherein R^{2b}, R^{2c} and R³ corresponds in each case to one row of Table T.

Table 9-36 Methods and uses, wherein the mixture of compound A9 and Acetamiprid is applied plant and/or pests and wherein R^{2b}, R^{2c} and R³ corresponds in each case to one row of Table T.

Table 9-37 Methods and uses, wherein the mixture of compound A9 and Chlorpyrifos is applied plant and/or pests and wherein R^{2b}, R^{2c} and R³ corresponds in each case to one row of Table T.

Table 9-38 Methods and uses, wherein the mixture of compound A9 and Acephate is applied plant and/or pests and wherein R^{2b}, R^{2c} and R³ corresponds in each case to one row of Table T.

Table 9-39 Methods and uses, wherein the mixture of compound A9 and Permethrin is applied plant and/or pests and wherein R^{2b}, R^{2c} and R³ corresponds in each case to one row of Table T.

Table 9-40 Methods and uses, wherein the mixture of compound A9 and Cypermethrin is applied plant and/or pests and wherein R^{2b}, R^{2c} and R³ corresponds in each case to one row of Table T.

Table 9-41 Methods and uses, wherein the mixture of compound A9 and Cyfluthrin is applied plant and/or pests and wherein R^{2b}, R^{2c} and R³ corresponds in each case to one row of Table T.

Table 9-42 Methods and uses, wherein the mixture of compound A9 and Zeta-cypermethrin is applied plant and/or pests and wherein R^{2b}, R^{2c} and R³ corresponds in each case to one row of Table T.

Table 9-43 Methods and uses, wherein the mixture of compound A9 and Tefluthrin is applied plant and/or pests and wherein R^{2b}, R^{2c} and R³ corresponds in each case to one row of Table T.

Table 9-44 Methods and uses, wherein the mixture of compound A9 and Esfenvalerate is applied plant and/or pests and wherein R^{2b}, R^{2c} and R³ corresponds in each case to one row of Table T.

Table 9-45 Methods and uses, wherein the mixture of compound A9 and Etofenprox is applied plant and/or pests and wherein R^{2b}, R^{2c} and R³ corresponds in each case to one row of Table T.

Table 9-46 Methods and uses, wherein the mixture of compound A9 and Gamma-cyhalothrin is applied plant and/or pests and wherein R^{2b}, R^{2c} and R³ corresponds in each case to one row of Table T.

Table 9-47 Methods and uses, wherein the mixture of compound A9 and Fenpropathrin is applied plant and/or pests and wherein R^{2b}, R^{2c} and R³ corresponds in each case to one row of Table T.

Table 9-48 Methods and uses, wherein the mixture of compound A9 and Fenvalerate is applied plant and/or pests and wherein R^{2b}, R^{2c} and R³ corresponds in each case to one row of Table T.

Table 9-49 Methods and uses, wherein the mixture of compound A9 and Fluvalinate is applied plant and/or pests and wherein R^{2b}, R^{2c} and R³ corresponds in each case to one row of Table T.

Table 9-50 Methods and uses, wherein the mixture of compound A9 and Carbofuran is applied plant and/or pests and wherein R^{2b}, R^{2c} and R³ corresponds in each case to one row of Table T.

Table 9-51 Methods and uses, wherein the mixture of compound A9 and Novaluron is applied plant and/or pests and wherein R^{2b}, R^{2c} and R³ corresponds in each case to one row of Table T.

Table 9-52 Methods and uses, wherein the mixture of compound A9 and Cyflumetofen is applied plant and/or pests and wherein R^{2b}, R^{2c} and R³ corresponds in each case to one row of Table T.

Table 9-53 Methods and uses, wherein the mixture of compound A9 and Bifenazate is applied plant and/or pests and wherein R^{2b}, R^{2c} and R³ corresponds in each case to one row of Table T.

Table 10-1 Methods and uses, wherein the mixture of compound A10 and Lambda cyhalothrin is applied to plant and/or pests and wherein R^{2b}, R^{2c} and R³ corresponds in each case to one row of Table T.

Table 10-2 Methods and uses, wherein the mixture of compound A10 and Bifenthrin is applied to plant and/or pests and wherein R^{2b}, R^{2c} and R³ corresponds in each case to one row of Table T.

Table 10-3 Methods and uses, wherein the mixture of compound A10 and Afidopyropen is applied to plant and/or pests and wherein R^{2b}, R^{2c} and R³ corresponds in each case to one row of Table T.

Table 10-4 Methods and uses, wherein the mixture of compound A10 and Broflanilide is applied to plant and/or pests and wherein R^{2b}, R^{2c} and R³ corresponds in each case to one row of Table T.

Table 10-5 Methods and uses, wherein the mixture of compound A10 and Flubendiamide is applied to plant and/or pests and wherein R^{2b}, R^{2c} and R³ corresponds in each case to one row of Table T.

Table 10-6 Methods and uses, wherein the mixture of compound A10 and Chlorfenapyr is applied to plant and/or pests and wherein R^{2b}, R^{2c} and R³ corresponds in each case to one row of Table T.

Table 10-7 Methods and uses, wherein the mixture of compound A10 and Ethiprole is applied to plant and/or pests and wherein R^{2b}, R^{2c} and R³ corresponds in each case to one row of Table T.

Table 10-8 Methods and uses, wherein the mixture of compound A10 and Dinotefuran is applied to plant and/or pests and wherein R^{2b}, R^{2c} and R³ corresponds in each case to one row of Table T.

Table 10-9 Methods and uses, wherein the mixture of compound A10 and Sulfoxaflor is applied to plant and/or pests and wherein R^{2b}, R^{2c} and R³ corresponds in each case to one row of Table T.

Table 10-10 Methods and uses, wherein the mixture of compound A10 and Clothianidin is applied to plant and/or pests and wherein R^{2b}, R^{2c} and R³ corresponds in each case to one row of Table T.

Table 10-11 Methods and uses, wherein the mixture of compound A10 and Thiacloprid is applied to plant and/or pests and wherein R^{2b}, R^{2c} and R³ corresponds in each case to one row of Table T.

Table 10-12 Methods and uses, wherein the mixture of compound A10 and Flupyradifuron is applied to plant and/or pests and wherein R^{2b}, R^{2c} and R³ corresponds in each case to one row of Table T.

Table 10-13 Methods and uses, wherein the mixture of compound A10 and Imidacloprid is applied to plant and/or pests and wherein R^{2b}, R^{2c} and R³ corresponds in each case to one row of Table T.

Table 10-14 Methods and uses, wherein the mixture of compound A10 and Fipronil is applied to plant and/or pests and wherein R^{2b}, R^{2c} and R³ corresponds in each case to one row of Table T.

Table 10-15 Methods and uses, wherein the mixture of compound A10 and Ivermectin is applied to plant and/or pests and wherein R^{2b}, R^{2c} and R³ corresponds in each case to one row of Table T.

Table 10-16 Methods and uses, wherein the mixture of compound A10 and Abamectin is applied to plant and/or pests and wherein R^{2b}, R^{2c} and R³ corresponds in each case to one row of Table T.

Table 10-17 Methods and uses, wherein the mixture of compound A10 and Spinosad is applied to plant and/or pests and wherein R^{2b}, R^{2c} and R³ corresponds in each case to one row of Table T.

Table 10-18 Methods and uses, wherein the mixture of compound A10 and Thiamethoxam is applied to plant and/or pests and wherein R^{2b}, R^{2c} and R³ corresponds in each case to one row of Table T.

Table 10-19 Methods and uses, wherein the mixture of compound A10 and Indoxacarb is applied plant and/or pests and wherein R^{2b}, R^{2c} and R³ corresponds in each case to one row of Table T.

Table 10-20 Methods and uses, wherein the mixture of compound A10 and Deltamethrin is applied to plant and/or pests and wherein R^{2b}, R^{2c} and R³ corresponds in each case to one row of Table T.

Table 10-21 Methods and uses, wherein the mixture of compound A10 and Metaflumizone is applied to plant and/or pests and wherein R^{2b}, R^{2c} and R³ corresponds in each case to one row of Table T.

Table 10-22 Methods and uses, wherein the mixture of compound A10 and Avermectin is applied to plant and/or pests and wherein R^{2b}, R^{2c} and R³ corresponds in each case to one row of Table T.

Table 10-23 Methods and uses, wherein the mixture of compound A10 and Emamectin is applied to plant and/or pests and wherein R^{2b}, R^{2c} and R³ corresponds in each case to one row of Table T.

Table 10-24 Methods and uses, wherein the mixture of compound A10 and Methomyl is applied to plant and/or pests and wherein R^{2b}, R^{2c} and R³ corresponds in each case to one row of Table T.

Table 10-25 Methods and uses, wherein the mixture of compound A10 and Lufenuron is applied to plant and/or pests and wherein R^{2b}, R^{2c} and R³ corresponds in each case to one row of Table T.

Table 10-26 Methods and uses, wherein the mixture of compound A10 and Buprofezin is applied to plant and/or pests and wherein R^{2b}, R^{2c} and R³ corresponds in each case to one row of Table T.

Table 10-27 Methods and uses, wherein the mixture of compound A10 and Teflubenzuron is applied to plant and/or pests and wherein R^{2b}, R^{2c} and R³ corresponds in each case to one row of Table T.

Table 10-28 Methods and uses, wherein the mixture of compound A10 and Chlorantraniliprole is applied to plant and/or pests and wherein R^{2b}, R^{2c} and R³ corresponds in each case to one row of Table T.

Table 10-29 Methods and uses, wherein the mixture of compound A10 and Cyantraniliprole is applied to plant and/or pests and wherein R^{2b}, R^{2c} and R³ corresponds in each case to one row of Table T.

Table 10-30 Methods and uses, wherein the mixture of compound A10 and Tetraniliprole is applied to plant and/or pests and wherein R^{2b}, R^{2c} and R³ corresponds in each case to one row of Table T.

Table 10-31 Methods and uses, wherein the mixture of compound A10 and Cyclaniliprole is applied to plant and/or pests and wherein R^{2b}, R^{2c} and R³ corresponds in each case to one row of Table T.

Table 10-32 Methods and uses, wherein the mixture of compound A10 and Flonicamid is applied to plant and/or pests and wherein R^{2b}, R^{2c} and R³ corresponds in each case to one row of Table T.

Table 10-33 Methods and uses, wherein the mixture of compound A10 and Pymetrozine is applied to plant and/or pests and wherein R^{2b}, R^{2c} and R³ corresponds in each case to one row of Table T.

Table 10-34 Methods and uses, wherein the mixture of compound A10 and Spirotetramat is applied plant and/or pests and wherein R^{2b}, R^{2c} and R³ corresponds in each case to one row of Table T.

Table 10-35 Methods and uses, wherein the mixture of compound A10 and alpha-cypermethrin is applied plant and/or pests and wherein R^{2b}, R^{2c} and R³ corresponds in each case to one row of Table T.

Table 10-36 Methods and uses, wherein the mixture of compound A10 and Acetamiprid is applied plant and/or pests and wherein R^{2b}, R^{2c} and R³ corresponds in each case to one row of Table T.

Table 10-37 Methods and uses, wherein the mixture of compound A10 and Chlorpyrifos is applied plant and/or pests and wherein R^{2b}, R^{2c} and R³ corresponds in each case to one row of Table T.

Table 10-38 Methods and uses, wherein the mixture of compound A10 and Acephate is applied plant and/or pests and wherein R^{2b}, R^{2c} and R³ corresponds in each case to one row of Table T.

Table 10-39 Methods and uses, wherein the mixture of compound A10 and Permethrin is applied plant and/or pests and wherein R^{2b}, R^{2c} and R³ corresponds in each case to one row of Table T.

Table 10-40 Methods and uses, wherein the mixture of compound A10 and Cypermethrin is applied plant and/or pests and wherein R^{2b}, R^{2c} and R³ corresponds in each case to one row of Table T.

Table 10-41 Methods and uses, wherein the mixture of compound A10 and Cyfluthrin is applied plant and/or pests and wherein R^{2b}, R^{2c} and R³ corresponds in each case to one row of Table T.

Table 10-42 Methods and uses, wherein the mixture of compound A10 and Zeta-cypermethrin is applied plant and/or pests and wherein R^{2b}, R^{2c} and R³ corresponds in each case to one row of Table T.

Table 10-43 Methods and uses, wherein the mixture of compound A10 and Tefluthrin is applied plant and/or pests and wherein R^{2b}, R^{2c} and R³ corresponds in each case to one row of Table T.

Table 10-44 Methods and uses, wherein the mixture of compound A10 and Esfenvalerate is applied plant and/or pests and wherein R^{2b}, R^{2c} and R³ corresponds in each case to one row of Table T.

Table 10-45 Methods and uses, wherein the mixture of compound A10 and Etofenprox is applied plant and/or pests and wherein R^{2b}, R^{2c} and R³ corresponds in each case to one row of Table T.

Table 10-46 Methods and uses, wherein the mixture of compound A10 and Gamma-cyhalothrin is applied plant and/or pests and wherein R^{2b}, R^{2c} and R³ corresponds in each case to one row of Table T.

Table 10-47 Methods and uses, wherein the mixture of compound A10 and Fenpropathrin is applied plant and/or pests and wherein R^{2b}, R^{2c} and R³ corresponds in each case to one row of Table T.

Table 10-48 Methods and uses, wherein the mixture of compound A10 and Fenvalerate is applied plant and/or pests and wherein R^{2b}, R^{2c} and R³ corresponds in each case to one row of Table T.

Table 10-49 Methods and uses, wherein the mixture of compound A10 and Fluvalinate is applied plant and/or pests and wherein R^{2b}, R^{2c} and R³ corresponds in each case to one row of Table T.

Table 10-50 Methods and uses, wherein the mixture of compound A10 and Carbofuran is applied plant and/or pests and wherein R^{2b}, R^{2c} and R³ corresponds in each case to one row of Table T.

Table 10-51 Methods and uses, wherein the mixture of compound A10 and Novaluron is applied plant and/or pests and wherein R^{2b}, R^{2c} and R³ corresponds in each case to one row of Table T.

Table 10-52 Methods and uses, wherein the mixture of compound A10 and Cyflumetofen is applied plant and/or pests and wherein R^{2b}, R^{2c} and R³ corresponds in each case to one row of Table T.

Table 10-53 Methods and uses, wherein the mixture of compound A10 and Bifenazate is applied plant and/or pests and wherein R^{2b}, R^{2c} and R³ corresponds in each case to one row of Table T.

Meaning of C1 to C11 used in Table T are as given below, wherein the zigzag line shows the point of attachment to the carbonyl group.

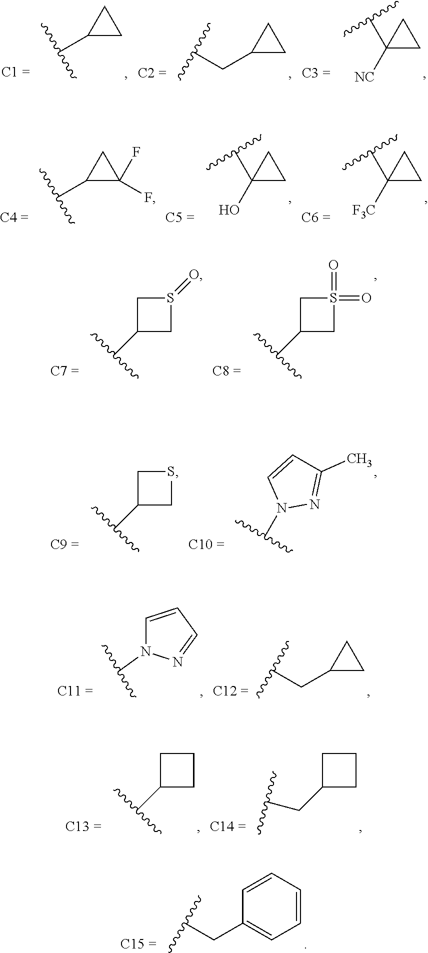

TABLE T

| No. | R^{2b} | R^{2c} | R³ |
|---|---|---|---|
| T-1 | H | H | CH₃ |
| T-2 | H | H | C₂H₅ |
| T-3 | H | H | CH₂CF₃ |
| T-4 | H | H | CH₂CH₂CF₃ |
| T-5 | H | H | CH₂CH₂CH₃ |
| T-6 | H | H | CH₂OCH₃ |
| T-7 | H | H | CH₂OC₂H₅ |
| T-8 | H | H | CH₂OCF₃ |
| T-9 | H | H | CH₂OCH₂CF₃ |
| T-10 | H | H | CH₂S(O)CH₃ |
| T-11 | H | H | CH₂S(O)C₂H₅ |
| T-12 | H | H | CH₂S(O)₂CH₃ |
| T-13 | H | H | CH₂S(O)2C₂H₅ |
| T-14 | H | H | CH₂SCH₃ |
| T-15 | H | H | CH₂SC₂H₅ |
| T-16 | H | H | CH₂CH(CH₃)₂ |
| T-17 | H | H | C(CH₃)₂OH |
| T-18 | H | H | C(CH₃)₃ |
| T-19 | H | H | CH(CH₃)₂ |
| T-20 | H | H | CH₂OH |
| T-21 | H | H | CH(CH₃)CH₂OH |
| T-22 | H | H | CH₂CH(CH₃)OH |
| T-23 | H | H | CH₂—C10 |
| T-24 | H | H | CH₂—C11 |
| T-25 | H | H | CH₂SCF₃ |
| T-26 | H | H | CH₂S(O)CF₃ |
| T-27 | H | H | CH₂S(O)₂CF₃ |
| T-28 | H | H | C1 |
| T-29 | H | H | C2 |
| T-30 | H | H | C3 |
| T-31 | H | H | C4 |
| T-32 | H | H | C5 |
| T-33 | H | H | C6 |
| T-34 | H | H | C7 |
| T-35 | H | H | C8 |
| T-36 | H | H | C9 |
| T-37 | H | H | C10 |
| T-38 | H | H | C11 |
| T-39 | H | H | C12 |
| T-40 | H | H | C13 |
| T-41 | H | H | C14 |
| T-42 | H | H | C15 |
| T-43 | H | F | CH₃ |
| T-44 | H | F | C₂H₅ |
| T-45 | H | F | CH₂CF₃ |
| T-46 | H | F | CH₂CH₂CF₃ |
| T-47 | H | F | CH₂CH₂CH₃ |
| T-48 | H | F | CH₂OCH₃ |
| T-49 | H | F | CH₂OC₂H₅ |
| T-50 | H | F | CH₂OCF₃ |
| T-51 | H | F | CH₂OCH₂CF₃ |
| T-52 | H | F | CH₂S(O)CH₃ |
| T-53 | H | F | CH₂S(O)C₂H₅ |
| T-54 | H | F | CH₂S(O)₂CH₃ |
| T-55 | H | F | CH₂S(O)₂C₂H₅ |
| T-56 | H | F | CH₂SCH₃ |
| T-57 | H | F | CH₂SC₂H₅ |
| T-58 | H | F | CH₂CH(CH₃)₂ |
| T-59 | H | F | C(CH₃)₂OH |
| T-60 | H | F | C(CH₃)₃ |
| T-61 | H | F | CH(CH₃)₂ |
| T-62 | H | F | CH₂OH |
| T-63 | H | F | CH(CH₃)CH₂OH |
| T-64 | H | F | CH₂CH(CH₃)OH |
| T-65 | H | F | CH₂—C10 |
| T-66 | H | F | CH₂—C11 |
| T-67 | H | F | CH₂SCF₃ |
| T-68 | H | F | CH₂S(O)CF₃ |
| T-69 | H | F | CH₂S(O)₂CF₃ |
| T-70 | H | F | C1 |
| T-71 | H | F | C2 |
| T-72 | H | F | C3 |
| T-73 | H | F | C4 |
| T-74 | H | F | C5 |
| T-75 | H | F | C6 |
| T-76 | H | F | C7 |
| T-77 | H | F | C8 |
| T-78 | H | F | C9 |
| T-79 | H | F | C10 |
| T-80 | H | F | C11 |
| T-81 | H | F | C12 |
| T-82 | H | F | C13 |
| T-83 | H | F | C14 |
| T-84 | H | F | C15 |
| T-85 | H | Cl | CH₃ |
| T-86 | H | Cl | C₂H₅ |
| T-87 | H | Cl | CH₂CF₃ |
| T-88 | H | Cl | CH₂CH₂CF₃ |
| T-89 | H | Cl | CH₂CH₂CH₃ |
| T-90 | H | Cl | CH₂OCH₃ |
| T-91 | H | Cl | CH₂OC₂H₅ |
| T-92 | H | Cl | CH₂OCF₃ |
| T-93 | H | Cl | CH₂OCH₂CF₃ |
| T-94 | H | Cl | CH₂S(O)CH₃ |
| T-95 | H | Cl | CH₂S(O)C₂H₅ |
| T-96 | H | Cl | CH₂S(O)₂CH₃ |
| T-97 | H | Cl | CH₂S(O)₂C₂H₅ |
| T-98 | H | Cl | CH₂SCH₃ |
| T-99 | H | Cl | CH₂SC₂H₅ |
| T-100 | H | Cl | CH₂CH(CH₃)₂ |
| T-101 | H | Cl | C(CH₃)₂OH |
| T-102 | H | Cl | C(CH₃)₃ |
| T-103 | H | Cl | CH(CH₃)₂ |
| T-104 | H | Cl | CH₂OH |
| T-105 | H | Cl | CH(CH₃)CH₂OH |
| T-106 | H | Cl | CH₂CH(CH₃)OH |
| T-107 | H | Cl | CH₂—C10 |
| T-108 | H | Cl | CH₂—C11 |
| T-109 | H | Cl | CH₂SCF₃ |
| T-110 | H | Cl | CH₂S(O)CF₃ |
| T-111 | H | Cl | CH₂S(O)₂CF₃ |
| T-112 | H | Cl | C1 |
| T-113 | H | Cl | C2 |
| T-114 | H | Cl | C3 |
| T-115 | H | Cl | C4 |
| T-116 | H | Cl | C5 |
| T-117 | H | Cl | C6 |
| T-118 | H | Cl | C7 |
| T-119 | H | Cl | C8 |
| T-120 | H | Cl | C9 |
| T-121 | H | Cl | C10 |
| T-122 | H | Cl | C11 |
| T-123 | H | Cl | C12 |
| T-124 | H | Cl | C13 |
| T-125 | H | Cl | C14 |
| T-126 | H | Cl | C15 |
| T-127 | H | Br | CH₃ |
| T-128 | H | Br | C₂H₅ |
| T-129 | H | Br | CH₂CF₃ |
| T-130 | H | Br | CH₂CH₂CF₃ |
| T-131 | H | Br | CH₂CH₂CH₃ |
| T-132 | H | Br | CH₂OCH₃ |
| T-133 | H | Br | CH₂OC₂H₅ |
| T-134 | H | Br | CH₂OCF₃ |
| T-135 | H | Br | CH₂OCH₂CF₃ |
| T-136 | H | Br | CH₂S(O)CH₃ |
| T-137 | H | Br | CH₂S(O)C₂H₅ |
| T-138 | H | Br | CH₂S(O)₂CH₃ |
| T-139 | H | Br | CH₂S(O)₂C₂H₅ |
| T-140 | H | Br | CH₂SCH₃ |
| T-141 | H | Br | CH₂SC₂H₅ |
| T-142 | H | Br | CH₂CH(CH₃)₂ |
| T-143 | H | Br | C(CH₃)₂OH |
| T-144 | H | Br | C(CH₃)₃ |
| T-145 | H | Br | CH(CH₃)₂ |
| T-146 | H | Br | CH₂OH |
| T-147 | H | Br | CH(CH₃)CH₂OH |
| T-148 | H | Br | CH₂CH(CH₃)OH |
| T-149 | H | Br | CH₂—C10 |
| T-150 | H | Br | CH₂—C11 |
| T-151 | H | Br | CH₂SCF₃ |
| T-152 | H | Br | CH₂S(O)CF₃ |
| T-153 | H | Br | CH₂S(O)₂CF₃ |
| T-154 | H | Br | C1 |
| T-155 | H | Br | C2 |
| T-156 | H | Br | C3 |
| T-157 | H | Br | C4 |
| T-158 | H | Br | C5 |
| T-159 | H | Br | C6 |
| T-160 | H | Br | C7 |
| T-161 | H | Br | C8 |
| T-162 | H | Br | C9 |
| T-163 | H | Br | C10 |
| T-164 | H | Br | C11 |
| T-165 | H | Br | C12 |
| T-166 | H | Br | C13 |
| T-167 | H | Br | C14 |
| T-168 | H | Br | C15 |
| T-169 | H | CF₃ | CH₃ |
| T-170 | H | CF₃ | C₂H₅ |
| T-171 | H | CF₃ | CH₂CF₃ |
| T-172 | H | CF₃ | CH₂CH₂CF₃ |
| T-173 | H | CF₃ | CH₂CH₂CH₃ |
| T-174 | H | CF₃ | CH₂OCH₃ |
| T-175 | H | CF₃ | CH₂OC₂H₅ |
| T-176 | H | CF₃ | CH₂OCF₃ |
| T-177 | H | CF₃ | CH₂OCH₂CF₃ |
| T-178 | H | CF₃ | CH₂S(O)CH₃ |
| T-179 | H | CF₃ | CH₂S(O)C₂H₅ |
| T-180 | H | CF₃ | CH₂S(O)₂CH₃ |
| T-181 | H | CF₃ | CH₂S(O)₂C₂H₅ |
| T-182 | H | CF₃ | CH₂SCH₃ |
| T-183 | H | CF₃ | CH₂SC₂H₅ |
| T-184 | H | CF₃ | CH₂CH(CH₃)₂ |
| T-185 | H | CF₃ | C(CH₃)₂OH |
| T-186 | H | CF₃ | C(CH₃)₃ |
| T-187 | H | CF₃ | CH(CH₃)₂ |
| T-188 | H | CF₃ | CH₂OH |
| T-189 | H | CF₃ | CH(CH₃)CH₂OH |
| T-190 | H | CF₃ | CH₂CH(CH₃)OH |
| T-191 | H | CF₃ | CH₂—C10 |
| T-192 | H | CF₃ | CH₂—C11 |
| T-193 | H | CF₃ | CH₂SCF₃ |
| T-194 | H | CF₃ | CH₂S(O)CF₃ |
| T-195 | H | CF₃ | CH₂S(O)₂CF₃ |
| T-196 | H | CF₃ | C1 |
| T-197 | H | CF₃ | C2 |
| T-198 | H | CF₃ | C3 |
| T-199 | H | CF₃ | C4 |
| T-200 | H | CF₃ | C5 |
| T-201 | H | CF₃ | C6 |
| T-202 | H | CF₃ | C7 |
| T-203 | H | CF₃ | C8 |
| T-204 | H | CF₃ | C9 |
| T-205 | H | CF₃ | C10 |
| T-206 | H | CF₃ | C11 |
| T-207 | H | CF₃ | C12 |
| T-208 | H | CF₃ | C13 |
| T-209 | H | CF₃ | C14 |
| T-210 | H | CF₃ | C15 |
| T-211 | H | OCF₃ | CH₃ |
| T-212 | H | OCF₃ | C₂H₅ |
| T-213 | H | OCF₃ | CH₂CF₃ |
| T-214 | H | OCF₃ | CH₂CH₂CF₃ |
| T-215 | H | OCF₃ | CH₂CH₂CH₃ |
| T-216 | H | OCF₃ | CH₂OCH₃ |
| T-217 | H | OCF₃ | CH₂OC₂H₅ |
| T-218 | H | OCF₃ | CH₂OCF₃ |
| T-219 | H | OCF₃ | CH₂OCH₂CF₃ |
| T-220 | H | OCF₃ | CH₂S(O)CH₃ |
| T-221 | H | OCF₃ | CH₂S(O)C₂H₅ |
| T-222 | H | OCF₃ | CH₂S(O)₂CH₃ |
| T-223 | H | OCF₃ | CH₂S(O)₂C₂H₅ |
| T-224 | H | OCF₃ | CH₂SCH₃ |
| T-225 | H | OCF₃ | CH₂SC₂H₅ |
| T-226 | H | OCF₃ | CH₂CH(CH₃)₂ |
| T-227 | H | OCF₃ | C(CH₃)₂OH |
| T-228 | H | OCF₃ | C(CH₃)₃ |
| T-229 | H | OCF₃ | CH(CH₃)₂ |
| T-230 | H | OCF₃ | CH₂OH |
| T-231 | H | OCF₃ | CH(CH₃)CH₂OH |
| T-232 | H | OCF₃ | CH₂CH(CH₃)OH |
| T-233 | H | OCF₃ | CH₂—C10 |
| T-234 | H | OCF₃ | CH₂—C11 |
| T-235 | H | OCF₃ | CH₂SCF₃ |
| T-236 | H | OCF₃ | CH₂S(O)CF₃ |
| T-237 | H | OCF₃ | CH₂S(O)₂CF₃ |
| T-238 | H | OCF₃ | C1 |
| T-239 | H | OCF₃ | C2 |
| T-240 | H | OCF₃ | C3 |
| T-241 | H | OCF₃ | C4 |
| T-242 | H | OCF₃ | C5 |
| T-243 | H | OCF₃ | C6 |
| T-244 | H | OCF₃ | C7 |
| T-245 | H | OCF₃ | C8 |
| T-246 | H | OCF₃ | C9 |
| T-247 | H | OCF₃ | C10 |
| T-248 | H | OCF₃ | C11 |
| T-249 | H | OCF₃ | C12 |
| T-250 | H | OCF₃ | C13 |
| T-251 | H | OCF₃ | C14 |
| T-252 | H | OCF₃ | C15 |
| T-253 | F | H | CH₃ |
| T-254 | F | H | C₂H₅ |
| T-255 | F | H | CH₂CF₃ |
| T-256 | F | H | CH₂CH₂CF₃ |
| T-257 | F | H | CH₂CH₂CH₃ |
| T-258 | F | H | CH₂OCH₃ |
| T-259 | F | H | CH₂OC₂H₅ |
| T-260 | F | H | CH₂OCF₃ |
| T-261 | F | H | CH₂OCH₂CF₃ |
| T-262 | F | H | CH₂S(O)CH₃ |
| T-263 | F | H | CH₂S(O)C₂H₅ |
| T-264 | F | H | CH₂S(O)₂CH₃ |
| T-265 | F | H | CH₂S(O)₂C₂H₅ |
| T-266 | F | H | CH₂SCH₃ |
| T-267 | F | H | CH₂SC₂H₅ |
| T-268 | F | H | CH₂CH(CH₃)₂ |
| T-269 | F | H | C(CH₃)₂OH |
| T-270 | F | H | C(CH₃)₃ |
| T-271 | F | H | CH(CH₃)₂ |
| T-272 | F | H | CH₂OH |
| T-273 | F | H | CH(CH₃)CH₂OH |
| T-274 | F | H | CH₂CH(CH₃)OH |
| T-275 | F | H | CH₂—C10 |
| T-276 | F | H | CH₂—C11 |
| T-277 | F | H | CH₂SCF₃ |
| T-278 | F | H | CH₂S(O)CF₃ |
| T-279 | F | H | CH₂S(O)₂CF₃ |
| T-280 | F | H | C1 |
| T-281 | F | H | C2 |
| T-282 | F | H | C3 |
| T-283 | F | H | C4 |
| T-284 | F | H | C5 |
| T-285 | F | H | C6 |
| T-286 | F | H | C7 |
| T-287 | F | H | C8 |
| T-288 | F | H | C9 |
| T-289 | F | H | C10 |
| T-290 | F | H | C11 |
| T-291 | F | H | C12 |
| T-292 | F | H | C13 |
| T-293 | F | H | C14 |
| T-294 | F | H | C15 |
| T-295 | F | F | CH₃ |
| T-296 | F | F | C₂H₅ |
| T-297 | F | F | CH₂CF₃ |
| T-298 | F | F | CH₂CH₂CF₃ |
| T-299 | F | F | CH₂CH₂CH₃ |
| T-300 | F | F | CH₂OCH₃ |
| T-301 | F | F | CH₂OC₂H₅ |
| T-302 | F | F | CH₂OCF₃ |
| T-303 | F | F | CH₂OCH₂CF₃ |
| T-304 | F | F | CH₂S(O)CH₃ |
| T-305 | F | F | CH₂S(O)C₂H₅ |
| T-306 | F | F | CH₂S(O)₂CH₃ |
| T-307 | F | F | CH₂S(O)₂C₂H₅ |
| T-308 | F | F | CH₂SCH₃ |
| T-309 | F | F | CH₂SC₂H₅ |
| T-310 | F | F | CH₂CH(CH₃)₂ |
| T-311 | F | F | C(CH₃)₂OH |
| T-312 | F | F | C(CH₃)₃ |
| T-313 | F | F | CH(CH₃)₂ |
| T-314 | F | F | CH₂OH |
| T-315 | F | F | CH(CH₃)CH₂OH |
| T-316 | F | F | CH₂CH(CH₃)OH |
| T-317 | F | F | CH₂—C10 |
| T-318 | F | F | CH₂—C11 |
| T-319 | F | F | CH₂SCF₃ |
| T-320 | F | F | CH₂S(O)CF₃ |
| T-321 | F | F | CH₂S(O)₂CF₃ |
| T-322 | F | F | C1 |
| T-323 | F | F | C2 |
| T-324 | F | F | C3 |
| T-325 | F | F | C4 |
| T-326 | F | F | C5 |
| T-327 | F | F | C6 |
| T-328 | F | F | C7 |
| T-329 | F | F | C8 |
| T-330 | F | F | C9 |
| T-331 | F | F | C10 |
| T-332 | F | F | C11 |
| T-333 | F | F | C12 |
| T-334 | F | F | C13 |
| T-335 | F | F | C14 |
| T-336 | F | F | C15 |
| T-337 | F | Cl | CH₃ |
| T-338 | F | Cl | C₂H₅ |
| T-339 | F | Cl | CH₂CF₃ |
| T-340 | F | Cl | CH₂CH₂CF₃ |
| T-341 | F | Cl | CH₂CH₂CH₃ |
| T-342 | F | Cl | CH₂OCH₃ |
| T-343 | F | Cl | CH₂OC₂H₅ |
| T-344 | F | Cl | CH₂OCF₃ |
| T-345 | F | Cl | CH₂OCH₂CF₃ |
| T-346 | F | Cl | CH₂S(O)CH₃ |
| T-347 | F | Cl | CH₂S(O)C₂H₅ |
| T-348 | F | Cl | CH₂S(O)₂CH₃ |
| T-349 | F | Cl | CH₂S(O)₂C₂H₅ |
| T-350 | F | Cl | CH₂SCH₃ |
| T-351 | F | Cl | CH₂SC₂H₅ |
| T-352 | F | Cl | CH₂CH(CH₃)₂ |
| T-353 | F | Cl | C(CH₃)₂OH |
| T-354 | F | Cl | C(CH₃)₃ |
| T-355 | F | Cl | CH(CH₃)₂ |
| T-356 | F | Cl | CH₂OH |
| T-357 | F | Cl | CH(CH₃)CH₂OH |
| T-358 | F | Cl | CH₂CH(CH₃)OH |
| T-359 | F | Cl | CH₂—C10 |
| T-360 | F | Cl | CH₂—C11 |
| T-361 | F | Cl | CH₂SCF₃ |
| T-362 | F | Cl | CH₂S(O)CF₃ |
| T-363 | F | Cl | CH₂S(O)₂CF₃ |
| T-364 | F | Cl | C1 |
| T-365 | F | Cl | C2 |
| T-366 | F | Cl | C3 |
| T-367 | F | Cl | C4 |
| T-368 | F | Cl | C5 |
| T-369 | F | Cl | C6 |
| T-370 | F | Cl | C7 |
| T-371 | F | Cl | C8 |
| T-372 | F | Cl | C9 |
| T-373 | F | Cl | C10 |
| T-374 | F | Cl | C11 |
| T-375 | F | Cl | C12 |
| T-376 | F | Cl | C13 |
| T-377 | F | Cl | C14 |
| T-378 | F | Cl | C15 |
| T-379 | F | Br | CH₃ |
| T-380 | F | Br | C₂H₅ |
| T-381 | F | Br | CH₂CF₃ |
| T-382 | F | Br | CH₂CH₂CF₃ |
| T-383 | F | Br | CH₂CH₂CH₃ |
| T-384 | F | Br | CH₂OCH₃ |
| T-385 | F | Br | CH₂OC₂H₅ |
| T-386 | F | Br | CH₂OCF₃ |
| T-387 | F | Br | CH₂OCH₂CF₃ |
| T-388 | F | Br | CH₂S(O)CH₃ |
| T-389 | F | Br | CH₂S(O)C₂H₅ |
| T-390 | F | Br | CH₂S(O)₂CH₃ |
| T-391 | F | Br | CH₂S(O)₂C₂H₅ |
| T-392 | F | Br | CH₂SCH₃ |
| T-393 | F | Br | CH₂SC₂H₅ |
| T-394 | F | Br | CH₂CH(CH₃)₂ |
| T-395 | F | Br | C(CH₃)₂OH |
| T-396 | F | Br | C(CH₃)₃ |
| T-397 | F | Br | CH(CH₃)₂ |
| T-398 | F | Br | CH₂OH |
| T-399 | F | Br | CH(CH₃)CH₂OH |
| T-400 | F | Br | CH₂CH(CH₃)OH |
| T-401 | F | Br | CH₂—C10 |
| T-402 | F | Br | CH₂—C11 |
| T-403 | F | Br | CH₂SCF₃ |
| T-404 | F | Br | CH₂S(O)CF₃ |
| T-405 | F | Br | CH₂S(O)₂CF₃ |
| T-406 | F | Br | C1 |
| T-407 | F | Br | C2 |
| T-408 | F | Br | C3 |
| T-409 | F | Br | C4 |
| T-410 | F | Br | C5 |
| T-411 | F | Br | C6 |
| T-412 | F | Br | C7 |
| T-413 | F | Br | C8 |
| T-414 | F | Br | C9 |
| T-415 | F | Br | C10 |
| T-416 | F | Br | C11 |
| T-417 | F | Br | C12 |
| T-418 | F | Br | C13 |
| T-419 | F | Br | C14 |
| T-420 | F | Br | C15 |
| T-421 | F | CF₃ | CH₃ |
| T-422 | F | CF₃ | C₂H₅ |
| T-423 | F | CF₃ | CH₂CF₃ |
| T-424 | F | CF₃ | CH₂CH₂CF₃ |
| T-425 | F | CF₃ | CH₂CH₂CH₃ |
| T-426 | F | CF₃ | CH₂OCH₃ |
| T-427 | F | CF₃ | CH₂OC₂H₅ |
| T-428 | F | CF₃ | CH₂OCF₃ |
| T-429 | F | CF₃ | CH₂OCH₂CF₃ |
| T-430 | F | CF₃ | CH₂S(O)CH₃ |
| T-431 | F | CF₃ | CH₂S(O)C₂H₅ |
| T-432 | F | CF₃ | CH₂S(O)₂CH₃ |
| T-433 | F | CF₃ | CH₂S(O)₂C₂H₅ |
| T-434 | F | CF₃ | CH₂SCH₃ |
| T-435 | F | CF₃ | CH₂SC₂H₅ |
| T-436 | F | CF₃ | CH₂CH(CH₃)₂ |
| T-437 | F | CF₃ | C(CH₃)₂OH |
| T-438 | F | CF₃ | C(CH₃)₃ |
| T-439 | F | CF₃ | CH(CH₃)₂ |
| T-440 | F | CF₃ | CH₂OH |
| T-441 | F | CF₃ | CH(CH₃)CH₂OH |
| T-442 | F | CF₃ | CH₂CH(CH₃)OH |
| T-443 | F | CF₃ | CH₂—C10 |
| T-444 | F | CF₃ | CH₂—C11 |
| T-445 | F | CF₃ | CH₂SCF₃ |
| T-446 | F | CF₃ | CH₂S(O)CF₃ |
| T-447 | F | CF₃ | CH₂S(O)₂CF₃ |
| T-448 | F | CF₃ | C1 |
| T-449 | F | CF₃ | C2 |
| T-450 | F | CF₃ | C3 |
| T-451 | F | CF₃ | C4 |
| T-452 | F | CF₃ | C5 |
| T-453 | F | CF₃ | C6 |
| T-454 | F | CF₃ | C7 |
| T-455 | F | CF₃ | C8 |
| T-456 | F | CF₃ | C9 |
| T-457 | F | CF₃ | C10 |
| T-458 | F | CF₃ | C11 |
| T-459 | F | CF₃ | C12 |
| T-460 | F | CF₃ | C13 |
| T-461 | F | CF₃ | C14 |
| T-462 | F | CF₃ | C15 |
| T-463 | F | OCF₃ | CH₃ |
| T-464 | F | OCF₃ | C₂H₅ |
| T-465 | F | OCF₃ | CH₂CF₃ |
| T-466 | F | OCF₃ | CH₂CH₂CF₃ |
| T-467 | F | OCF₃ | CH₂CH₂CH₃ |
| T-468 | F | OCF₃ | CH₂OCH₃ |
| T-469 | F | OCF₃ | CH₂OC₂H₅ |
| T-470 | F | OCF₃ | CH₂OCF₃ |
| T-471 | F | OCF₃ | CH₂OCH₂CF₃ |
| T-472 | F | OCF₃ | CH₂S(O)CH₃ |
| T-473 | F | OCF₃ | CH₂S(O)C₂H₅ |
| T-474 | F | OCF₃ | CH₂S(O)₂CH₃ |
| T-475 | F | OCF₃ | CH₂S(O)₂C₂H₅ |
| T-476 | F | OCF₃ | CH₂SCH₃ |
| T-477 | F | OCF₃ | CH₂SC₂H₅ |
| T-478 | F | OCF₃ | CH₂CH(CH₃)₂ |
| T-479 | F | OCF₃ | C(CH₃)₂OH |
| T-480 | F | OCF₃ | C(CH₃)₃ |
| T-481 | F | OCF₃ | CH(CH₃)₂ |
| T-482 | F | OCF₃ | CH₂OH |
| T-483 | F | OCF₃ | CH(CH₃)CH₂OH |
| T-484 | F | OCF₃ | CH₂CH(CH₃)OH |
| T-485 | F | OCF₃ | CH₂—C10 |
| T-486 | F | OCF₃ | CH₂—C11 |
| T-487 | F | OCF₃ | CH₂SCF₃ |
| T-488 | F | OCF₃ | CH₂S(O)CF₃ |
| T-489 | F | OCF₃ | CH₂S(O)₂CF₃ |
| T-490 | F | OCF₃ | C1 |
| T-491 | F | OCF₃ | C2 |
| T-492 | F | OCF₃ | C3 |
| T-493 | F | OCF₃ | C4 |
| T-494 | F | OCF₃ | C5 |
| T-495 | F | OCF₃ | C6 |
| T-496 | F | OCF₃ | C7 |
| T-497 | F | OCF₃ | C8 |
| T-498 | F | OCF₃ | C9 |
| T-499 | F | OCF₃ | C10 |
| T-500 | F | OCF₃ | C11 |
| T-501 | F | OCF₃ | C12 |
| T-502 | F | OCF₃ | C13 |
| T-503 | F | OCF₃ | C14 |
| T-504 | F | OCF₃ | C15 |
| T-505 | Cl | H | CH₃ |
| T-506 | Cl | H | C₂H₅ |
| T-507 | Cl | H | CH₂CF₃ |
| T-508 | Cl | H | CH₂CH₂CF₃ |
| T-509 | Cl | H | CH₂CH₂CH₃ |
| T-510 | Cl | H | CH₂OCH₃ |
| T-511 | Cl | H | CH₂OC₂H₅ |
| T-512 | Cl | H | CH₂OCF₃ |
| T-513 | Cl | H | CH₂OCH₂CF₃ |
| T-514 | Cl | H | CH₂S(O)CH₃ |
| T-515 | Cl | H | CH₂S(O)C₂H₅ |
| T-516 | Cl | H | CH₂S(O)₂CH₃ |
| T-517 | Cl | H | CH₂S(O)₂C₂H₅ |
| T-518 | Cl | H | CH₂SCH₃ |
| T-519 | Cl | H | CH₂SC₂H₅ |
| T-520 | Cl | H | CH₂CH(CH₃)₂ |
| T-521 | Cl | H | C(CH₃)₂OH |
| T-522 | Cl | H | C(CH₃)₃ |
| T-523 | Cl | H | CH(CH₃)₂ |
| T-524 | Cl | H | CH₂OH |
| T-525 | Cl | H | CH(CH₃)CH₂OH |
| T-526 | Cl | H | CH₂CH(CH₃)OH |
| T-527 | Cl | H | CH₂—C10 |
| T-528 | Cl | H | CH₂—C11 |
| T-529 | Cl | H | CH₂SCF₃ |
| T-530 | Cl | H | CH₂S(O)CF₃ |
| T-531 | Cl | H | CH₂S(O)₂CF₃ |
| T-532 | Cl | H | C1 |
| T-533 | Cl | H | C2 |
| T-534 | Cl | H | C3 |
| T-535 | Cl | H | C4 |
| T-536 | Cl | H | C5 |
| T-537 | Cl | H | C6 |
| T-538 | Cl | H | C7 |
| T-539 | Cl | H | C8 |
| T-540 | Cl | H | C9 |
| T-541 | Cl | H | C10 |
| T-542 | Cl | H | C11 |
| T-543 | Cl | H | C12 |
| T-544 | Cl | H | C13 |
| T-545 | Cl | H | C14 |
| T-546 | Cl | H | C15 |
| T-547 | Cl | F | CH₃ |
| T-548 | Cl | F | C₂H₅ |
| T-549 | Cl | F | CH₂CF₃ |
| T-550 | Cl | F | CH₂CH₂CF₃ |
| T-551 | Cl | F | CH₂CH₂CH₃ |
| T-552 | Cl | F | CH₂OCH₃ |
| T-553 | Cl | F | CH₂OC₂H₅ |
| T-554 | Cl | F | CH₂OCF₃ |
| T-555 | Cl | F | CH₂OCH₂CF₃ |
| T-556 | Cl | F | CH₂S(O)CH₃ |
| T-557 | Cl | F | CH₂S(O)C₂H₅ |
| T-558 | Cl | F | CH₂S(O)₂CH₃ |
| T-559 | Cl | F | CH₂S(O)₂C₂H₅ |
| T-560 | Cl | F | CH₂SCH₃ |
| T-561 | Cl | F | CH₂SC₂H₅ |
| T-562 | Cl | F | CH₂CH(CH₃)₂ |
| T-563 | Cl | F | C(CH₃)₂OH |
| T-564 | Cl | F | C(CH₃)₃ |
| T-565 | Cl | F | CH(CH₃)₂ |
| T-566 | Cl | F | CH₂OH |
| T-567 | Cl | F | CH(CH₃)CH₂OH |
| T-568 | Cl | F | CH₂CH(CH₃)OH |
| T-569 | Cl | F | CH₂—C10 |
| T-570 | Cl | F | CH₂—C11 |
| T-571 | Cl | F | CH₂SCF₃ |
| T-572 | Cl | F | CH₂S(O)CF₃ |
| T-573 | Cl | F | CH₂S(O)₂CF₃ |
| T-574 | Cl | F | C1 |
| T-575 | Cl | F | C2 |
| T-576 | Cl | F | C3 |
| T-577 | Cl | F | C4 |
| T-578 | Cl | F | C5 |
| T-579 | Cl | F | C6 |
| T-580 | Cl | F | C7 |
| T-581 | Cl | F | C8 |
| T-582 | Cl | F | C9 |
| T-583 | Cl | F | C10 |
| T-584 | Cl | F | C11 |
| T-585 | Cl | F | C12 |
| T-586 | Cl | F | C13 |
| T-587 | Cl | F | C14 |
| T-588 | Cl | F | C15 |
| T-589 | Cl | Cl | CH₃ |
| T-590 | Cl | Cl | C₂H₅ |
| T-591 | Cl | Cl | CH₂CF₃ |
| T-592 | Cl | Cl | CH₂CH₂CF₃ |
| T-593 | Cl | Cl | CH₂CH₂CH₃ |
| T-594 | Cl | Cl | CH₂OCH₃ |
| T-595 | Cl | Cl | CH₂OC₂H₅ |
| T-596 | Cl | Cl | CH₂OCF₃ |
| T-597 | Cl | Cl | CH₂OCH₂CF₃ |
| T-598 | Cl | Cl | CH₂S(O)CH₃ |
| T-599 | Cl | Cl | CH₂S(O)C₂H₅ |
| T-600 | Cl | Cl | CH₂S(O)₂CH₃ |
| T-601 | Cl | Cl | CH₂S(O)₂C₂H₅ |
| T-602 | Cl | Cl | CH₂SCH₃ |
| T-603 | Cl | Cl | CH₂SC₂H₅ |
| T-604 | Cl | Cl | CH₂CH(CH₃)₂ |
| T-605 | Cl | Cl | C(CH₃)₂OH |
| T-606 | Cl | Cl | C(CH₃)₃ |
| T-607 | Cl | Cl | CH(CH₃)₂ |
| T-608 | Cl | Cl | CH₂OH |
| T-609 | Cl | Cl | CH(CH₃)CH₂OH |
| T-610 | Cl | Cl | CH₂CH(CH₃)OH |
| T-611 | Cl | Cl | CH₂—C10 |
| T-612 | Cl | Cl | CH₂—C11 |
| T-613 | Cl | Cl | CH₂SCF₃ |
| T-614 | Cl | Cl | CH₂S(O)CF₃ |
| T-615 | Cl | Cl | CH₂S(O)₂CF₃ |
| T-616 | Cl | Cl | C1 |
| T-617 | Cl | Cl | C2 |
| T-618 | Cl | Cl | C3 |
| T-619 | Cl | Cl | C4 |
| T-620 | Cl | Cl | C5 |
| T-621 | Cl | Cl | C6 |
| T-622 | Cl | Cl | C7 |
| T-623 | Cl | Cl | C8 |
| T-624 | Cl | Cl | C9 |
| T-625 | Cl | Cl | C10 |
| T-626 | Cl | Cl | C11 |
| T-627 | Cl | Cl | C12 |
| T-628 | Cl | Cl | C13 |
| T-629 | Cl | Cl | C14 |
| T-630 | Cl | Cl | C15 |
| T-631 | Cl | Br | CH₃ |
| T-632 | Cl | Br | C₂H₅ |
| T-633 | Cl | Br | CH₂CF₃ |
| T-634 | Cl | Br | CH₂CH₂CF₃ |
| T-635 | Cl | Br | CH₂CH₂CH₃ |
| T-636 | Cl | Br | CH₂OCH₃ |
| T-637 | Cl | Br | CH₂OC₂H₅ |
| T-638 | Cl | Br | CH₂OCF₃ |
| T-639 | Cl | Br | CH₂OCH₂CF₃ |
| T-640 | Cl | Br | CH₂S(O)CH₃ |
| T-641 | Cl | Br | CH₂S(O)C₂H₅ |
| T-642 | Cl | Br | CH₂S(O)₂CH₃ |
| T-643 | Cl | Br | CH₂S(O)₂C₂H₅ |
| T-644 | Cl | Br | CH₂SCH₃ |
| T-645 | Cl | Br | CH₂SC₂H₅ |
| T-646 | Cl | Br | CH₂CH(CH₃)₂ |
| T-647 | Cl | Br | C(CH₃)₂OH |
| T-648 | Cl | Br | C(CH₃)₃ |
| T-649 | Cl | Br | CH(CH₃)₂ |
| T-650 | Cl | Br | CH₂OH |
| T-651 | Cl | Br | CH(CH₃)CH₂OH |
| T-652 | Cl | Br | CH₂CH(CH₃)OH |
| T-653 | Cl | Br | CH₂—C10 |
| T-654 | Cl | Br | CH₂—C11 |
| T-655 | Cl | Br | CH₂SCF₃ |
| T-656 | Cl | Br | CH₂S(O)CF₃ |
| T-657 | Cl | Br | CH₂S(O)₂CF₃ |
| T-658 | Cl | Br | C1 |
| T-659 | Cl | Br | C2 |
| T-660 | Cl | Br | C3 |
| T-661 | Cl | Br | C4 |
| T-662 | Cl | Br | C5 |
| T-663 | Cl | Br | C6 |
| T-664 | Cl | Br | C7 |
| T-665 | Cl | Br | C8 |
| T-666 | Cl | Br | C9 |
| T-667 | Cl | Br | C10 |
| T-668 | Cl | Br | C11 |
| T-669 | Cl | Br | C12 |
| T-670 | Cl | Br | C13 |
| T-671 | Cl | Br | C14 |
| T-672 | Cl | Br | C15 |
| T-673 | Cl | CF₃ | CH₃ |
| T-674 | Cl | CF₃ | C₂H₅ |
| T-675 | Cl | CF₃ | CH₂CF₃ |
| T-676 | Cl | CF₃ | CH₂CH₂CF₃ |
| T-677 | Cl | CF₃ | CH₂CH₂CH₃ |
| T-678 | Cl | CF₃ | CH₂OCH₃ |
| T-679 | Cl | CF₃ | CH₂OC₂H₅ |
| T-680 | Cl | CF₃ | CH₂OCF₃ |
| T-681 | Cl | CF₃ | CH₂OCH₂CF₃ |
| T-682 | Cl | CF₃ | CH₂S(O)CH₃ |
| T-683 | Cl | CF₃ | CH₂S(O)C₂H₅ |
| T-684 | Cl | CF₃ | CH₂S(O)₂CH₃ |
| T-685 | Cl | CF₃ | CH₂S(O)₂C₂H₅ |
| T-686 | Cl | CF₃ | CH₂SCH₃ |
| T-687 | Cl | CF₃ | CH₂SC₂H₅ |
| T-688 | Cl | CF₃ | CH₂CH(CH₃)₂ |
| T-689 | Cl | CF₃ | C(CH₃)₂OH |
| T-690 | Cl | CF₃ | C(CH₃)₃ |
| T-691 | Cl | CF₃ | CH(CH₃)₂ |
| T-692 | Cl | CF₃ | CH₂OH |
| T-693 | Cl | CF₃ | CH(CH₃)CH₂OH |
| T-694 | Cl | CF₃ | CH₂CH(CH₃)OH |
| T-695 | Cl | CF₃ | CH₂—C10 |
| T-696 | Cl | CF₃ | CH₂—C11 |
| T-697 | Cl | CF₃ | CH₂SCF₃ |
| T-698 | Cl | CF₃ | CH₂S(O)CF₃ |
| T-699 | Cl | CF₃ | CH₂S(O)₂CF₃ |
| T-700 | Cl | CF₃ | C1 |
| T-701 | Cl | CF₃ | C2 |
| T-702 | Cl | CF₃ | C3 |
| T-703 | Cl | CF₃ | C4 |
| T-704 | Cl | CF₃ | C5 |
| T-705 | Cl | CF₃ | C6 |
| T-706 | Cl | CF₃ | C7 |
| T-707 | Cl | CF₃ | C8 |
| T-708 | Cl | CF₃ | C9 |
| T-709 | Cl | CF₃ | C10 |
| T-710 | Cl | CF₃ | C11 |
| T-711 | Cl | CF₃ | C12 |
| T-712 | Cl | CF₃ | C13 |
| T-713 | Cl | CF₃ | C14 |
| T-714 | Cl | CF₃ | C15 |
| T-715 | Cl | OCF₃ | CH₃ |
| T-716 | Cl | OCF₃ | C₂H₅ |
| T-717 | Cl | OCF₃ | CH₂CF₃ |
| T-718 | Cl | OCF₃ | CH₂CH₂CF₃ |
| T-719 | Cl | OCF₃ | CH₂CH₂CH₃ |
| T-720 | Cl | OCF₃ | CH₂OCH₃ |
| T-721 | Cl | OCF₃ | CH₂OC₂H₅ |
| T-722 | Cl | OCF₃ | CH₂OCF₃ |
| T-723 | Cl | OCF₃ | CH₂OCH₂CF₃ |
| T-724 | Cl | OCF₃ | CH₂S(O)CH₃ |
| T-725 | Cl | OCF₃ | CH₂S(O)C₂H₅ |
| T-726 | Cl | OCF₃ | CH₂S(O)₂CH₃ |
| T-727 | Cl | OCF₃ | CH₂S(O)₂C₂H₅ |
| T-728 | Cl | OCF₃ | CH₂SCH₃ |
| T-729 | Cl | OCF₃ | CH₂SC₂H₅ |
| T-730 | Cl | OCF₃ | CH₂CH(CH₃)₂ |
| T-731 | Cl | OCF₃ | C(CH₃)₂OH |
| T-732 | Cl | OCF₃ | C(CH₃)₃ |
| T-733 | Cl | OCF₃ | CH(CH₃)₂ |
| T-734 | Cl | OCF₃ | CH₂OH |
| T-735 | Cl | OCF₃ | CH(CH₃)CH₂OH |
| T-736 | Cl | OCF₃ | CH₂CH(CH₃)OH |
| T-737 | Cl | OCF₃ | CH₂—C10 |
| T-738 | Cl | OCF₃ | CH₂—C11 |
| T-739 | Cl | OCF₃ | CH₂SCF₃ |
| T-740 | Cl | OCF₃ | CH₂S(O)CF₃ |
| T-741 | Cl | OCF₃ | CH₂S(O)₂CF₃ |
| T-742 | Cl | OCF₃ | C1 |
| T-743 | Cl | OCF₃ | C2 |
| T-744 | Cl | OCF₃ | C3 |
| T-745 | Cl | OCF₃ | C4 |
| T-746 | Cl | OCF₃ | C5 |
| T-747 | Cl | OCF₃ | C6 |
| T-748 | Cl | OCF₃ | C7 |
| T-749 | Cl | OCF₃ | C8 |
| T-750 | Cl | OCF₃ | C9 |
| T-751 | Cl | OCF₃ | C10 |
| T-752 | Cl | OCF₃ | C11 |
| T-753 | Cl | OCF₃ | C12 |
| T-754 | Cl | OCF₃ | C13 |
| T-755 | Cl | OCF₃ | C14 |
| T-756 | Cl | OCF₃ | C15 |
| T-757 | Br | H | CH₃ |
| T-758 | Br | H | C₂H₅ |
| T-759 | Br | H | CH₂CF₃ |
| T-760 | Br | H | CH₂CH₂CF₃ |
| T-761 | Br | H | CH₂CH₂CH₃ |
| T-762 | Br | H | CH₂OCH₃ |
| T-763 | Br | H | CH₂OC₂H₅ |
| T-764 | Br | H | CH₂OCF₃ |
| T-765 | Br | H | CH₂OCH₂CF₃ |
| T-766 | Br | H | CH₂S(O)CH₃ |
| T-767 | Br | H | CH₂S(O)C₂H₅ |
| T-768 | Br | H | CH₂S(O)₂CH₃ |
| T-769 | Br | H | CH₂S(O)₂C₂H₅ |
| T-770 | Br | H | CH₂SCH₃ |
| T-771 | Br | H | CF₂SC₂H₅ |
| T-772 | Br | H | CH₂CH(CH₃)₂ |
| T-773 | Br | H | C(CH₃)₂OH |
| T-774 | Br | H | C(CH₃)₃ |
| T-775 | Br | H | CH(CH₃)₂ |
| T-776 | Br | H | CH₂OH |
| T-777 | Br | H | CH(CH₃)CH₂OH |
| T-778 | Br | H | CH₂CH(CH₃)OH |
| T-779 | Br | H | CH₂—C10 |
| T-780 | Br | H | CH₂—C11 |
| T-781 | Br | H | CH₂SCF₃ |
| T-782 | Br | H | CH₂S(O)CF₃ |
| T-783 | Br | H | CH₂S(O)₂CF₃ |
| T-784 | Br | H | C1 |
| T-785 | Br | H | C2 |
| T-786 | Br | H | C3 |
| T-787 | Br | H | C4 |
| T-788 | Br | H | C5 |
| T-789 | Br | H | C6 |
| T-790 | Br | H | C7 |
| T-791 | Br | H | C8 |
| T-792 | Br | H | C9 |
| T-793 | Br | H | C10 |
| T-794 | Br | H | C11 |
| T-795 | Br | H | C12 |
| T-796 | Br | H | C13 |
| T-797 | Br | H | C14 |
| T-798 | Br | H | C15 |
| T-799 | Br | F | CH₃ |
| T-800 | Br | F | C₂H₅ |
| T-801 | Br | F | CH₂CF₃ |
| T-802 | Br | F | CH₂CH₂CF₃ |
| T-803 | Br | F | CH₂CH₂CH₃ |
| T-804 | Br | F | CH₂OCH₃ |
| T-805 | Br | F | CH₂OC₂H₅ |
| T-806 | Br | F | CH₂OCF₃ |
| T-807 | Br | F | CH₂OCH₂CF₃ |
| T-808 | Br | F | CH₂S(O)CH₃ |
| T-809 | Br | F | CH₂S(O)C₂H₅ |
| T-810 | Br | F | CH₂S(O)₂CH₃ |
| T-811 | Br | F | CH₂S(O)₂C₂H₅ |
| T-812 | Br | F | CH₂SCH₃ |
| T-813 | Br | F | CH₂SC₂H₅ |
| T-814 | Br | F | CH₂CH(CH₃)₂ |
| T-815 | Br | F | C(CH₃)₂OH |
| T-816 | Br | F | C(CH₃)₃ |
| T-817 | Br | F | CH(CH₃)₂ |
| T-818 | Br | F | CH₂OH |
| T-819 | Br | F | CH(CH₃)CH₂OH |
| T-820 | Br | F | CH₂CH(CH₃)OH |
| T-821 | Br | F | CH₂—C10 |
| T-822 | Br | F | CH₂—C11 |
| T-823 | Br | F | CH₂SCF₃ |
| T-824 | Br | F | CH₂S(O)CF₃ |
| T-825 | Br | F | CH₂S(O)₂CF₃ |
| T-826 | Br | F | C1 |
| T-827 | Br | F | C2 |
| T-828 | Br | F | C3 |
| T-829 | Br | F | C4 |
| T-830 | Br | F | C5 |
| T-831 | Br | F | C6 |
| T-832 | Br | F | C7 |
| T-833 | Br | F | C8 |
| T-834 | Br | F | C9 |
| T-835 | Br | F | C10 |
| T-836 | Br | F | C11 |
| T-837 | Br | F | C12 |
| T-838 | Br | F | C13 |
| T-839 | Br | F | C14 |
| T-840 | Br | F | C15 |
| T-841 | Br | Cl | CH₃ |
| T-842 | Br | Cl | C₂H₅ |
| T-843 | Br | Cl | CH₂CF₃ |
| T-844 | Br | Cl | CH₂CH₂CF₃ |
| T-845 | Br | Cl | CH₂CH₂CH₃ |
| T-846 | Br | Cl | CH₂OCH₃ |
| T-847 | Br | Cl | CH₂OC₂H₅ |
| T-848 | Br | Cl | CH₂OCF₃ |
| T-849 | Br | Cl | CH₂OCH₂CF₃ |
| T-850 | Br | Cl | CH₂S(O)CH₃ |
| T-851 | Br | Cl | CH₂S(O)C₂H₅ |
| T-852 | Br | Cl | CH₂S(O)₂CH₃ |
| T-853 | Br | Cl | CH₂S(O)₂C₂H₅ |
| T-854 | Br | Cl | CH₂SCH₃ |
| T-855 | Br | Cl | CH₂SC₂H₅ |
| T-856 | Br | Cl | CH₂CH(CH₃)₂ |
| T-857 | Br | Cl | C(CH₃)₂OH |
| T-858 | Br | Cl | C(CH₃)₃ |
| T-859 | Br | Cl | CH(CH₃)₂ |
| T-860 | Br | Cl | CH₂OH |
| T-861 | Br | Cl | CH(CH₃)CH₂OH |
| T-862 | Br | Cl | CH₂CH(CH₃)OH |
| T-863 | Br | Cl | CH₂—C10 |
| T-864 | Br | Cl | CH₂—C11 |
| T-865 | Br | Cl | CH₂SCF₃ |
| T-866 | Br | Cl | CH₂S(O)CF₃ |
| T-867 | Br | Cl | CH₂S(O)₂CF₃ |
| T-868 | Br | Cl | C1 |
| T-869 | Br | Cl | C2 |
| T-870 | Br | Cl | C3 |
| T-871 | Br | Cl | C4 |
| T-872 | Br | Cl | C5 |
| T-873 | Br | Cl | C6 |
| T-874 | Br | Cl | C7 |
| T-875 | Br | Cl | C8 |
| T-876 | Br | Cl | C9 |
| T-877 | Br | Cl | C10 |
| T-878 | Br | Cl | C11 |
| T-879 | Br | Cl | C12 |
| T-880 | Br | Cl | C13 |
| T-881 | Br | Cl | C14 |
| T-882 | Br | Cl | C15 |
| T-883 | Br | Br | CH₃ |
| T-884 | Br | Br | C₂H₅ |
| T-885 | Br | Br | CH₂CF₃ |
| T-886 | Br | Br | CH₂CH₂CF₃ |
| T-887 | Br | Br | CH₂CH₂CH₃ |
| T-888 | Br | Br | CH₂OCH₃ |
| T-889 | Br | Br | CH₂OC₂H₅ |
| T-890 | Br | Br | CH₂OCF₃ |
| T-891 | Br | Br | CH₂OCH₂CF₃ |
| T-892 | Br | Br | CH₂S(O)CH₃ |
| T-893 | Br | Br | CH₂S(O)C₂H₅ |
| T-894 | Br | Br | CH₂S(O)₂CH₃ |
| T-895 | Br | Br | CH₂S(O)₂C₂H₅ |
| T-896 | Br | Br | CH₂SCH₃ |
| T-897 | Br | Br | CH₂SC₂H₅ |
| T-898 | Br | Br | CH₂CH(CH₃)₂ |
| T-899 | Br | Br | C(CH₃)₂OH |
| T-900 | Br | Br | C(CH₃)₃ |
| T-901 | Br | Br | CH(CH₃)₂ |
| T-902 | Br | Br | CH₂OH |
| T-903 | Br | Br | CH(CH₃)CH₂OH |
| T-904 | Br | Br | CH₂CH(CH₃)OH |
| T-905 | Br | Br | CH₂—C10 |
| T-906 | Br | Br | CH₂—C11 |
| T-907 | Br | Br | CH₂SCF₃ |
| T-908 | Br | Br | CH₂S(O)CF₃ |
| T-909 | Br | Br | CH₂S(O)₂CF₃ |
| T-910 | Br | Br | C1 |
| T-911 | Br | Br | C2 |
| T-912 | Br | Br | C3 |
| T-913 | Br | Br | C4 |
| T-914 | Br | Br | C5 |
| T-915 | Br | Br | C6 |
| T-916 | Br | Br | C7 |
| T-917 | Br | Br | C8 |
| T-918 | Br | Br | C9 |
| T-919 | Br | Br | C10 |
| T-920 | Br | Br | C11 |
| T-921 | Br | Br | C12 |
| T-922 | Br | Br | C13 |
| T-923 | Br | Br | C14 |
| T-924 | Br | Br | C15 |
| T-925 | Br | CF₃ | CH₃ |
| T-926 | Br | CF₃ | C₂H₅ |
| T-927 | Br | CF₃ | CH₂CF₃ |
| T-928 | Br | CF₃ | CH₂CH₂CF₃ |
| T-929 | Br | CF₃ | CH₂CH₂CH₃ |
| T-930 | Br | CF₃ | CH₂OCH₃ |
| T-931 | Br | CF₃ | CH₂OC₂H₅ |
| T-932 | Br | CF₃ | CH₂OCF₃ |
| T-933 | Br | CF₃ | CH₂OCH₂CF₃ |
| T-934 | Br | CF₃ | CH₂S(O)CH₃ |
| T-935 | Br | CF₃ | CH₂S(O)C₂H₅ |
| T-936 | Br | CF₃ | CH₂S(O)₂CH₃ |
| T-937 | Br | CF₃ | CH₂S(O)₂C₂H₅ |
| T-938 | Br | CF₃ | CH₂SCH₃ |
| T-939 | Br | CF₃ | CH₂SC₂H₅ |
| T-940 | Br | CF₃ | CH₂CH(CH₃)₂ |
| T-941 | Br | CF₃ | C(CH₃)₂OH |
| T-942 | Br | CF₃ | C(CH₃)₃ |
| T-943 | Br | CF₃ | CH(CH₃)₂ |
| T-944 | Br | CF₃ | CH₂OH |
| T-945 | Br | CF₃ | CH(CH₃)CH₂OH |
| T-946 | Br | CF₃ | CH₂CH(CH₃)OH |
| T-947 | Br | CF₃ | CH₂—C10 |
| T-948 | Br | CF₃ | CH₂—C11 |
| T-949 | Br | CF₃ | CH₂SCF₃ |
| T-950 | Br | CF₃ | CH₂S(O)CF₃ |
| T-951 | Br | CF₃ | CH₂S(O)₂CF₃ |
| T-952 | Br | CF₃ | C1 |
| T-953 | Br | CF₃ | C2 |
| T-954 | Br | CF₃ | C3 |
| T-955 | Br | CF₃ | C4 |
| T-956 | Br | CF₃ | C5 |
| T-957 | Br | CF₃ | C6 |
| T-958 | Br | CF₃ | C7 |
| T-959 | Br | CF₃ | C8 |
| T-960 | Br | CF₃ | C9 |
| T-961 | Br | CF₃ | C10 |
| T-962 | Br | CF₃ | C11 |
| T-963 | Br | CF₃ | C12 |
| T-964 | Br | CF₃ | C13 |
| T-965 | Br | CF₃ | C14 |
| T-966 | Br | CF₃ | C15 |
| T-967 | Br | OCF₃ | CH₃ |
| T-968 | Br | OCF₃ | C₂H₅ |
| T-969 | Br | OCF₃ | CH₂CF₃ |
| T-970 | Br | OCF₃ | CH₂CH₂CF₃ |
| T-971 | Br | OCF₃ | CH₂CH₂CH₃ |
| T-972 | Br | OCF₃ | CH₂OCH₃ |
| T-973 | Br | OCF₃ | CH₂OC₂H₅ |
| T-974 | Br | OCF₃ | CH₂OCF₃ |
| T-975 | Br | OCF₃ | CH₂OCH₂CF₃ |
| T-976 | Br | OCF₃ | CH₂S(O)CH₃ |
| T-977 | Br | OCF₃ | CH₂S(O)C₂H₅ |
| T-978 | Br | OCF₃ | CH₂S(O)₂CH₃ |
| T-979 | Br | OCF₃ | CH₂S(O)₂C₂H₅ |
| T-980 | Br | OCF₃ | CH₂SCH₃ |
| T-981 | Br | OCF₃ | CH₂SC₂H₅ |
| T-982 | Br | OCF₃ | CH₂CH(CH₃)₂ |
| T-983 | Br | OCF₃ | C(CH₃)₂OH |
| T-984 | Br | OCF₃ | C(CH₃)₃ |
| T-985 | Br | OCF₃ | CH(CH₃)₂ |
| T-986 | Br | OCF₃ | CH₂OH |
| T-987 | Br | OCF₃ | CH(CH₃)CH₂OH |
| T-988 | Br | OCF₃ | CH₂CH(CH₃)OH |
| T-989 | Br | OCF₃ | CH₂—C10 |
| T-990 | Br | OCF₃ | CH₂—C11 |
| T-991 | Br | OCF₃ | CH₂SCF₃ |
| T-992 | Br | OCF₃ | CH₂S(O)CF₃ |
| T-993 | Br | OCF₃ | CH₂S(O)₂CF₃ |
| T-994 | Br | OCF₃ | C1 |
| T-995 | Br | OCF₃ | C2 |
| T-996 | Br | OCF₃ | C3 |
| T-997 | Br | OCF₃ | C4 |
| T-998 | Br | OCF₃ | C5 |
| T-999 | Br | OCF₃ | C6 |
| T-1000 | Br | OCF₃ | C7 |
| T-1001 | Br | OCF₃ | C8 |
| T-1002 | Br | OCF₃ | C9 |
| T-1003 | Br | OCF₃ | C10 |
| T-1004 | Br | OCF₃ | C11 |
| T-1005 | Br | OCF₃ | C12 |
| T-1006 | Br | OCF₃ | C13 |
| T-1007 | Br | OCF₃ | C14 |
| T-1008 | Br | OCF₃ | C15 |
| T-1009 | CF₃ | H | CH₃ |
| T-1010 | CF₃ | H | C₂H₅ |
| T-1011 | CF₃ | H | CH₂CF₃ |
| T-1012 | CF₃ | H | CH₂CH₂CF₃ |
| T-1013 | CF₃ | H | CH₂CH₂CH₃ |
| T-1014 | CF₃ | H | CH₂OCH₃ |
| T-1015 | CF₃ | H | CH₂OC₂H₅ |
| T-1016 | CF₃ | H | CH₂OCF₃ |
| T-1017 | CF₃ | H | CH₂OCH₂CF₃ |
| T-1018 | CF₃ | H | CH₂S(O)CH₃ |
| T-1019 | CF₃ | H | CH₂S(O)C₂H₅ |
| T-1020 | CF₃ | H | CH₂S(O)₂CH₃ |
| T-1021 | CF₃ | H | CH₂S(O)₂C₂H₅ |
| T-1022 | CF₃ | H | CH₂SCH₃ |
| T-1023 | CF₃ | H | CH₂SC₂H₅ |
| T-1024 | CF₃ | H | CH₂CH(CH₃)₂ |
| T-1025 | CF₃ | H | C(CH₃)₂OH |
| T-1026 | CF₃ | H | C(CH₃)₃ |
| T-1027 | CF₃ | H | CH(CH₃)₂ |
| T-1028 | CF₃ | H | CH₂OH |
| T-1029 | CF₃ | H | CH(CH₃)CH₂OH |
| T-1030 | CF₃ | H | CH₂CH(CH₃)OH |
| T-1031 | CF₃ | H | CH₂—C10 |
| T-1032 | CF₃ | H | CH₂—C11 |
| T-1033 | CF₃ | H | CH₂SCF₃ |
| T-1034 | CF₃ | H | CH₂S(O)CF₃ |
| T-1035 | CF₃ | H | CH₂S(O)₂CF₃ |
| T-1036 | CF₃ | H | C1 |
| T-1037 | CF₃ | H | C2 |
| T-1038 | CF₃ | H | C3 |
| T-1039 | CF₃ | H | C4 |
| T-1040 | CF₃ | H | C5 |
| T-1041 | CF₃ | H | C6 |
| T-1042 | CF₃ | H | C7 |
| T-1043 | CF₃ | H | C8 |
| T-1044 | CF₃ | H | C9 |
| T-1045 | CF₃ | H | C10 |
| T-1046 | CF₃ | H | C11 |
| T-1047 | CF₃ | H | C12 |
| T-1048 | CF₃ | H | C13 |
| T-1049 | CF₃ | H | C14 |
| T-1050 | CF₃ | H | C15 |
| T-1051 | CF₃ | F | CH₃ |
| T-1052 | CF₃ | F | C₂H₅ |
| T-1053 | CF₃ | F | CH₂CF₃ |
| T-1054 | CF₃ | F | CH₂CH₂CF₃ |
| T-1055 | CF₃ | F | CH₂CH₂CH₃ |
| T-1056 | CF₃ | F | CH₂OCH₃ |
| T-1057 | CF₃ | F | CH₂OC₂H₅ |
| T-1058 | CF₃ | F | CH₂OCF₃ |
| T-1059 | CF₃ | F | CH₂OCH₂CF₃ |
| T-1060 | CF₃ | F | CH₂S(O)CH₃ |
| T-1061 | CF₃ | F | CH₂S(O)C₂H₅ |
| T-1062 | CF₃ | F | CH₂S(O)₂CH₃ |
| T-1063 | CF₃ | F | CH₂S(O)₂C₂H₅ |
| T-1064 | CF₃ | F | CH₂SCH₃ |
| T-1065 | CF₃ | F | CH₂SC₂H₅ |
| T-1066 | CF₃ | F | CH₂CH(CH₃)₂ |
| T-1067 | CF₃ | F | C(CH₃)₂OH |
| T-1068 | CF₃ | F | C(CH₃)₃ |
| T-1069 | CF₃ | F | CH(CH₃)₂ |
| T-1070 | CF₃ | F | CH₂OH |
| T-1071 | CF₃ | F | CH(CH₃)CH₂OH |
| T-1072 | CF₃ | F | CH₂CH(CH₃)OH |
| T-1073 | CF₃ | F | CH₂—C10 |
| T-1074 | CF₃ | F | CH₂—C11 |
| T-1075 | CF₃ | F | CH₂SCF₃ |
| T-1076 | CF₃ | F | CH₂S(O)CF₃ |
| T-1077 | CF₃ | F | CH₂S(O)₂CF₃ |
| T-1078 | CF₃ | F | C1 |
| T-1079 | CF₃ | F | C2 |
| T-1080 | CF₃ | F | C3 |
| T-1081 | CF₃ | F | C4 |
| T-1082 | CF₃ | F | C5 |
| T-1083 | CF₃ | F | C6 |
| T-1084 | CF₃ | F | C7 |
| T-1085 | CF₃ | F | C8 |
| T-1086 | CF₃ | F | C9 |
| T-1087 | CF₃ | F | C10 |
| T-1088 | CF₃ | F | C11 |
| T-1089 | CF₃ | F | C12 |
| T-1090 | CF₃ | F | C13 |
| T-1091 | CF₃ | F | C14 |
| T-1092 | CF₃ | F | C15 |
| T-1093 | CF₃ | Cl | CH₃ |
| T-1094 | CF₃ | Cl | C₂H₅ |
| T-1095 | CF₃ | Cl | CH₂CF₃ |
| T-1096 | CF₃ | Cl | CH₂CH₂CF₃ |
| T-1097 | CF₃ | Cl | CH₂CH₂CH₃ |
| T-1098 | CF₃ | Cl | CH₂OCH₃ |
| T-1099 | CF₃ | Cl | CH₂OC₂H₅ |
| T-1100 | CF₃ | Cl | CH₂OCF₃ |
| T-1101 | CF₃ | Cl | CH₂OCH₂CF₃ |
| T-1102 | CF₃ | Cl | CH₂S(O)CH₃ |
| T-1103 | CF₃ | Cl | CH₂S(O)C₂H₅ |
| T-1104 | CF₃ | Cl | CH₂S(O)₂CH₃ |
| T-1105 | CF₃ | Cl | CH₂S(O)₂C₂H₅ |
| T-1106 | CF₃ | Cl | CH₂SCH₃ |
| T-1107 | CF₃ | Cl | CH₂SC₂H₅ |
| T-1108 | CF₃ | Cl | CH₂CH(CH₃)₂ |
| T-1109 | CF₃ | Cl | C(CH₃)₂OH |
| T-1110 | CF₃ | Cl | C(CH₃)₃ |
| T-1111 | CF₃ | Cl | CH(CH₃)₂ |
| T-1112 | CF₃ | Cl | CH₂OH |
| T-1113 | CF₃ | Cl | CH(CH₃)CH₂OH |
| T-1114 | CF₃ | Cl | CH₂CH(CH₃)OH |
| T-1115 | CF₃ | Cl | CH₂—C10 |
| T-1116 | CF₃ | Cl | CH₂—C11 |
| T-1117 | CF₃ | Cl | CH₂SCF₃ |
| T-1118 | CF₃ | Cl | CH₂S(O)CF₃ |
| T-1119 | CF₃ | Cl | CH₂S(O)₂CF₃ |
| T-1120 | CF₃ | Cl | C1 |
| T-1121 | CF₃ | Cl | C2 |
| T-1122 | CF₃ | Cl | C3 |
| T-1123 | CF₃ | Cl | C4 |
| T-1124 | CF₃ | Cl | C5 |
| T-1125 | CF₃ | Cl | C6 |
| T-1126 | CF₃ | Cl | C7 |
| T-1127 | CF₃ | Cl | C8 |
| T-1128 | CF₃ | Cl | C9 |
| T-1129 | CF₃ | Cl | C10 |
| T-1130 | CF₃ | Cl | C11 |
| T-1131 | CF₃ | Cl | C12 |
| T-1132 | CF₃ | Cl | C13 |
| T-1133 | CF₃ | Cl | C14 |
| T-1134 | CF₃ | Cl | C15 |
| T-1135 | CF₃ | Br | CH₃ |
| T-1136 | CF₃ | Br | C₂H₅ |
| T-1137 | CF₃ | Br | CH₂CF₃ |
| T-1138 | CF₃ | Br | CH₂CH₂CF₃ |
| T-1139 | CF₃ | Br | CH₂CH₂CH₃ |
| T-1140 | CF₃ | Br | CH₂OCH₃ |
| T-1141 | CF₃ | Br | CH₂OC₂H₅ |
| T-1142 | CF₃ | Br | CH₂OCF₃ |
| T-1143 | CF₃ | Br | CH₂OCH₂CF₃ |
| T-1144 | CF₃ | Br | CH₂S(O)CH₃ |
| T-1145 | CF₃ | Br | CH₂S(O)C₂H₅ |
| T-1146 | CF₃ | Br | CH₂S(O)₂CH₃ |
| T-1147 | CF₃ | Br | CH₂S(O)₂C₂H₅ |
| T-1148 | CF₃ | Br | CH₂SCH₃ |
| T-1149 | CF₃ | Br | CH₂SC₂H₅ |
| T-1150 | CF₃ | Br | CH₂CH(CH₃)₂ |
| T-1151 | CF₃ | Br | C(CH₃)₂OH |
| T-1152 | CF₃ | Br | C(CH₃)₃ |
| T-1153 | CF₃ | Br | CH(CH₃)₂ |
| T-1154 | CF₃ | Br | CH₂OH |
| T-1155 | CF₃ | Br | CH(CH₃)CH₂OH |
| T-1156 | CF₃ | Br | CH₂CH(CH₃)OH |
| T-1157 | CF₃ | Br | CH₂—C10 |
| T-1158 | CF₃ | Br | CH₂—C11 |
| T-1159 | CF₃ | Br | CH₂SCF₃ |
| T-1160 | CF₃ | Br | CH₂S(O)CF₃ |
| T-1161 | CF₃ | Br | CH₂S(O)₂CF₃ |
| T-1162 | CF₃ | Br | C1 |
| T-1163 | CF₃ | Br | C2 |
| T-1164 | CF₃ | Br | C3 |
| T-1165 | CF₃ | Br | C4 |
| T-1166 | CF₃ | Br | C5 |
| T-1167 | CF₃ | Br | C6 |
| T-1168 | CF₃ | Br | C7 |
| T-1169 | CF₃ | Br | C8 |
| T-1170 | CF₃ | Br | C9 |
| T-1171 | CF₃ | Br | C10 |
| T-1172 | CF₃ | Br | C11 |
| T-1173 | CF₃ | Br | C12 |
| T-1174 | CF₃ | Br | C13 |
| T-1175 | CF₃ | Br | C14 |
| T-1176 | CF₃ | Br | C15 |
| T-1177 | CF₃ | CF₃ | CH₃ |
| T-1178 | CF₃ | CF₃ | C₂H₅ |
| T-1179 | CF₃ | CF₃ | CH₂CF₃ |
| T-1180 | CF₃ | CF₃ | CH₂CH₂CF₃ |
| T-1181 | CF₃ | CF₃ | CH₂CH₂CH₃ |
| T-1182 | CF₃ | CF₃ | CH₂OCH₃ |
| T-1183 | CF₃ | CF₃ | CH₂OC₂H₅ |
| T-1184 | CF₃ | CF₃ | CH₂OCF₃ |
| T-1185 | CF₃ | CF₃ | CH₂OCH₂CF₃ |
| T-1186 | CF₃ | CF₃ | CH₂S(O)CH₃ |
| T-1187 | CF₃ | CF₃ | CH₂S(O)C₂H₅ |
| T-1188 | CF₃ | CF₃ | CH₂S(O)₂CH₃ |
| T-1189 | CF₃ | CF₃ | CH₂S(O)₂C₂H₅ |
| T-1190 | CF₃ | CF₃ | CH₂SCH₃ |
| T-1191 | CF₃ | CF₃ | CH₂SC₂H₅ |
| T-1192 | CF₃ | CF₃ | CH₂CH(CH₃)₂ |
| T-1193 | CF₃ | CF₃ | C(CH₃)₂OH |
| T-1194 | CF₃ | CF₃ | C(CH₃)₃ |
| T-1195 | CF₃ | CF₃ | CH(CH₃)₂ |
| T-1196 | CF₃ | CF₃ | CH₂OH |
| T-1197 | CF₃ | CF₃ | CH(CH₃)CH₂OH |
| T-1198 | CF₃ | CF₃ | CH₂CH(CH₃)OH |
| T-1199 | CF₃ | CF₃ | CH₂—C10 |
| T-1200 | CF₃ | CF₃ | CH₂—C11 |
| T-1201 | CF₃ | CF₃ | CH₂SCF₃ |
| T-1202 | CF₃ | CF₃ | CH₂S(O)CF₃ |
| T-1203 | CF₃ | CF₃ | CH₂S(O)₂CF₃ |
| T-1204 | CF₃ | CF₃ | C1 |
| T-1205 | CF₃ | CF₃ | C2 |
| T-1206 | CF₃ | CF₃ | C3 |
| T-1207 | CF₃ | CF₃ | C4 |
| T-1208 | CF₃ | CF₃ | C5 |
| T-1209 | CF₃ | CF₃ | C6 |
| T-1210 | CF₃ | CF₃ | C7 |
| T-1211 | CF₃ | CF₃ | C8 |
| T-1212 | CF₃ | CF₃ | C9 |
| T-1213 | CF₃ | CF₃ | C10 |
| T-1214 | CF₃ | CF₃ | C11 |
| T-1215 | CF₃ | CF₃ | C12 |
| T-1216 | CF₃ | CF₃ | C13 |
| T-1217 | CF₃ | CF₃ | C14 |
| T-1218 | CF₃ | CF₃ | C15 |
| T-1219 | CF₃ | OCF₃ | CH₃ |
| T-1220 | CF₃ | OCF₃ | C₂H₅ |
| T-1221 | CF₃ | OCF₃ | CH₂CF₃ |
| T-1222 | CF₃ | OCF₃ | CH₂CH₂CF₃ |
| T-1223 | CF₃ | OCF₃ | CH₂CH₂CH₃ |
| T-1224 | CF₃ | OCF₃ | CH₂OCH₃ |
| T-1225 | CF₃ | OCF₃ | CH₂OC₂H₅ |
| T-1226 | CF₃ | OCF₃ | CH₂OCF₃ |
| T-1227 | CF₃ | OCF₃ | CH₂OCH₂CF₃ |
| T-1228 | CF₃ | OCF₃ | CH₂S(O)CH₃ |
| T-1229 | CF₃ | OCF₃ | CH₂S(O)C₂H₅ |
| T-1230 | CF₃ | OCF₃ | CH₂S(O)₂CH₃ |
| T-1231 | CF₃ | OCF₃ | CH₂S(O)₂C₂H₅ |
| T-1232 | CF₃ | OCF₃ | CH₂SCH₃ |
| T-1233 | CF₃ | OCF₃ | CH₂SC₂H₅ |
| T-1234 | CF₃ | OCF₃ | CH₂CH(CH₃)₂ |
| T-1235 | CF₃ | OCF₃ | C(CH₃)₂OH |
| T-1236 | CF₃ | OCF₃ | C(CH₃)₃ |
| T-1237 | CF₃ | OCF₃ | CH(CH₃)₂ |
| T-1238 | CF₃ | OCF₃ | CH₂OH |
| T-1239 | CF₃ | OCF₃ | CH(CH₃)CH₂OH |
| T-1240 | CF₃ | OCF₃ | CH₂CH(CH₃)OH |
| T-1241 | CF₃ | OCF₃ | CH₂—C10 |
| T-1242 | CF₃ | OCF₃ | CH₂—C11 |
| T-1243 | CF₃ | OCF₃ | CH₂SCF₃ |
| T-1244 | CF₃ | OCF₃ | CH₂S(O)CF₃ |
| T-1245 | CF₃ | OCF₃ | CH₂S(O)₂CF₃ |
| T-1246 | CF₃ | OCF₃ | C1 |
| T-1247 | CF₃ | OCF₃ | C2 |
| T-1248 | CF₃ | OCF₃ | C3 |
| T-1249 | CF₃ | OCF₃ | C4 |
| T-1250 | CF₃ | OCF₃ | C5 |
| T-1251 | CF₃ | OCF₃ | C6 |
| T-1252 | CF₃ | OCF₃ | C7 |
| T-1253 | CF₃ | OCF₃ | C8 |
| T-1254 | CF₃ | OCF₃ | C9 |
| T-1255 | CF₃ | OCF₃ | C10 |
| T-1256 | CF₃ | OCF₃ | C11 |
| T-1257 | CF₃ | OCF₃ | C12 |
| T-1258 | CF₃ | OCF₃ | C13 |
| T-1259 | CF₃ | OCF₃ | C14 |
| T-1260 | CF₃ | OCF₃ | C15 |
| T-1261 | OCF₃ | H | CH₃ |
| T-1262 | OCF₃ | H | C₂H₅ |
| T-1263 | OCF₃ | H | CH₂CF₃ |
| T-1264 | OCF₃ | H | CH₂CH₂CF₃ |
| T-1265 | OCF₃ | H | CH₂CH₂CH₃ |
| T-1266 | OCF₃ | H | CH₂OCH₃ |
| T-1267 | OCF₃ | H | CH₂OC₂H₅ |
| T-1268 | OCF₃ | H | CH₂OCF₃ |
| T-1269 | OCF₃ | H | CH₂OCH₂CF₃ |
| T-1270 | OCF₃ | H | CH₂S(O)CH₃ |
| T-1271 | OCF₃ | H | CH₂S(O)C₂H₅ |
| T-1272 | OCF₃ | H | CH₂S(O)₂CH₃ |
| T-1273 | OCF₃ | H | CH₂S(O)₂C₂H₅ |
| T-1274 | OCF₃ | H | CH₂SCH₃ |
| T-1275 | OCF₃ | H | CH₂SC₂H₅ |
| T-1276 | OCF₃ | H | CH₂CH(CH₃)₂ |
| T-1277 | OCF₃ | H | C(CH₃)₂OH |
| T-1278 | OCF₃ | H | C(CH₃)₃ |
| T-1279 | OCF₃ | H | CH(CH₃)₂ |
| T-1280 | OCF₃ | H | CH₂OH |
| T-1281 | OCF₃ | H | CH(CH₃)CH₂OH |
| T-1282 | OCF₃ | H | CH₂CH(CH₃)OH |
| T-1283 | OCF₃ | H | CH₂—C10 |
| T-1284 | OCF₃ | H | CH₂—C11 |
| T-1285 | OCF₃ | H | CH₂SCF₃ |
| T-1286 | OCF₃ | H | CH₂S(O)CF₃ |
| T-1287 | OCF₃ | H | CH₂S(O)₂CF₃ |
| T-1288 | OCF₃ | H | C1 |
| T-1289 | OCF₃ | H | C2 |
| T-1290 | OCF₃ | H | C3 |
| T-1291 | OCF₃ | H | C4 |
| T-1292 | OCF₃ | H | C5 |
| T-1293 | OCF₃ | H | C6 |
| T-1294 | OCF₃ | H | C7 |
| T-1295 | OCF₃ | H | C8 |
| T-1296 | OCF₃ | H | C9 |
| T-1297 | OCF₃ | H | C10 |
| T-1298 | OCF₃ | H | C11 |
| T-1299 | OCF₃ | H | C12 |
| T-1300 | OCF₃ | H | C13 |
| T-1301 | OCF₃ | H | C14 |
| T-1302 | OCF₃ | H | C15 |
| T-1303 | OCF₃ | F | CH₃ |
| T-1304 | OCF₃ | F | C₂H₅ |
| T-1305 | OCF₃ | F | CH₂CF₃ |
| T-1306 | OCF₃ | F | CH₂CH₂CF₃ |
| T-1307 | OCF₃ | F | CH₂CH₂CH₃ |
| T-1308 | OCF₃ | F | CH₂OCH₃ |
| T-1309 | OCF₃ | F | CH₂OC₂H₅ |
| T-1310 | OCF₃ | F | CH₂OCF₃ |
| T-1311 | OCF₃ | F | CH₂OCH₂CF₃ |
| T-1312 | OCF₃ | F | CH₂S(O)CH₃ |
| T-1313 | OCF₃ | F | CH₂S(O)C₂H₅ |
| T-1314 | OCF₃ | F | CH₂S(O)₂CH₃ |
| T-1315 | OCF₃ | F | CH₂S(O)₂C₂H₅ |
| T-1316 | OCF₃ | F | CH₂SCH₃ |
| T-1317 | OCF₃ | F | CH₂SC₂H₅ |
| T-1318 | OCF₃ | F | CH₂CH(CH₃)₂ |
| T-1319 | OCF₃ | F | C(CH₃)₂OH |
| T-1320 | OCF₃ | F | C(CH₃)₃ |
| T-1321 | OCF₃ | F | CH(CH₃)₂ |
| T-1322 | OCF₃ | F | CH₂OH |
| T-1323 | OCF₃ | F | CH(CH₃)CH₂OH |
| T-1324 | OCF₃ | F | CH₂CH(CH₃)OH |
| T-1325 | OCF₃ | F | CH₂—C10 |
| T-1326 | OCF₃ | F | CH₂—C11 |
| T-1327 | OCF₃ | F | CH₂SCF₃ |
| T-1328 | OCF₃ | F | CH₂S(O)CF₃ |
| T-1329 | OCF₃ | F | CH₂S(O)₂CF₃ |
| T-1330 | OCF₃ | F | C1 |
| T-1331 | OCF₃ | F | C2 |
| T-1332 | OCF₃ | F | C3 |
| T-1333 | OCF₃ | F | C4 |
| T-1334 | OCF₃ | F | C5 |
| T-1335 | OCF₃ | F | C6 |
| T-1336 | OCF₃ | F | C7 |
| T-1337 | OCF₃ | F | C8 |
| T-1338 | OCF₃ | F | C9 |
| T-1339 | OCF₃ | F | C10 |
| T-1340 | OCF₃ | F | C11 |
| T-1341 | OCF₃ | F | C12 |
| T-1342 | OCF₃ | F | C13 |
| T-1343 | OCF₃ | F | C14 |
| T-1344 | OCF₃ | F | C15 |
| T-1345 | OCF₃ | Cl | CH₃ |
| T-1346 | OCF₃ | Cl | C₂H₅ |
| T-1347 | OCF₃ | Cl | CH₂CF₃ |
| T-1348 | OCF₃ | Cl | CH₂CH₂CF₃ |
| T-1349 | OCF₃ | Cl | CH₂CH₂CH₃ |
| T-1350 | OCF₃ | Cl | CH₂OCH₃ |
| T-1351 | OCF₃ | Cl | CH₂OC₂H₅ |
| T-1352 | OCF₃ | Cl | CH₂OCF₃ |
| T-1353 | OCF₃ | Cl | CH₂OCH₂CF₃ |
| T-1354 | OCF₃ | Cl | CH₂S(O)CH₃ |
| T-1355 | OCF₃ | Cl | CH₂S(O)C₂H₅ |
| T-1356 | OCF₃ | Cl | CH₂S(O)₂CH₃ |
| T-1357 | OCF₃ | Cl | CH₂S(O)₂C₂H₅ |
| T-1358 | OCF₃ | Cl | CH₂SCH₃ |
| T-1359 | OCF₃ | Cl | CH₂SC₂H₅ |
| T-1360 | OCF₃ | Cl | CH₂CH(CH₃)₂ |
| T-1361 | OCF₃ | Cl | C(CH₃)₂OH |
| T-1362 | OCF₃ | Cl | C(CH₃)₃ |
| T-1363 | OCF₃ | Cl | CH(CH₃)₂ |
| T-1364 | OCF₃ | Cl | CH₂OH |
| T-1365 | OCF₃ | Cl | CH(CH₃)CH₂OH |
| T-1366 | OCF₃ | Cl | CH₂CH(CH₃)OH |
| T-1367 | OCF₃ | Cl | CH₂—C10 |
| T-1368 | OCF₃ | Cl | CH₂—C11 |
| T-1369 | OCF₃ | Cl | CH₂SCF₃ |
| T-1370 | OCF₃ | Cl | CH₂S(O)CF₃ |
| T-1371 | OCF₃ | Cl | CH₂S(O)₂CF₃ |
| T-1372 | OCF₃ | Cl | C1 |
| T-1373 | OCF₃ | Cl | C2 |
| T-1374 | OCF₃ | Cl | C3 |
| T-1375 | OCF₃ | Cl | C4 |
| T-1376 | OCF₃ | Cl | C5 |
| T-1377 | OCF₃ | Cl | C6 |
| T-1378 | OCF₃ | Cl | C7 |
| T-1379 | OCF₃ | Cl | C8 |
| T-1380 | OCF₃ | Cl | C9 |
| T-1381 | OCF₃ | Cl | C10 |
| T-1382 | OCF₃ | Cl | C11 |
| T-1383 | OCF₃ | Cl | C12 |
| T-1384 | OCF₃ | Cl | C13 |
| T-1385 | OCF₃ | Cl | C14 |
| T-1386 | OCF₃ | Cl | C15 |
| T-1387 | OCF₃ | Br | CH₃ |
| T-1388 | OCF₃ | Br | C₂H₅ |
| T-1389 | OCF₃ | Br | CH₂CF |
| T-1390 | OCF₃ | Br | CH₂CH₂CF₃ |
| T-1391 | OCF₃ | Br | CH₂CH₂CH₃ |
| T-1392 | OCF₃ | Br | CH₂OCH₃ |
| T-1393 | OCF₃ | Br | CH₂OC₂H₅ |
| T-1394 | OCF₃ | Br | CH₂OCF₃ |
| T-1395 | OCF₃ | Br | CH₂OCH₂CF₃ |
| T-1396 | OCF₃ | Br | CH₂S(O)CH₃ |
| T-1397 | OCF₃ | Br | CH₂S(O)C₂H₅ |
| T-1398 | OCF₃ | Br | CH₂S(O)₂CH₃ |
| T-1399 | OCF₃ | Br | CH₂S(O)₂C₂H₅ |
| T-1400 | OCF₃ | Br | CH₂SCH₃ |
| T-1401 | OCF₃ | Br | CH₂SC₂H₅ |
| T-1402 | OCF₃ | Br | CH₂CH(CH₃)₂ |
| T-1403 | OCF₃ | Br | C(CH₃)₂OH |
| T-1404 | OCF₃ | Br | C(CH₃)₃ |
| T-1405 | OCF₃ | Br | CH(CH₃)₂ |
| T-1406 | OCF₃ | Br | CH₂OH |
| T-1407 | OCF₃ | Br | CH(CH₃)CH₂OH |
| T-1408 | OCF₃ | Br | CH₂CH(CH₃)OH |
| T-1409 | OCF₃ | Br | CH₂—C10 |
| T-1410 | OCF₃ | Br | CH₂—C11 |
| T-1411 | OCF₃ | Br | CH₂SCF₃ |
| T-1412 | OCF₃ | Br | CH₂S(O)CF₃ |
| T-1413 | OCF₃ | Br | CH₂S(O)₂CF₃ |
| T-1414 | OCF₃ | Br | C1 |
| T-1415 | OCF₃ | Br | C2 |
| T-1416 | OCF₃ | Br | C3 |
| T-1417 | OCF₃ | Br | C4 |
| T-1418 | OCF₃ | Br | C5 |
| T-1419 | OCF₃ | Br | C6 |
| T-1420 | OCF₃ | Br | C7 |
| T-1421 | OCF₃ | Br | C8 |
| T-1422 | OCF₃ | Br | C9 |
| T-1423 | OCF₃ | Br | C10 |
| T-1424 | OCF₃ | Br | C11 |
| T-1425 | OCF₃ | Br | C12 |
| T-1426 | OCF₃ | Br | C13 |
| T-1427 | OCF₃ | Br | C14 |
| T-1428 | OCF₃ | Br | C15 |
| T-1429 | OCF₃ | CF₃ | CH₃ |
| T-1430 | OCF₃ | CF₃ | C₂H₅ |
| T-1431 | OCF₃ | CF₃ | CH₂CF₃ |
| T-1432 | OCF₃ | CF₃ | CH₂CH₂CF₃ |
| T-1433 | OCF₃ | CF₃ | CH₂CH₂CH₃ |
| T-1434 | OCF₃ | CF₃ | CH₂OCH₃ |
| T-1435 | OCF₃ | CF₃ | CH₂OC₂H₅ |
| T-1436 | OCF₃ | CF₃ | CH₂OCF₃ |
| T-1437 | OCF₃ | CF₃ | CH₂OCH₂CF₃ |
| T-1438 | OCF₃ | CF₃ | CH₂S(O)CH₃ |
| T-1439 | OCF₃ | CF₃ | CH₂S(O)C₂H₅ |
| T-1440 | OCF₃ | CF₃ | CH₂S(O)₂CH₃ |
| T-1441 | OCF₃ | CF₃ | CH₂S(O)₂C₂H₅ |
| T-1442 | OCF₃ | CF₃ | CH₂SCH₃ |
| T-1443 | OCF₃ | CF₃ | CH₂SC₂H₅ |
| T-1444 | OCF₃ | CF₃ | CH₂CH(CH₃)₂ |
| T-1445 | OCF₃ | CF₃ | C(CH₃)₂OH |
| T-1446 | OCF₃ | CF₃ | C(CH₃)₃ |
| T-1447 | OCF₃ | CF₃ | CH(CH₃)₂ |
| T-1448 | OCF₃ | CF₃ | CH₂OH |
| T-1449 | OCF₃ | CF₃ | CH(CH₃)CH₂OH |
| T-1450 | OCF₃ | CF₃ | CH₂CH(CH₃)OH |
| T-1451 | OCF₃ | CF₃ | CH₂—C10 |
| T-1452 | OCF₃ | CF₃ | CH₂—C11 |
| T-1453 | OCF₃ | CF₃ | CH₂SCF₃ |
| T-1454 | OCF₃ | CF₃ | CH₂S(O)CF₃ |
| T-1455 | OCF₃ | CF₃ | CH₂S(O)₂CF₃ |
| T-1456 | OCF₃ | CF₃ | C1 |
| T-1457 | OCF₃ | CF₃ | C2 |
| T-1458 | OCF₃ | CF₃ | C3 |
| T-1459 | OCF₃ | CF₃ | C4 |
| T-1460 | OCF₃ | CF₃ | C5 |
| T-1461 | OCF₃ | CF₃ | C6 |
| T-1462 | OCF₃ | CF₃ | C7 |
| T-1463 | OCF₃ | CF₃ | C8 |
| T-1464 | OCF₃ | CF₃ | C9 |
| T-1465 | OCF₃ | CF₃ | C10 |
| T-1466 | OCF₃ | CF₃ | C11 |
| T-1467 | OCF₃ | CF₃ | C12 |
| T-1468 | OCF₃ | CF₃ | C13 |
| T-1469 | OCF₃ | CF₃ | C14 |
| T-1470 | OCF₃ | CF₃ | C15 |
| T-1471 | OCF₃ | OCF₃ | CH₃ |
| T-1472 | OCF₃ | OCF₃ | C₂H₅ |
| T-1473 | OCF₃ | OCF₃ | CH₂CF₃ |
| T-1474 | OCF₃ | OCF₃ | CH₂CH₂CF₃ |
| T-1475 | OCF₃ | OCF₃ | CH₂CH₂CH₃ |
| T-1476 | OCF₃ | OCF₃ | CH₂OCH₃ |
| T-1477 | OCF₃ | OCF₃ | CH₂OC₂H₅ |
| T-1478 | OCF₃ | OCF₃ | CH₂OCF₃ |
| T-1479 | OCF₃ | OCF₃ | CH₂OCH₂CF₃ |
| T-1480 | OCF₃ | OCF₃ | CH₂S(O)CH₃ |
| T-1481 | OCF₃ | OCF₃ | CH₂S(O)C₂H₅ |
| T-1482 | OCF₃ | OCF₃ | CH₂S(O)₂CH₃ |
| T-1483 | OCF₃ | OCF₃ | CH₂S(O)₂C₂H₅ |
| T-1484 | OCF₃ | OCF₃ | CH₂SCH₃ |
| T-1485 | OCF₃ | OCF₃ | CH₂SC₂H₅ |
| T-1486 | OCF₃ | OCF₃ | CH₂CH(CH₃)₂ |
| T-1487 | OCF₃ | OCF₃ | C(CH₃)₂OH |
| T-1488 | OCF₃ | OCF₃ | C(CH₃)₃ |
| T-1489 | OCF₃ | OCF₃ | CH(CH₃)₂ |
| T-1490 | OCF₃ | OCF₃ | CH₂OH |
| T-1491 | OCF₃ | OCF₃ | CH(CH₃)CH₂OH |
| T-1492 | OCF₃ | OCF₃ | CH₂CH(CH₃)OH |
| T-1493 | OCF₃ | OCF₃ | CH₂—C10 |
| T-1494 | OCF₃ | OCF₃ | CH₂—C11 |
| T-1495 | OCF₃ | OCF₃ | CH₂SCF₃ |
| T-1496 | OCF₃ | OCF₃ | CH₂S(O)CF₃ |
| T-1497 | OCF₃ | OCF₃ | CH₂S(O)₂CF₃ |
| T-1498 | OCF₃ | OCF₃ | C1 |
| T-1499 | OCF₃ | OCF₃ | C2 |
| T-1500 | OCF₃ | OCF₃ | C3 |
| T-1501 | OCF₃ | OCF₃ | C4 |
| T-1502 | OCF₃ | OCF₃ | C5 |
| T-1503 | OCF₃ | OCF₃ | C6 |
| T-1504 | OCF₃ | OCF₃ | C7 |
| T-1505 | OCF₃ | OCF₃ | C8 |
| T-1506 | OCF₃ | OCF₃ | C9 |
| T-1507 | OCF₃ | OCF₃ | C10 |
| T-1508 | OCF₃ | OCF₃ | C11 |
| T-1509 | OCF₃ | OCF₃ | C12 |
| T-1510 | OCF₃ | OCF₃ | C13 |
| T-1511 | OCF₃ | OCF₃ | C14 |
| T-1512 | OCF₃ | OCF₃ | C15 |

The invention also relates to agrochemical compositions comprising an auxiliary and at least one compound of the invention or a mixture thereof.

An agrochemical composition comprises a pesticidally effective amount of a compound of the invention or a mixture thereof. The term “pesticidally effective amount” is defined below.

The compounds of formula I or the mixtures thereof can be converted into customary types of agro-chemical compositions, e. g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Mono-graph No. 2, 6th Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Examples for suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclo-hexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharide powders, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylaryl-sulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylhnaphthalenes, sulfosuccinates or sulfosuccinamates. Examples of sulfates are sulfates of fatty acids and oils, of ethoxylated alkylphenols, of alcohols, of ethox-ylated alcohols, or of fatty acid esters. Examples of phosphates are phosphate esters. Exam-ples of carboxylates are alkyl carboxylates, and carboxylated alcohol or alkylphenol eth-oxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B—C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compounds of formula I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for composition types and their preparation are:

i) Water-Soluble Concentrates (SL, LS)

10-60 wt % of a compound I according to the invention and 5-15 wt % wetting agent (e.g. alcohol alkoxylates) are dissolved in water and/or in a water-soluble solvent (e.g. alcohols) up to 100 wt %. The active substance dissolves upon dilution with water.

ii) Dispersible Concentrates (DC)

5-25 wt % of a compound I according to the invention and 1-10 wt % dispersant (e. g. polyvinylpyrrolidone) are dissolved in up to 100 wt % organic solvent (e.g. cyclohexanone). Dilution with water gives a dispersion.

iii) Emulsifiable Concentrates (EC)

15-70 wt % of a compound I according to the invention and 5-10 wt % emulsifiers (e.g. calcium dodecylbenzenesulfonate and castor oil ethoxylate) are dissolved in up to 100 wt % water-insoluble organic solvent (e.g. aromatic hydrocarbon). Dilution with water gives an emulsion.

iv) Emulsions (EW, EO, ES)

5-40 wt % of a compound I according to the invention and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into up to 100 wt % water by means of an emulsifying machine and made into a homogeneous emulsion. Dilution with water gives an emulsion.

v) Suspensions (SC, OD, FS)

In an agitated ball mill, 20-60 wt % of a compound I according to the invention are comminuted with addition of 2-10 wt % dispersants and wetting agents (e.g. sodium lignosulfonate and alcohol ethoxylate), 0.1-2 wt % thickener (e.g. xanthan gum) and up to 100 wt % water to give a fine active substance suspension. Dilution with water gives a stable suspension of the active substance. For FS type composition up to 40 wt % binder (e.g. polyvinylalcohol) is added.

vi) Water-Dispersible Granules and Water-Soluble Granules (WG, SG)

50-80 wt % of a compound I according to the invention are ground finely with addition of up to 100 wt % dispersants and wetting agents (e.g. sodium lignosulfonate and alcohol ethoxylate) and prepared as water-dispersible or water-soluble granules by means of technical appliances (e. g. extrusion, spray tower, fluidized bed). Dilution with water gives a stable dispersion or solution of the active substance.

vii) Water-Dispersible Powders and Water-Soluble Powders (WP, SP, WS)

50-80 wt % of a compound I according to the invention are ground in a rotor-stator mill with addition of 1-5 wt % dispersants (e.g. sodium lignosulfonate), 1-3 wt % wetting agents (e.g. alcohol ethoxylate) and up to 100 wt % solid carrier, e.g. silica gel. Dilution with water gives a stable dispersion or solution of the active substance.

viii) Gel (GW, GF)

In an agitated ball mill, 5-25 wt % of a compound I according to the invention are comminuted with addition of 3-10 wt % dispersants (e.g. sodium lignosulfonate), 1-5 wt % thickener (e.g. carboxymethylcellulose) and up to 100 wt % water to give a fine suspension of the active substance. Dilution with water gives a stable suspension of the active substance.

ix) Microemulsion (ME)

5-20 wt % of a compound I according to the invention are added to 5-30 wt % organic solvent blend (e.g. fatty acid dimethylamide and cyclohexanone), 10-25 wt % surfactant blend (e.g. alkohol ethoxylate and arylphenol ethoxylate), and water up to 100%. This mixture is stirred for 1 h to produce spontaneously a thermodynamically stable microemulsion.

x) Microcapsules (CS)

An oil phase comprising 5-50 wt % of a compound I according to the invention, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radi-cal initiator results in the formation of poly(meth)acrylate microcapsules. Alternatively, an oil phase comprising 5-50 wt % of a compound I according to the invention, 0-40 wt % water insolu-ble organic solvent (e.g. aromatic hydrocarbon), and an isocyanate monomer (e.g. diphenylme-thene-4,4′-diisocyanatae) are dispersed into an aqueous solution of a protective colloid (e.g. polyvinyl alcohol). The addition of a polyamine (e.g. hexamethylenediamine) results in the for-mation of a polyurea microcapsule. The monomers amount to 1-10 wt %. The wt % relate to the total CS composition.

xi) Dustable Powders (DP, DS)

1-10 wt % of a compound I according to the invention are ground finely and mixed intimately with up to 100 wt % solid carrier, e.g. finely divided kaolin.

xii) Granules (GR, FG)

0.5-30 wt % of a compound I according to the invention is ground finely and associated with up to 100 wt % solid carrier (e.g. silicate). Granulation is achieved by extrusion, spray-drying or the fluidized bed.

xiii) Ultra-Low Volume Liquids (UL)

1-50 wt % of a compound I according to the invention are dissolved in up to 100 wt % organic solvent, e.g. aromatic hydrocarbon.

The compositions types i) to xi) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally comprise between 0.01 and 95%, preferably between 0.1 and 90%, and most preferably between 0.5 and 75%, by weight of active sub-stance. The active substances are employed in a purity of from 90% to 100%, preferably from 95% to 100% (according to NMR spectrum).

Various types of oils, wetters, adjuvants, fertilizer, or micronutrients, and other pesticides (e.g. herbicides, insecticides, fungicides, growth regulators, safeners) may be added to the active substances or the compositions com-prising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage de-vice, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components, e. g. components comprising compounds of the invention and/or mixing partners as defined above, may be mixed by the user in a spray tank and further auxiliaries and additives may be added, if appropriate.

In a further embodiment, either individual components of the composition according to the invention or partially premixed components, e. g. components comprising compounds of the invention and/or mixing partners as defined above, can be applied jointly (e.g. after tank mix) or consecutively.

The compounds of formula I are suitable for use in protecting crops, plants, plant propagation materials, such as seeds, or soil or water, in which the plants are growing, from attack or infestation by animal pests. Therefore, the invention also relates to a plant protection method, which comprises contacting crops, plants, plant propagation materials, such as seeds, or soil or water, in which the plants are growing, to be protected from attack or infestation by animal pests, with a pesticidally effective amount of a compound of the invention.

The compounds of formula I are also suitable for use in combating or controlling animal pests. Therefore, the invention also relates to a method of combating or controlling animal pests, which comprises contacting the animal pests, their habitat, breeding ground, or food supply, or the crops, plants, plant propagation materials, such as seeds, or soil, or the area, material or environment in which the animal pests are growing or may grow, with a pesticidally effective amount of a compound of the invention.

The compounds of formula I are effective through both contact and ingestion. Furthermore, the compounds of formula I can be applied to any and all developmental stages, such as egg, larva, pupa, and adult.

The compounds of formula I can be applied as such or in form of compositions comprising them as defined above. Furthermore, the compounds of formula I can be applied together with a mixing partner as defined above or in form of compositions comprising said mixtures as defined above. The components of said mixture can be applied simultaneously, jointly or separately, or in succession, that is immediately one after another and thereby creating the mixture “in situ” on the desired location, e.g. the plant, the sequence, in the case of separate application, generally not having any effect on the result of the control measures.

The application can be carried out both before and after the infestation of the crops, plants, plant propagation materials, such as seeds, soil, or the area, material or environment by the pests.

Suitable application methods include inter alia soil treatment, seed treatment, in furrow application, and foliar application. Soil treatment methods include drenching the soil, drip irrigation (drip application onto the soil), dipping roots, tubers or bulbs, or soil injection. Seed treatment techniques include seed dressing, seed coating, seed dusting, seed soaking, and seed pelleting. In furrow applications typically include the steps of making a furrow in cultivated land, seeding the furrow with seeds, applying the pesticidally active compound to the furrow, and closing the furrow. Foliar application refers to the application of the pesticidally active compound to plant foliage, e.g. through spray equipment. For foliar applications, it can be advantageous to modify the behavior of the pests by use of pheromones in combination with The compounds of formula I. Suitable pheromones for specific crops and pests are known to a skilled person and publicly available from databases of pheromones and semiochemicals, such as http://www.pherobase.com.

As used herein, the term “contacting” includes both direct contact (applying the compounds/compositions directly on the animal pest or plant—typically to the foliage, stem or roots of the plant) and indirect contact (applying the compounds/compositions to the locus, i.e. habitat, breeding ground, plant, seed, soil, area, material or environment in which a pest is growing or may grow, of the animal pest or plant).

The term “crop” refers to both, growing and harvested crops.

The term “plant” includes cereals, e.g. durum and other wheat, rye, barley, triticale, oats, rice, or maize (fodder maize and sugar maize/sweet and field corn); beet, e.g. sugar beet or fodder beet; fruits, such as pomes, stone fruits or soft fruits, e.g. apples, pears, plums, peaches, nectarines, almonds, cherries, papayas, strawberries, raspberries, blackberries or gooseberries; leguminous plants, such as beans, lentils, peas, alfalfa or soybeans; oil plants, such as rapeseed (oilseed rape), turnip rape, mustard, olives, sunflowers, coconut, cocoa beans, castor oil plants, oil palms, ground nuts or soybeans; cucurbits, such as squashes, pumpkins, cucumber or melons; fiber plants, such as cotton, flax, hemp or jute; citrus fruit, such as oranges, lemons, grapefruits or mandarins; vegetables, such as eggplant, spinach, lettuce (e.g. iceberg lettuce), chicory, cabbage, asparagus, cabbages, carrots, onions, garlic, leeks, tomatoes, potatoes, cucurbits or sweet peppers; lauraceous plants, such as avocados, cinnamon or camphor; energy and raw material plants, such as corn, soybean, rapeseed, sugar cane or oil palm; tobacco; nuts, e.g. walnuts; pistachios; coffee; tea; bananas; vines (table grapes and grape juice grape vines); hop; sweet leaf (also called Stevia); natural rubber plants or ornamental and forestry plants, such as flowers (e.g. carnation, petunias, geranium/pelargoniums, pansies and impatiens), shrubs, broad-leaved trees (e.g. poplar) or evergreens, e.g. conifers; eucalyptus; turf; lawn; grass such as grass for animal feed or ornamental uses. Preferred plants include potatoes sugar beets, tobacco, wheat, rye, barley, oats, rice, corn, cotton, soybeans, rapeseed, legumes, sunflowers, coffee or sugar cane; fruits; vines; ornamentals; or vegetables, such as cucumbers, tomatoes, beans or squashes.

The term “plant” is to be understood as including wild type plants and plants, which have been modified by either conventional breeding, or mutagenesis or genetic engineering, or by a combination thereof.

Plants, which have been modified by mutagenesis or genetic engineering, and are of particular commercial importance, include alfalfa, rapeseed (e.g. oilseed rape), bean, carnation, chicory, cotton, eggplant, eucalyptus, flax, lentil, maize, melon, papaya, petunia, plum, poplar, potato, rice, soybean, squash, sugar beet, sugarcane, sunflower, sweet pepper, tobacco, tomato, and cereals (e.g. wheat), in particular maize, soybean, cotton, wheat, and rice. In plants, which have been modified by mutagenesis or genetic engineering, one or more genes have been mutagenized or integrated into the genetic material of the plant. The one or more mutagenized or integrated genes are preferably selected from pat, epsps, cry1Ab, bar, cry1Fa2, cry1Ac, cry34Ab1, cry35AB1, cry3A, cryF, cry1F, mcry3a, cry2Ab2, cry3Bb1, cry1A.105, dfr, barnase, vip3Aa20, barstar, als, bxn, bp40, asn1, and ppo5. The mutagenesis or integration of the one or more genes is performed in order to improve certain properties of the plant. Such properties, also known as traits, include abiotic stress tolerance, altered growth/yield, disease resistance, herbicide tolerance, insect resistance, modified product quality, and pollination control. Of these properties, herbicide tolerance, e.g. imidazolinone tolerance, glyphosate tolerance, or glufosinate tolerance, is of particular importance. Several plants have been rendered tolerant to herbicides by mutagenesis, for example Clearfield® oilseed rape being tolerant to imidazolinones, e.g. imazamox. Alternatively, genetic engineering methods have been used to render plants, such as soybean, cotton, corn, beets and oil seed rape, tolerant to herbicides, such as glyphosate and glufosinate, some of which are commercially available under the trade names RoundupReady® (glyphosate) and LibertyLink® (glufosinate). Furthermore, insect resistance is of importance, in particular lepidopteran insect resistance and coleopteran insect resistance. Insect resistance is typically achieved by modifying plants by integrating cry and/or vip genes, which were isolated from Bacillus thuringiensis (Bt), and code for the respective Bt toxins. Genetically modified plants with insect resistance are commercially available under trade names including WideStrike®, Bollgard®, Agrisure®, Herculex®, YieldGard®, Genuity®, and Intacta®.

Plants may be modified by mutagenesis or genetic engineering either in terms of one property (singular traits) or in terms of a combination of properties (stacked traits). Stacked traits, e.g. the combination of herbicide tolerance and insect resistance, are of increasing importance. In general, all relevant modified plants in connection with singular or stacked traits as well as detailed information as to the mutagenized or integrated genes and the respective events are available from websites of the organizations “International Service for the Acquisition of Agri-biotech Applications (ISAAA)” (http://www.isaaa.org/gmapprovaldatabase) and “Center for Environmental Risk Assessment (CERA)” (http://cera-gmc.org/GMCropDatabase).

It has surprisingly been found that the pesticidal activity of The compounds of formula I may be enhanced by the insecticidal trait of a modified plant. Furthermore, it has been found that The compounds of formula I are suitable for preventing insects to become resistant to the insecticidal trait or for combating pests, which already have become resistant to the insecticidal trait of a modified plant. Moreover, The compounds of formula I are suitable for combating pests, against which the insecticidal trait is not effective, so that a complementary insecticidal activity can advantageously be used.

The term “plant propagation material” refers to all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

The term “seed” embraces seeds and plant propagules of all kinds including but not limited to true seeds, seed pieces, suckers, corms, bulbs, fruit, tubers, grains, cuttings, cut shoots and the like, and means in a preferred embodiment true seeds.

In general, “pesticidally effective amount” means the amount of active ingredient needed to achieve an observable effect on growth, including the effects of necrosis, death, retardation, prevention, and removal, destruction, or otherwise diminishing the occurrence and activity of the target organism. The pesticidally effective amount can vary for the various compounds/compositions used in the invention. A pesticidally effective amount of the compositions will also vary according to the prevailing conditions such as desired pesticidal effect and duration, weather, target species, locus, mode of application, and the like.

In the case of soil treatment, in furrow application or of application to the pests dwelling place or nest, the quantity of active ingredient ranges from 0.0001 to 500 g per 100 m², preferably from 0.001 to 20 g per 100 m².

For use in treating crop plants, e.g. by foliar application, the rate of application of the active ingredients of this invention may be in the range of 0.0001 g to 4000 g per hectare, e.g. from 1 g to 2 kg per hectare or from 1 g to 750 g per hectare, desirably from 1 g to 100 g per hectare, more desirably from 10 g to 50 g per hectare, e.g., 10 to 20 g per hectare, 20 to 30 g per hectare, 30 to 40 g per hectare, or 40 to 50 g per hectare.

The compounds of formula I are particularly suitable for use in the treatment of seeds in order to protect the seeds from insect pests, in particular from soil-living insect pests, and the resulting seedling's roots and shoots against soil pests and foliar insects. The invention therefore also relates to a method for the protection of seeds from insects, in particular from soil insects, and of the seedling's roots and shoots from insects, in particular from soil and foliar insects, said method comprising treating the seeds before sowing and/or after pregermination with a compound of the invention. The protection of the seedling's roots and shoots is preferred. More preferred is the protection of seedling's shoots from piercing and sucking insects, chewing insects and nematodes.

The term “seed treatment” comprises all suitable seed treatment techniques known in the art, such as seed dressing, seed coating, seed dusting, seed soaking, seed pelleting, and in-furrow application methods. Preferably, the seed treatment application of the active compound is carried out by spraying or by dusting the seeds before sowing of the plants and before emergence of the plants.

The invention also comprises seeds coated with or containing the active compound. The term “coated with and/or containing” generally signifies that the active ingredient is for the most part on the surface of the propagation product at the time of application, although a greater or lesser part of the ingredient may penetrate into the propagation product, depending on the method of application. When the said propagation product is (re)planted, it may absorb the active ingredient.

Suitable seed is for example seed of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

In addition, the active compound may also be used for the treatment of seeds from plants, which have been modified by mutagenisis or genetic engineering, and which e.g. tolerate the action of herbicides or fungicides or insecticides. Such modified plants have been described in detail above.

Conventional seed treatment formulations include for example flowable concentrates FS, solutions LS, suspoemulsions (SE), powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter. Preferably, the formulations are applied such that germination is not included.

The active substance concentrations in ready-to-use formulations, which may be obtained after two-to-tenfold dilution, are preferably from 0.01 to 60% by weight, more preferably from 0.1 to 40% by weight.

In a preferred embodiment a FS formulation is used for seed treatment. Typically, a FS formulation may comprise 1-800 g/l of active ingredient, 1-200 g/I Surfactant, 0 to 200 g/I antifreezing agent, 0 to 400 g/l of binder, 0 to 200 g/l of a pigment and up to 1 liter of a solvent, preferably water.

Especially preferred FS formulations of The compounds of formula I for seed treatment usually comprise from 0.1 to 80% by weight (1 to 800 g/I) of the active ingredient, from 0.1 to 20% by weight (1 to 200 g/I) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker/adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

In the treatment of seed, the application rates of the compounds of the invention are generally from 0.1 g to 10 kg per 100 kg of seed, preferably from 1 g to 5 kg per 100 kg of seed, more preferably from 1 g to 1000 g per 100 kg of seed and in particular from 1 g to 200 g per 100 kg of seed, e.g. from 1 g to 100 g or from 5 g to 100 g per 100 kg of seed.

The invention therefore also relates to seed comprising a compound of the invention, or an agriculturally useful salt thereof, as defined herein. The amount of the compound of the invention or the agriculturally useful salt thereof will in general vary from 0.1 g to 10 kg per 100 kg of seed, preferably from 1 g to 5 kg per 100 kg of seed, in particular from 1 g to 1000 g per 100 kg of seed. For specific crops such as lettuce the rate can be higher.

The compounds of formula I may also be used for improving the health of a plant. Therefore, the invention also relates to a method for improving plant health by treating a plant, plant propagation material and/or the locus where the plant is growing or is to grow with an effective and non-phytotoxic amount of a compound of the invention.

As used herein “an effective and non-phytotoxic amount” means that the compound is used in a quantity which allows to obtain the desired effect but which does not give rise to any phytotoxic symptom on the treated plant or on the plant grown from the treated propagule or treated soil.

The terms “plant” and “plant propagation material” are defined above.

“Plant health” is defined as a condition of the plant and/or its products which is determined by several aspects alone or in combination with each other such as yield (for example increased biomass and/or increased content of valuable ingredients), quality (for example improved content or composition of certain ingredients or shelf life), plant vigour (for example improved plant growth and/or greener leaves (“greening effect”), tolerance to abiotic (for example drought) and/or biotic stress (for example disease) and production efficiency (for example, harvesting efficiency, processability).

The above identified indicators for the health condition of a plant may be interdependent and may result from each other. Each indicator is defined in the art and can be determined by methods known to a skilled person.

The compounds of the invention are also suitable for use against non-crop insect pests. For use against said non-crop pests, compounds of the invention can be used as bait composition, gel, general insect spray, aerosol, as ultra-low volume application and bed net (impregnated or surface applied). Furthermore, drenching and rodding methods can be used.

As used herein, the term “non-crop insect pest” refers to pests, which are particularly relevant for non-crop targets, such as ants, termites, wasps, flies, ticks, mosquitos, crickets, or cockroaches.

The bait can be a liquid, a solid or a semisolid preparation (e.g. a gel). The bait employed in the composition is a product, which is sufficiently attractive to incite insects such as ants, termites, wasps, flies, mosquitos, crickets etc. or cockroaches to eat it. The attractiveness can be manipulated by using feeding stimulants or sex pheromones. Food stimulants are chosen, for example, but not exclusively, from animal and/or plant proteins (meat-, fish- or blood meal, insect parts, egg yolk), from fats and oils of animal and/or plant origin, or mono-, oligo- or polyorganosaccharides, especially from sucrose, lactose, fructose, dextrose, glucose, starch, pectin or even molasses or honey. Fresh or decaying parts of fruits, crops, plants, animals, insects or specific parts thereof can also serve as a feeding stimulant. Sex pheromones are known to be more insect specific. Specific pheromones are described in the literature (e.g. http://www.pherobase.com), and are known to those skilled in the art.

For use in bait compositions, the typical content of active ingredient is from 0.001 weight % to 15 weight %, desirably from 0.001 weight % to 5% weight % of active compound.

Formulations of The compounds of formula I as aerosols (e.g in spray cans), oil sprays or pump sprays are highly suitable for the non-professional user for controlling pests such as flies, fleas, ticks, mosquitos or cockroaches. Aerosol recipes are preferably composed of the active compound, solvents, furthermore auxiliaries such as emulsifiers, perfume oils, if appropriate stabilizers, and, if required, propellants.

The oil spray formulations differ from the aerosol recipes in that no propellants are used.

For use in spray compositions, the content of active ingredient is from 0.001 to 80 weights %, preferably from 0.01 to 50 weight % and most preferably from 0.01 to 15 weight %.

The compounds of formula I and its respective compositions can also be used in mosquito and fumigating coils, smoke cartridges, vaporizer plates or long-term vaporizers and also in moth papers, moth pads or other heat-independent vaporizer systems.

Methods to control infectious diseases transmitted by insects (e.g. malaria, dengue and yellow fever, lymphatic filariasis, and leishmaniasis) with compounds of the invention and its respective compositions also comprise treating surfaces of huts and houses, air spraying and impregnation of curtains, tents, clothing items, bed nets, tsetse-fly trap or the like. Insecticidal compositions for application to fibers, fabric, knitgoods, nonwovens, netting material or foils and tarpaulins preferably comprise a mixture including the insecticide, optionally a repellent and at least one binder.

The compounds of formula I and its compositions can be used for protecting wooden materials such as trees, board fences, sleepers, frames, artistic artifacts, etc. and buildings, but also construction materials, furniture, leathers, fibers, vinyl articles, electric wires and cables etc. from ants and/or termites, and for controlling ants and termites from doing harm to crops or human being (e.g. when the pests invade into houses and public facilities).

Customary application rates in the protection of materials are, for example, from 0.001 g to 2000 g or from 0.01 g to 1000 g of active compound per m² treated material, desirably from 0.1 g to 50 g per m².

Insecticidal compositions for use in the impregnation of materials typically contain from 0.001 to 95 weight %, preferably from 0.1 to 45 weight %, and more preferably from 1 to 25 weight % of at least one repellent and/or insecticide.

The compounds of the the invention are especially suitable for efficiently combating animal pests such as arthropods, gastropods and nematodes including but not limited to:

insects from the order of Lepidoptera, for example Achroia grisella, Acleris spp. such as A. fimbriana, A. gloverana, A. variana; Acrolepiopsis assectella, Acronicta major, Adoxophyes spp. such as A. cyrtosema, A. orana; Aedia leucomelas, Agrotis spp. such as A. exclamationis, A. fucosa, A. ipsilon, A. orthogoma, A. segetum, A. subterranea; Alabama argillacea, Aleurodicus dispersus, Alsophila pometaria, Ampelophaga rubiginosa, Amyelois transitella, Anacampsis sarcitella, Anagasta kuehniella, Anarsia lineatella, Anisota senatoria, Antheraea pernyi, Anticarsia (=Thermesia) spp. such as A. gemmatalis; Apamea spp., Aproaerema modicella, Archips spp. such as A. argyrospila, A. fuscocupreanus, A. rosana, A. xyloseanus; Argyresthia conjugella, Argyroploce spp., Argyrotaenia spp. such as A. velutinana; Athetis mindara, Austroasca viridigrisea, Autographa gamma, Autographa nigrisigna, Barathra brassicae, Bedellia spp., Bonagota salubricola, Borbo cinnara, Bucculatrix thurberiella, Bupalus piniarius, Busseola spp., Cacoecia spp. such as C. murinana, C. podana; Cactoblastis cactorum, Cadra cautella, Calingo braziliensis, Caloptilis theivora, Capua reticulana, Carposina spp. such as C. niponensis, C. sasakii; Cephus spp., Chaetocnema aridula, Cheimatobia brumata, Chilo spp. such as C. Indicus, C. suppressalis, C. partellus; Choreutis pariana, Choristoneura spp. such as C. conflictana, C. fumiferana, C. longicellana, C. murinana, C. occidentalis, C. rosaceana; Chrysodeixis (=Pseudoplusia) spp. such as C. eriosoma, C. includens; Cirphis unipuncta, Clysia ambiguella, Cnaphalocerus spp., Cnaphalocrocis medinalis, Cnephasia spp., Cochylis hospes, Coleophora spp., Colias eurytheme, Conopomorpha spp., Conotrachelus spp., Copitarsia spp., Corcyra cephalonica, Crambus caliginosellus, Crambus teterrellus, Crocidosema (=Epinotia) aporema, Cydalima (=Diaphania) perspectalis, Cydia (=Carpocapsa) spp. such as C. pomonella, C. latiferreana; Dalaca noctuides, Datana integerrima, Dasychira pinicola, Dendrolimus spp. such as D. pini, D. spectabilis, D. sibiricus; Desmia funeralis, Diaphania spp. such as D. nitidalis, D. hyalinata; Diatraea grandiosella, Diatraea saccharalis, Diphthera festiva, Earias spp. such as E. insulana, E. vittella; Ecdytolopha aurantianu, Egira (=Xylomyges) curialis, Elasmopalpus lignosellus, Eldana saccharina, Endopiza viteana, Ennomos subsignaria, Eoreuma loftini, Ephestia spp. such as E. cautella, E. elutella, E. kuehniella; Epinotia aporema, Epiphyas postvittana, Erannis tiliaria, Erionota thrax, Etiella spp., Eulia spp., Eupoecilia ambiguella, Euproctis chrysorrhoea, Euxoa spp., Evetria bouliana, Faronta albilinea, Feltia spp. such as F. subterranean; Galleria mellonella, Gracillaria spp., Grapholita spp. such as G. funebrana, G. molesta, G. inopinata; Halysidota spp., Harrisina americana, Hedylepta spp., Helicoverpa spp. such as H. armigera (=Heliothis armigera), H. zea (=Heliothis zea); Heliothis spp. such as H. assulta, H. subflexa, H. virescens; Hellula spp. such as H. undalis, H. rogatalis; Helocoverpa gelotopoeon, Hemileuca oliviae, Herpetogramma licarsisalis, Hibernia defoliaria, Hofmannophila pseudospretella, Homoeosoma electellum, Homona magnanima, Hypena scabra, Hyphantria cunea, Hyponomeuta padella, Hyponomeuta malinellus, Kakivoria flavofasciata, Keiferia lycopersicella, Lambdina fiscellaria fiscellaria, Lambdina fiscellaria lugubrosa, Lamprosema indicata, Laspeyresia molesta, Leguminivora glycinivorella, Lerodea eufala, Leucinodes orbonalis, Leucoma salicis, Leucoptera spp. such as L. coffeella, L. scitella; Leuminivora lycinivorella, Lithocolletis blancardella, Lithophane antennata, Llattia octo (=Amyna axis), Lobesia botrana, Lophocampa spp., Loxagrotis albicosta, Loxostege spp. such as L. sticticalis, L. cereralis; Lymantria spp. such as L. dispar, L. monacha; Lyonetia clerkella, Lyonetia prunifoliella, Malacosoma spp. such as M. americanum, M. californicum, M. constrictum, M. neustria; Mamestra spp. such as M. brassicae, M. configurata; Mamstra brassicae, Manduca spp. such as M. quinquemaculata, M. sexta; Marasmia spp, Marmara spp., Maruca testulalis, Megalopyge lanata, Melanchra picta, Melanitis leda, Mocis spp. such as M. lapites, M. repanda; Mocis latipes, Monochroa fragariae, Mythimna separata, Nemapogon cloacella, Neoleucinodes elegantalis, Nepytia spp., Nymphula spp., Oiketicus spp., Omiodes indicata, Omphisa anastomosalis, Operophtera brumata, Orgyia pseudotsugata, Oria spp., Orthaga thyrisalis, Ostrinia spp. such as O. nubilalis; Oulema oryzae, Paleacrita vernata, Panolis flammea, Parnara spp., Papaipema nebris, Papilio cresphontes, Paramyelois transitella, Paranthrene regalis, Paysandisia archon, Pectinophora spp. such as P. gossypiella; Peridroma saucia, Perileucoptera spp., such as P. coffeella; Phalera bucephala, Phryganidia californica, Phthorimaea spp. such as P. operculella; Phyllocnistis citrella, Phyllonorycter spp. such as P. blancardella, P. crataegella, P. issikii, P. ringoniella; Pieris spp. such as P. brassicae, P. rapae, P. napi; Pilocrocis tripunctata, Plathypena scabra, Platynota spp. such as P. flavedana, P. idaeusalis, P. stultana; Platyptilia carduidactyla, Plebejus argus, Plodia interpunctella, Plusia spp, Plutella maculipennis, Plutella xylostella, Pontia protodica, Prays spp., Prodenia spp., Proxenus lepigone, Pseudaletia spp. such as P. sequax, P. unipuncta; Pyrausta nubilalis, Rachiplusia nu, Richia albicosta, Rhizobius ventralis, Rhyacionia frustrana, Sabulodes aegrotata, Schizura concinna, Schoenobius spp., Schreckensteinia festaliella, Scirpophaga spp. such as S. incertulas, S. innotata; Scotia segetum, Sesamia spp. such as S. inferens, Seudyra subflava, Sitotroga cerealella, Sparganothis pilleriana, Spilonota lechriaspis, S. ocellana, Spodoptera (=Lamphygma) spp. such as S. cosmoides, S. eridania, S. exigua, S. frugiperda, S. latisfascia, S. littoralis, S. litura, S. omithogalli; Stigmella spp., Stomopteryx subsecivella, Strymon bazochii, Sylepta derogata, Synanthedon spp. such as S. exitiosa, Tecia solanivora, Telehin licus, Thaumatopoea pityocampa, Thaumatotibia (=Cryptophlebia) leucotreta, Thaumetopoea pityocampa, Thecla spp., Theresimima ampelophaga, Thyrinteina spp, Tildenia inconspicuella, Tinea spp. such as T. cloacella, T. pellionella; Tineola bisselliella, Tortrix spp. such as T. viridana; Trichophaga tapetzella, Trichoplusia spp. such as T. ni; Tuta (=Scrobipalpula) absoluta, Udea spp. such as U. rubigalis, U. rubigalis; Virachola spp., Yponomeuta padella, and Zeiraphera canadensis;

insects from the order of Coleoptera, for example Acalymma vittatum, Acanthoscehdes obtectus, Adoretus spp., Agelastica alni, Agrilus spp. such as A. anxius, A. planipennis, A. sinuatus; Agriotes spp. such as A. fuscicollis, A. lineatus, A. obscurus; Alphitobius diaperinus, Amphimallus solstitialis, Anisandrus dispar, Anisoplia austriaca, Anobium punctatum, Anomala corpu lenta, Anomala rufocuprea, Anoplophora spp. such as A. glabripennis; Anthonomus spp. such as A. eugenii, A. grandis, A. pomorum; Anthrenus spp., Aphthona euphoridae, Apion spp., Apogonia spp., Athous haemorrhoidalis, Atomaria spp. such as A. linearis; Attagenus spp., Aulacophora femoralis, Blastophagus piniperda, Blitophaga undata, Bruchidius obtectus, Bruchus spp. such as B. lentis, B. pisorum, B. rufimanus; Byctiscus betulae, Callidiellum rufipenne, Callopistria floridensis, Callosobruchus chinensis, Cameraria ohridella, Cassida nebulosa, Cerotoma trifurcata, Cetonia aurata, Ceuthorhynchus spp. such as C. assimilis, C. napi; Chaetocnema tibialis, Cleonus mendicus, Conoderus spp. such as C. vespertinus; Conotrachelus nenuphar, Cosmopolites spp., Costelytra zealandica, Crioceris asparagi, Cryptolestes ferrugineus, Cryptorhynchus lapathi, Ctenicera spp. such as C. destructor; Curculio spp., Cylindrocopturus spp., Cyclocephala spp., Dactylispa balyi, Dectes texanus, Dermestes spp., Diabrotica spp. such as D. undecimpunctata, D. speciosa, D. longicornis, D. semipunctata, D. virgifera; Diaprepes abbreviates, Dichocrocis spp., Dicladispa armigera, Diloboderus abderus, Diocalandra frumenti (Diocalandra stigmaticollis), Enaphalodes rufulus, Epilachna spp. such as E. varivestis, E. vigintioctomaculata; Epitrix spp. such as E. hirtipennis, E. similaris; Eutheola humilis, Eutinobothrus brasiliensis, Faustinus cubae, Gibbium psylloides, Gnathocerus cornutus, Hellula undalis, Heteronychus arator, Hylamorpha elegans, Hylobius abietis, Hylotrupes bajulus, Hypera spp. such as H. brunneipennis, H. postica; Hypomeces squamosus, Hypothenemus spp., Ips typographus, Lachnosterna consanguinea, Lasioderma serricorne, Latheticus oryzae, Lathridius spp., Lema spp. such as L. bilineata, L. melanopus; Leptinotarsa spp. such as L. decemlineata; Leptispa pygmaea, Limonius californicus, Lissorhoptrus oryzophilus, Lixus spp., Luperodes spp., Lyctus spp. such as L. bruneus; Liogenys fuscus, Macrodactylus spp. such as M. subspinosus; Maladera matrida, Megaplatypus mutates, Megascelis spp., Melanotus communis, Meligethes spp. such as M. aeneus; Melolontha spp. such as M. hippocastani, M. melolontha; Metamasius hemipterus, Microtheca spp., Migdolus spp. such as M. fryanus, Monochamus spp. such as M. alternatus; Naupactus xanthographus, Niptus hololeucus, Oberia brevis, Oemona hirta, Oryctes rhinoceros, Oryzaephilus surinamensis, Oryzaphagus oryzae, Otiorrhynchus sulcatus, Otiorrhynchus ovatus, Otiorrhynchus sulcatus, Oulema melanopus, Oulema oryzae, Oxycetonia jucunda, Phaedon spp. such as P. brassicae, P. cochleariae; Phoracantha recurva, Phyllobius pyri, Phyllopertha horticola, Phyllophaga spp. such as P. helleri; Phyllotreta spp. such as P. chrysocephala, P. nemorum, P. striolata, P. vittula; Phyllopertha horticola, Popillia japonica, Premnotrypes spp., Psacothea hilaris, Psylliodes chrysocephala, Prostephanus truncates, Psylliodes spp., Ptinus spp., Pulga saltona, Rhizopertha dominica, Rhynchophorus spp. such as R. billineatus, R. ferrugineus, R. palmarum, R. phoenicis, R. vulneratus; Saperda candida, Scolytus schevyrewi, Scyphophorus acupunctatus, Sitona lineatus, Sitophilus spp. such as S. granaria, S. oryzae, S. zeamais; Sphenophorus spp. such as S. levis; Stegobium paniceum, Sternechus spp. such as S. subsignatus; Strophomorphus ctenotus, Symphyletes spp., Tanymecus spp., Tenebrio molitor, Tenebrioides mauretanicus, Tribolium spp. such as T. castaneum; Trogoderma spp., Tychius spp., Xylotrechus spp. such as X. pyrrhoderus; and, Zabrus spp. such as Z. tenebrioides;

insects from the order of Diptera for example Aedes spp. such as A. aegypti, A. albopictus, A. vexans; Anastrepha ludens, Anopheles spp. such as A. albimanus, A. crucians, A. freeborni, A. gambiae, A. leucosphyrus, A. maculipennis, A. minimus, A. quadrimaculatus, A. sinensis; Bactrocera invadens, Bibio hortulanus, Calliphora erythrocephala, Calliphora vicina, Ceratitis capitata, Chrysomyia spp. such as C. bezziana, C. hominivorax, C. macellaria; Chrysops atlanticus, Chrysops discalis, Chrysops silacea, Cochliomyia spp. such as C. hominivorax; Contarinia spp. such as C. sorghicola; Cordylobia anthropophaga, Culex spp. such as C. nigripalpus, C. pipiens, C. quinquefasciatus, C. tarsalis, C. tritaeniorhynchus; Culicoides furens, Culiseta inornata, Culiseta melanura, Cuterebra spp., Dacus cucurbitae, Dacus oleae, Dasineura brassicae, Dasineura oxycoccana, Delia spp. such as D. antique, D. coarctata, D. platura, D. radicum; Dermatobia hominis, Drosophila spp. such as D. suzukii, Fannia spp. such as F. canicularis; Gastraphilus spp. such as G. intestinalis; Geomyza tipunctata, Glossina spp. such as G. fuscipes, G. morsitans, G. palpalis, G. tachinoides; Haematobia irritans, Haplodiplosis equestris, Hippelates spp., Hylemyia spp. such as H. platura; Hypoderma spp. such as H. lineata; Hyppobosca spp., Hydrellia philippina, Leptoconops torrens, Liriomyza spp. such as L. sativae, L. trifolii; Lucilia spp. such as L. caprina, L. cuprina, L. sericata; Lycoria pectoralis, Mansonia titillanus, Mayetiola spp. such as M. destructor; Musca spp. such as M. autumnalis, M. domestica; Muscina stabulans, Oestrus spp. such as O. ovis; Opomyza florum, Oscinella spp. such as O. frit; Orseolia oryzae, Pegomya hysocyami, Phlebotomus argentipes, Phorbia spp. such as P. antiqua, P. brassicae, P. coarctata; Phytomyza gymnostoma, Prosimulium mixtum, Psila rosae, Psorophora columbiae, Psorophora discolor, Rhagoletis spp. such as R. cerasi, R. cingulate, R. indifferens, R. mendax, R. pomonella; Rivellia quadrifasciata, Sarcophaga spp. such as S. haemorrhoidalis; Simulium vittatum, Sitodiplosis mosellana, Stomoxys spp. such as S. calcitrans; Tabanus spp. such as T. atratus, T. bovinus, T. lineola, T. similis; Tannia spp., Thecodiplosis japonensis, Tipula oleracea, Tipula paludosa, and Wohlfahrtia spp;

insects from the order of Thysanoptera for example, Baliothrips biformis, Dichromothrips corbetti, Dichromothrips ssp., Echinothrips americanus, Enneothrips flavens, Frankliniella spp. such as F. fusca, F. occidentalis, F. tritici; Heliothrips spp., Hercinothrips femoralis, Kakothrips spp., Microcephalothrips abdominalis, Neohydatothrips samayunkur, Pezothrips kellyanus, Rhipiphorothrips cruentatus, Scirtothrips spp. such as S. citri, S. dorsalis, S. perseae; Stenchaetothrips spp, Taeniothrips cardamoni, Taeniothrips inconsequens, Thrips spp. such as T. imagines, T. hawaiiensis, T. oryzae, T. palmi, T. parvispinus, T. tabaci;

insects from the order of Hemiptera for example, Acizzia jamatonica, Acrosternum spp. such as A. hilare; Acyrthosipon spp. such as A. onobrychis, A. pisum; Adelges laricis, Adelges tsugae, Adelphocoris spp., such as A. rapidus, A. superbus; Aeneolamia spp., Agonoscena spp., Aulacorthum solani, Aleurocanthus woglumi, Aleurodes spp., Aleurodicus disperses, Aleurolobus barodensis, Aleurothrixus spp., Amrasca spp., Anasa tristis, Antestiopsis spp., Anuraphis cardui, Aonidiella spp., Aphanostigma piri, Aphidula nasturtii, Aphis spp. such as A. craccivora, A. fabae, A. forbesi, A. gossypii, A. grossulariae, A. maidiradicis, A. pomi, A. sambuci, A. schneideri, A. spiraecola; Arboridia apicalis, Arilus critatus, Aspidiella spp., Aspidiotus spp., Atanus spp., Aulacaspis yasumatsui, Aulacorthum solani, Bactericera cockerelli (Paratrioza cockerelli), Bemisia spp. such as B. argentifolii, B. tabaci (Aleurodes tabaci); Blissus spp. such as B. leucopterus; Brachycaudus spp. such as B. cardui, B. helichrysi, B. persicae, B. prunicola; Brachycolus spp., Brachycorynella asparagi, Brevicoryne brassicae, Cacopsylla spp. such as C. fulguralis, C. pyricola (Psylla piri); Calligypona marginata, Calocoris spp., Campylomma livida, Capitophorus horni, Carneocephala fulgida, Cavelerius spp., Ceraplastes spp., Ceratovacuna lanigera, Ceroplastes ceriferus, Cerosipha gossypii, Chaetosiphon fragaefolii, Chionaspis tegalensis, Chlorita onukii, Chromaphis juglandicola, Chrysomphalus ficus, Cicadulina mbila, Cimex spp. such as C. hemipterus, C. lectularius; Coccomytilus halli, Coccus spp. such as C. hesperidum, C. pseudomagnoliarum; Corythucha arcuata, Creontiades dilutus, Cryptomyzus ribis, Chrysomphalus aonidum, Cryptomyzus ribis, Ctenarytaina spatulata, Cyrtopeltis notatus, Dalbulus spp., Dasynus piperis, Dialeurodes spp. such as D. citrifolii; Dalbulus maidis, Diaphorina spp. such as D. citri; Diaspis spp. such as D. bromeliae; Dichelops furcatus, Diconocoris hewetti, Doralis spp., Dreyfusia nordmannianae, Dreyfusia piceae, Drosicha spp., Dysaphis spp. such as D. plantaginea, D. pyri, D. radicola; Dysaulacorthum pseudosolani, Dysdercus spp. such as D. cingulatus, D. intermedius; Dysmicoccus spp., Edessa spp., Geocoris spp., Empoasca spp. such as E. fabae, E. solana; Epidiaspis leperii, Eriosoma spp. such as E. lanigerum, E. pyricola; Erythroneura spp., Eurygaster spp. such as E. integriceps; Euscelis bilobatus, Euschistus spp. such as E. heros, E. impictiventris, E. servus; Fiorinia theae, Geococcus coffeae, Glycaspis brimblecombei, Halyomorpha spp. such as H. halys; Heliopeltis spp., Homalodisca vitripennis (=H. coagulata), Horcias nobilellus, Hyalopterus pruni, Hyperomyzus lactucae, Icerya spp. such as I. purchase; Idiocerus spp., Idioscopus spp., Laodelphax striatellus, Lecanium spp., Lecanoideus floccissimus, Lepidosaphes spp. such as L. ulmi; Leptocorisa spp., Leptoglossus phyllopus, Lipaphis erysimi, Lygus spp. such as L. hesperus, L. lineolaris, L. pratensis; Maconellicoccus hirsutus, Marchalina hellenica, Macropes excavatus, Macrosiphum spp. such as M. rosae, M. avenae, M. euphorbiae; Macrosteles quadrilineatus, Mahanarva fimbriolata, Megacopta cribraria, Megoura viciae, Melanaphis pyrarius, Melanaphis sacchari, Melanocallis (=Tinocallis) caryaefoliae, Metcafiella spp., Metopolophium dirhodum, Monellia costalis, Monelliopsis pecanis, Myzocallis coryli, Murgantia spp., Myzus spp. such as M. ascalonicus, M. cerasi, M. nicotianae, M. persicae, M. varians; Nasonovia ribis-nigri, Neotoxoptera formosana, Neomegalotomus spp, Nephotettix spp. such as N. malayanus, N. nigropictus, N. parvus, N. virescens; Nezara spp. such as N. viridula; Nilaparvata lugens, Nysius huttoni, Oebalus spp. such as O. pugnax; Oncometopia spp., Orthezia praelonga, Oxycaraenus hyalinipennis, Parabemisia myricae, Parlatoria spp., Parthenolecanium spp. such as P. corni, P. persicae; Pemphigus spp. such as P. bursarius, P. populivenae; Peregrinus maidis, Perkinsiella saccharicida, Phenacoccus spp. such as P. aceris, P. gossypii; Phloeomyzus passerinii, Phorodon humuli, Phylloxera spp. such as P. devastatrix, Piesma quadrata, Piezodorus spp. such as P. guildinii; Pinnaspis aspidistrae, Planococcus spp. such as P. citri, P. ficus; Prosapia bicincta, Protopulvinaria pyriformis, Psallus seriatus, Pseudacysta persea, Pseudaulacaspis pentagona, Pseudococcus spp. such as P. comstocki; Psylla spp. such as P. mali; Pteromalus spp., Pulvinaria amygdali, Pyrilla spp., Quadraspidiotus spp., such as Q. perniciosus; Quesada gigas, Rastrococcus spp., Reduvius senilis, Rhizoecus americanus, Rhodnius spp., Rhopalomyzus ascalonicus, Rhopalosiphum spp. such as R. pseudobrassicas, R. insertum, R. maidis, R. padi; Sagatodes spp., Sahlbergella singularis, Saissetia spp., Sappaphis mala, Sappaphis mali, Scaptocoris spp., Scaphoides titanus, Schizaphis graminum, Schizoneura lanuginosa, Scotinophora spp., Selenaspidus articulatus, Sitobion avenae, Sogata spp., Sogatella furcifera, Solubea insularis, Spissistilus festinus (=Stictocephala festina), Stephanitis nashi, Stephanitis pyrioides, Stephanitis takeyai, Tenalaphara malayensis, Tetraleurodes perseae, Therioaphis maculate, Thyanta spp. such as T. accerra, T. perditor; Tibraca spp., Tomaspis spp., Toxoptera spp. such as T. aurantii; Trialeurodes spp. such as T. abutilonea, T. ricini, T. vaporariorum; Triatoma spp., Trioza spp., Typhlocyba spp., Unaspis spp. such as U. citri, U. yanonensis; and Viteus vitifolii,

Insects from the order Hymenoptera for example Acanthomyops interjectus, Athalia rosae, Atta spp. such as A. capiguara, A. cephalotes, A. cephalotes, A. laevigata, A. robusta, A. sexdens, A. texana, Bombus spp., Brachymyrmex spp., Camponotus spp. such as C. floridanus, C. pennsylvanicus, C. modoc; Cardiocondyla nuda, Chalibion sp, Crematogaster spp., Dasymutilla occidentalis, Diprion spp., Dolichovespula maculata, Dorymyrmex spp., Dryocosmus kuriphilus, Formica spp., Hoplocampa spp. such as H. minuta, H. testudinea; Iridomyrmex humilis, Lasius spp. such as L. niger, Linepithema humile, Liometopum spp., Leptocybe invasa, Monomorium spp. such as M. pharaonis, Monomorium, Nylandria fulva, Pachycondyla chinensis, Paratrechina longicornis, Paravespula spp., such as P. germanica, P. pennsylvanica, P. vulgaris; Pheidole spp. such as P. megacephala; Pogonomyrmex spp. such as P. barbatus, P. californicus, Polistes rubiginosa, Prenolepis impairs, Pseudomyrmex gracilis, Schelipron spp., Sirex cyaneus, Solenopsis spp. such as S. geminata, S. invicta, S. molesta, S. richteri, S. xyloni, Sphecius speciosus, Sphex spp., Tapinoma spp. such as T. melanocephalum, T. sessile; Tetramorium spp. such as T. caespitum, T. bicarinatum, Vespa spp. such as V. crabro; Vespula spp. such as V. squamosal; Wasmannia auropunctata, Xylocopa sp;

Insects from the order Orthoptera for example Acheta domesticus, Calliptamus italicus, Chortoicetes terminifera, Ceuthophilus spp., Diastrammena asynamora, Dociostaurus maroccanus, Gryllotalpa spp. such as G. africana, G. gryllotalpa; Gryllus spp., Hieroglyphus daganensis, Kraussaria angulifera, Locusta spp. such as L. migratoria, L. pardalina; Melanoplus spp. such as M. bivittatus, M. femurrubrum, M. mexicanus, M. sanguinipes, M. spretus; Nomadacris septemfasciata, Oedaleus senegalensis, Scapteriscus spp., Schistocerca spp. such as S. ameri cana, S. gregaria, Stemopelmatus spp., Tachycines asynamorus, and Zonozerus variegatus; Pests from the Class Arachnida for example Acari, e.g. of the families Argasidae, Ixodidae and Sarcoptidae, such as Amblyomma spp. (e.g. A. americanum, A. variegatum, A. maculatum), Argas spp. such as A. persicu), Boophilus spp. such as B. annulatus, B. decoloratus, B. microplus, Dermacentor spp. such as D. silvarum, D. andersoni, D. variabilis, Hyalomma spp. such as H. truncatum, Ixodes spp. such as I. ricinus, I. rubicundus, I. scapularis, I. holocyclus, I. pacificus, Rhipicephalus sanguineus, Ornithodorus spp. such as O. moubata, O. hermsi, O. turicata, Ornithonyssus bacoti, Otobius megnini, Dermanyssus gallinae, Psoroptes spp. such as P. ovis, Rhipicephalus spp. such as R. sanguineus, R. appendiculatus, Rhipicephalus evertsi, Rhizoglyphus spp., Sarcoptes spp. such as S. Scabiei; and Family Eriophyidae including Aceria spp. such as A. sheldoni, A. anthocoptes, Acallitus spp., Aculops spp. such as A. lycopersici, A. pelekassi; Aculus spp. such as A. schlechtendali; Colomerus vitis, Epitrimerus pyri, Phyllocoptruta oleivora; Eriophytes ribis and Eriophyes spp. such as Eriophyes sheldoni; Family Tarsonemidae including Hemitarsonemus spp., Phytonemus pallidus and Polyphagotarsonemus latus, Stenotarsonemus spp. Steneotarsonemus spinki; Family Tenuipalpidae including Brevipalpus spp. such as B. phoenicis; Family Tetranychidae including Eotetranychus spp., Eutetranychus spp., Oligonychus spp., Petrobia latens, Tetranychus spp. such as T. cinnabarinus, T. evansi, T. kanzawai, T, pacificus, T. phaseulus, T. telarius and T. urticae; Bryobia praetiosa; Panonychus spp. such as P. ulmi, P. citri; Metatetranychus spp. and Oligonychus spp. such as O. pratensis, O. perseae, Vasates lycopersici; Raoiella indica, Family Carpoglyphidae including Carpoglyphus spp.; Penthaleidae spp. such as Halotydeus destructor; Family Demodicidae with species such as Demodex spp.; Family Trombicidea including Trombicula spp.; Family Macronyssidae including Ornothonyssus spp.; Family Pyemotidae including Pyemotes tritici; Tyrophagus putrescentiae; Family Acaridae including Acarus siro; Family Araneida including Latrodectus mactans, Tegenaria agrestis, Chiracanthium sp, Lycosa sp Achaearanea tepidariorum and Loxosceles reclusa;

Pests from the Phylum Nematoda, for example, plant parasitic nematodes such as root-knot nematodes, Meloidogyne spp. such as M. hapla, M. incognita, M. javanica; cyst-forming nematodes, Globodera spp. such as G. rostochiensis; Heterodera spp. such as H. avenae, H. glycines, H. schachtii, H. trifolii; Seed gall nematodes, Anguina spp.; Stem and foliar nematodes, Aphelenchoides spp. such as A. besseyi; Sting nematodes, Belonolaimus spp. such as B. longicaudatus; Pine nematodes, Bursaphelenchus spp. such as B. lignicolus, B. xylophilus; Ring nematodes, Criconema spp., Criconemella spp. such as C. xenoplax and C. ornata; and, Criconemoides spp. such as Criconemoides informis; Mesocriconema spp.; Stem and bulb nematodes, Ditylenchus spp. such as D. destructor, D. dipsaci; Awl nematodes, Dolichodorus spp.; Spiral nematodes, Heliocotylenchus multicinctus; Sheath and sheathoid nematodes, Hemicycliophora spp. and Hemicriconemoides spp.; Hirshmanniella spp.; Lance nematodes, Hoploaimus spp.; False rootknot nematodes, Nacobbus spp.; Needle nematodes, Longidorus spp. such as L. elongatus; Lesion nematodes, Pratylenchus spp. such as P. brachyurus, P. neglectus, P. penetrans, P. curvitatus, P. goodeyi; Burrowing nematodes, Radopholus spp. such as R. similis; Rhadopholus spp.; Rhodopholus spp.; Reniform nematodes, Rotylenchus spp. such as R. robustus, R. reniformis; Scutellonema spp.; Stubby-root nematode, Trichodorus spp. such as T. obtusus, T. primitivus; Paratrichodorus spp. such as P. minor; Stunt nematodes, Tylenchorhynchus spp. such as T. claytoni, T. dubius; Citrus nematodes, Tylenchulus spp. such as T. semipenetrans; Dagger nematodes, Xiphinema spp.; and other plant parasitic nematode species;

Insects from the order Isoptera for example Calotermes flavicollis, Coptotermes spp. such as C. formosanus, C. gestroi, C. acinaciformis; Cornitermes cumulans, Cryptotermes spp. such as C. brevis, C. cavifrons; Globitermes sulfureus, Heterotermes spp. such as H. aureus, H. longiceps, H. tenuis; Leucotermes flavipes, Odontotermes spp., Incisitermes spp. such as I. minor, I. Snyder; Marginitermes hubbardi, Mastotermes spp. such as M. darwiniensis Neocapritermes spp. such as N. opacus, N. parvus; Neotermes spp., Procornitermes spp., Zootermopsis spp. such as Z. angusticollis, Z. nevadensis, Reticulitermes spp. such as R. hesperus, R. tibialis, R. speratus, R. flavipes, R. grassei, R. lucifugus, R. santonensis, R. virginicus; Termes natalensis,

Insects from the order Blattaria for example Blatta spp. such as B. orientalis, B. lateralis; Blattella spp. such as B. asahinae, B. germanica; Leucophaea maderae, Panchlora nivea, Periplaneta spp. such as P. americana, P. australasiae, P. brunnea, P. fuligginosa, P. japonica; Supella longipalpa, Parcoblatta pennsylvanica, Eurycotis floridana, Pycnoscelus surinamensis,

Insects from the order Siphonoptera for example Cediopsylla simples, Ceratophyllus spp., Ctenocephalides spp. such as C. felis, C. canis, Xenopsylla cheopis, Pulex irritans, Trichodectes canis, Tunga penetrans, and Nosopsyllus fasciatus,

Insects from the order Thysanura for example Lepisma saccharina, Ctenolepisma urbana, and Thermobia domestica,

Pests from the class Chilopoda for example Geophilus spp., Scutigera spp. such as Scutigera coleoptrata;

Pests from the class Diplopoda for example Blaniulus guttulatus, Julus spp., Narceus spp.,

Pests from the class Symphyla for example Scutigerella immaculata,

Insects from the order Dermaptera, for example Forficula auricularia,

Insects from the order Collembola, for example Onychiurus spp., such as Onychiurus armatus,

Pests from the order Isopoda for example, Armadillidium vulgare, Oniscus asellus, Porcellio scaber,

Insects from the order Phthiraptera, for example Damalinia spp., Pediculus spp. such as Pediculus humanus capitis, Pediculus humanus corporis, Pediculus humanus humanus; Pthirus pubis, Haematopinus spp. such as Haematopinus eurysternus, Haematopinus suis; Linognathus spp. such as Linognathus vituli; Bovicola bovis, Menopon gallinae, Menacanthus stramineus and Solenopotes capillatus, Trichodectes spp.,

Examples of further pest species which may be controlled by compounds of formula (I) include: from the Phylum Mollusca, class Bivalvia, for example, Dreissena spp.; class Gastropoda, e.g., Arion spp., Biomphalaria spp., Bulinus spp., Deroceras spp., Galba spp., Lymnaea spp., Oncomelania spp., Pomacea canaliclata, Succinea spp.; from the class of the helminths, for example, Ancylostoma duodenale, Ancylostoma ceylanicum, Acylostoma braziliensis, Ancylostoma spp., Ascaris lumbricoides, Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp. such as Haemonchus contortus; Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercora lis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti.

The tested compounds of formula IA wherein R^{2b} and R^{2c} are F and Cl, resp., are listed in Table C.1, these compounds correspond to formula IAA

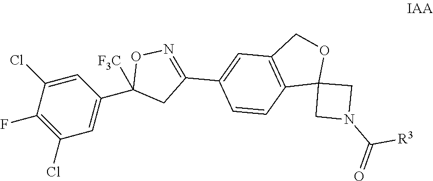

The compounds were characterized by HPLC: HPLC Phenomenex Kinetex 1.7 μm XB-C18 100A, 50×2.1 mm″, Mobile Phase: A: water+0.1% TFA; B: CAN; Temperature: 60° C.; Gradient: 5% B to 100% B in 1.50 min; 100% B 0.25 min; Flow: 0.8 ml/min to 1.0 ml/min in 1.51 min; MS method: ESI positive; Mass range (m/z): 100-700″

TABLE C.1

| Com- | | HPLC | M + H |
|---|---|---|---|
| pound | R³ | Rt [min] | [m/z] |
| I-1 | C₂H₅ | 1.313 | 517.0 |
| I-2 | CH₂S(O)₂CH₃ | 1.244 | 581.0 |
| I-3 | CH₃ | 1.289 | 503.0 |
| I-4 | 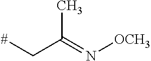 | 1.392 | 574.0 |
| I-5 | 1-CN-c-C₃H₄ | 1.403 | 554.0 |
| I-6 | CH₂SCH₃ | 1.371 | 549.0 |
| I-7 | CH₂SCH₂CH₃ | 1.412 | 563.0 |
| I-8 | CH₂SO₂CH₂CH₃ | 1.347 | 549.4 |
| I-9 | CH₂S(O)CH₂CH₃ | 1.278 | 579.4 |
| I-10 | CH₂S(O)CH₃ | 1.226 | 565.1 |
| I-11 | CH₂CH₂CH₃ | 1.393 | 531.1 |
| I-12 | c-C₃H₅ | 1.367 | 529.0 |
| I-13 | CH(CH₃)₂ | 1.391 | 531.1 |
| I-14 | pyrazin-2-yl | 1.372 | 567.1 |
| I-15 | pyrimidin-5-yl | 1.308 | 567.1 |
| I-16 | 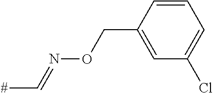 | 1.554 | 657.8 |
| I-17 | 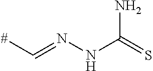 | 1.252 | 590.1 |
| I-18 | 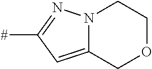 | 1.349 | 611.1 |
| I-19 | 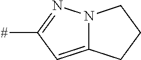 | 1.388 | 595.1 |
| I-20 | 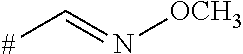 | 1.411 | 545.8 |
| I-21 | CH₂CF₃ | 1.390 | 571.1 |

II. Evaluation of Pesticidal Activity:

The activity of the compounds of formula I of the present invention was demonstrated and evaluated by the following biological tests.

B.1 Diamond Back Moth (Plutella xylostella)

The active compound was dissolved at the desired concentration in a mixture of 1:1 (vol:vol) distilled water:aceteone. Surfactant (Kinetic HV) was added at a rate of 0.01% (vol/vol). The test solution was prepared at the day of use. Leaves of cabbage were dipped in test solution and air-dried. Treated leaves were placed in petri dishes lined with moist filter paper and inoculated with ten 3^{rd} instar larvae. Mortality was recorded 72 hours after treatment. Feeding damages were also recorded using a scale of 0-100%.

In this test, the compounds I-1, I-2, I-3, I-4, I-5, I-6, I-7, I-8, I-9, I-10, I-11, I-12, I-13, I-14, I-15, I-16, I-17, I-18, I-19, I-20 at 300 ppm, respectively, showed a mortality of at least 75% in comparison with untreated controls.

B.2 Green Peach Aphid (Myzus persicae)

For evaluating control of green peach aphid (Myzus persicae) through systemic means the test unit consisted of 96-well-microtiter plates containing liquid artificial diet under an artificial membrane. The compounds were formulated using a solution containing 75% v/v water and 25% v/v DMSO. Different concentrations of formulated compounds were pipetted into the aphid diet, using a custom built pipetter, at two replications. After application, 5-8 adult aphids were placed on the artificial membrane inside the microtiter plate wells. The aphids were then allowed to suck on the treated aphid diet and incubated at about 23±1° C. and about 50±5% relative humidity for 3 days. Aphid mortality and fecundity was then visually assessed.

In this test, the compounds I-1, I-2, I-3, I-4, I-5, I-6, I-7, I-8, I-9, I-10, I-11, I-12, I-13, I-14, I-15, I-17, I-18, I-19, I-20 at 2500 ppm, respectively, showed a mortality of at least 75% in comparison with untreated controls.

B.3 Vetch Aphid (Megoura viciae)

For evaluating control of vetch aphid (Megoura viciae) through contact or systemic means the test unit consisted of 24-well-microtiter plates containing broad bean leaf disks. The compounds were formulated using a solution containing 75% v/v water and 25% v/v DMSO. Different concentrations of formulated compounds were sprayed onto the leaf disks at 2.5 μl, using a custom built micro atomizer, at two replications. After application, the leaf disks were air-dried and 5-8 adult aphids placed on the leaf disks inside the microtiter plate wells. The aphids were then allowed to suck on the treated leaf disks and incubated at about 23±1° C. and about 50±5% relative humidity for 5 days. Aphid mortality and fecundity was then visually assessed.

In this test, the compounds I-1, I-2, I-3, I-4, I-5, I-6, I-7, I-8, I-9, I-10, I-11, I-12, I-13, I-14, I-15, I-19, I-20 at 2500 ppm, respectively, showed a mortality of at least 75% in comparison with untreated controls.

B.4 Tobacco Budworm (Heliothis virescens)

For evaluating control of tobacco budworm (Heliothis virescens) the test unit consisted of 96-well-microtiter plates containing an insect diet and 15-25 H. virescens eggs. The compounds were formulated using a solution containing 75% v/v water and 25% v/v DMSO. Different concentrations of formulated compounds were sprayed onto the insect diet at 10 μl, using a custom built micro atomizer, at two replications. After application, microtiter plates were incubated at about 28±1° C. and about 80±5% relative humidity for 5 days. Egg and larval mortality was then visually assessed.

In this test, the compounds I-1, I-2, I-3, I-4, I-5, I-6, I-7, I-8, I-9, I-10, I-11, I-12, I-13, I-14, I-15, I-16, I-17, I-18, I-19, I-20 at 2500 ppm, respectively, showed a mortality of at least 75% in comparison with untreated controls.

B.5 Boll Weevil (Anthonomus grandis)

For evaluating control of boll weevil (Anthonomus grandis) the test unit consisted of 96-well-microtiter plates containing an insect diet and 5-10 A. grandis eggs. The compounds were formulated using a solution containing 75% v/v water and 25% v/v DMSO. Different concentrations of formulated compounds were sprayed onto the insect diet at 5 μl, using a custom built micro atomizer, at two replications. After application, microtiter plates were incubated at about 25±1° C. and about 75±5% relative humidity for 5 days. Egg and larval mortality was then visually assessed.

In this test, the compounds I-1, I-2, I-3, I-4, I-5, I-6, I-7, I-8, I-9, I-10, I-11, I-12, I-13, I-14, I-15, I-16, I-17, I-18, I-19, I-20 at 2500 ppm, respectively, showed a mortality of at least 75% in comparison with untreated controls.

B.6 Mediterranean Fruitfly (Ceratitis capitata)

For evaluating control of Mediterranean fruitfly (Ceratitis capitata) the test unit consisted of microtiter plates containing an insect diet and 50-80 C. capitata eggs. The compounds were formulated using a solution containing 75% v/v water and 25% v/v DMSO. Different concentrations of formulated compounds were sprayed onto the insect diet at 5 μl, using a custom built micro atomizer, at two replications. After application, microtiter plates were incubated at about 28±1° C. and about 80±5% relative humidity for 5 days. Egg and larval mortality was then visually assessed.

In this test, the compounds I-1 and 1-2 at 2500 ppm, respectively, showed a mortality of at least 75% in comparison with untreated controls.

B.7 Orchid thrips (Dichromothrips corbetti)

Dichromothrips corbetti adults used for bioassay were obtained from a colony maintained continuously under laboratory conditions. For testing purposes, the test compound is diluted in a 1:1 mixture of acetone:water (vol:vol), plus Kinetic HV at a rate of 0.01% v/v. Thrips potency of each compound was evaluated by using a floral-immersion technique. All petals of individual, intact orchid flowers were dipped into treatment solution and allowed to dry in Petri dishes. Treated petals were placed into individual re-sealable plastic along with about 20 adult thrips. All test arenas were held under continuous light and a temperature of about 28° C. for duration of the assay. After 3 days, the numbers of live thrips were counted on each petal. The percent mortality was recorded 72 hours after treatment.

In this test, the compounds I-1, I-2, I-3, I-4, I-5, I-6, I-7, I-8, I-9, I-10, I-11, I-12, I-13, I-14, I-15, I-16, I-17, I-18, I-19, I-20 at 300 ppm, respectively, showed a mortality of at least 75% in comparison with untreated controls.

B.8 Rice Green Leafhopper (Nephotettix virescens)

Rice seedlings were cleaned and washed 24 hours before spraying. The active compounds were formulated in 1:1 acetone:water (vol:vol), and 0.01% vol/vol surfactant (Kinetic HV) was added. Potted rice seedlings were sprayed with 5-6 ml test solution, air dried, covered with Mylar cages cages and inoculated with 10 adults. Treated rice plants were kept at about 28-29° C. and relative humidity of about 50-60%. Percent mortality was recorded after 72 hours.

In this test, the compounds I-1, I-2, I-3, I-4, I-5, I-6, I-7, I-8, I-9, I-10, I-11, I-12, I-13, I-14, I-15, I-16, I-20 at 300 ppm, respectively, showed a mortality of at least 75% in comparison with untreated controls.

B.9 Red Spider Mite (Tetranychus kanzawai)

The active compound was dissolved at the desired concentration in a mixture of 1:1 (vol:vol) distilled water: acetone. Add surfactant (Kinetic HV) was added at a rate of 0.01% (vol/vol). The test solution was prepared at the day of use. Potted cowpea beans of 4-5 days of age were cleaned with tap water and sprayed with 1-2 ml of the test solution using air driven hand atomizer. The treated plants were allowed to air dry and afterwards inoculated with 30 or more mites by clipping a cassava leaf section from rearing population. Treated plants were placed inside a holding room at about 25-27° C. and about 50-60% relative humidity. Percent mortality was assessed 72 hours after treatment.

In this test, the compounds I-1, I-2, I-3, I-4, I-5, I-6, I-7, I-8, I-9, I-10, I-11, I-12, I-13, I-14, I-15, I-20 at 300 ppm, respectively, showed a mortality of at least 75% in comparison with untreated controls.

B.10 Southern Armyworm (Spodoptera eridania)

The active compounds were formulated in cyclohexanone as a 10,000 ppm solution supplied in tubes. The tubes were inserted into an automated electrostatic sprayer equipped with an atomizing nozzle and they served as stock solutions for which lower dilutions were made in 50% acetone:50% water (v/v). A nonionic surfactant (Kinetic®) was included in the solution at a volume of 0.01% (v/v). Lima bean plants (variety Sieva) were grown 2 plants to a pot and selected for treatment at the 1^{st} true leaf stage. Test solutions were sprayed onto the foliage by an automated electrostatic plant sprayer equipped with an atomizing spray nozzle. The plants were dried in the sprayer fume hood and then removed from the sprayer. Each pot was placed into perforated plastic bags with a zip closure. About 10 to 11 armyworm larvae were placed into the bag and the bags zipped closed. Test plants were maintained in a growth room at about 25° C. and about 20-40% relative humidity for 4 days, avoiding direct exposure to fluorescent light (24 hour photoperiod) to prevent trapping of heat inside the bags. Mortality and reduced feeding were assessed 4 days after treatment, compared to untreated control plants.

In this test, the compounds I-1, I-2, I-3, I-5, I-6, I-7, I-8, I-9, I-11, I-12 at 10 ppm, respectively, showed a mortality of at least 75% in comparison with untreated controls.

B.11 Green Soldier Stink Bug (Nezara viridula)

The active compound was dissolved at the desired concentration in a mixture of 1:1 (vol:vol) distilled water: acetone. Surfactant (Kinetic HV) was added at a rate of 0.01% (vol/vol). The test solution was prepared at the day of use. Soybean pods were placed in glass Petri dishes lined with moist filter paper and inoculated with ten late 3rd instar N. viridula. Using a hand atomizer, approximately 2 ml solution is sprayed into each Petri dish. Assay arenas were kept at about 25° C. Percent mortality was recorded after 5 days.

In this test, the compounds 1-1, 1-2, 1-3, 1-4, 1-5, 1-6, 1-7, 1-8, 1-9, 1-10, 1-11, 1-12, 1-13, 1-15, 1-20 at 300 ppm, respectively, showed a mortality of at least 75% in comparison with untreated controls.

B.12 Neotropical Brown Stink Bug (Euschistus heros)

The active compound was dissolved at the desired concentration in a mixture of 1:1 (vol:vol) distilled water: acetone. Surfactant (Kinetic HV) was added at a rate of 0.01% (vol/vol). The test solution was prepared at the day of use. Soybean pods were placed in microwavable plastic cups and inoculated with ten adult stage E. heros. Using a hand atomizer, approximately 1 ml solution is sprayed into each cup, insects and food present. A water source was provided (cotton wick with water). Each treatment was replicated 2-fold. Assay arenas were kept at about 25° C. Percent mortality was recorded after 5 days.

In this test, the compounds 1-1, 1-3, 1-5 at 100 ppm, respectively, showed a mortality of at least 75% in comparison with untreated controls.

B.13 Brown Marmorated Stink Bug (Halyomorpha halys)

The active compound was dissolved at the desired concentration in a mixture of 1:1 (vol:vol) distilled water: acetone. Surfactant (Kinetic HV) was added at a rate of 0.01% (vol/vol). The test solution was prepared at the day of use. Row peanuts and soybean seeds were placed into microwavable plastic cups and inoculated with five adult stage H. halys. Using a hand atomizer, approximately 1 ml solution is sprayed into each cup, insects and food present. A water source was provided (cotton wick with water). Each treatment is replicated 4-fold. Assay arenas are kept at about 25° C. Percent mortality was recorded after 5 days.

In this test, the compounds 1-1, 1-2, 1-3, 1-5, 1-6, 1-7, 1-8, 1-9, 1-10, 1-11, 1-12, 1-13, 1-20 at 100 ppm, respectively, showed a mortality of at least 75% in comparison with untreated controls.

Biological Activity of Mixtures of the Invention

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 20-22):

$$E = X + Y - \frac{XY}{100}$$

When the observed combined control effect is greater than the expected combined control effect (E), then the combined effect is synergistic.

The following tests demonstrate the control efficacy of compounds, mixtures or compositions of this invention on specific pests. However, the pest control protection afforded by the compounds, mixtures or compositions is not limited to these species. In certain instances, combinations of a compound of this invention with other invertebrate pest control compounds or agents are found to exhibit synergistic effects against certain important invertebrate pests.

The analysis of synergism or antagonism between the mixtures or compositions was determined using Colby's equation.

For evaluating control of green peach aphid (Myzus persicae) through systemic means the test unit consisted of 96-well-microtiter plates containing liquid artificial diet under an artificial membrane.

The compounds or mixtures were formulated using a solution containing 75% water and 25% DMSO. Different concentrations of formulated compounds or mixtures were pipetted into the aphid diet, using a custom built pipetter, at two replications.

For experimental mixtures in these tests identical volumes of both mixing partners at the desired concentrations respectively, were mixed together.

After application, 5-8 adult aphids were placed on the artificial membrane inside the microtiter plate wells. The aphids were then allowed to suck on the treated aphid diet and incubated at 23±1° C., 50±5% RH for 3 days. Aphid mortality and fecundity was then visually assessed. For the mixture tested the results are listed below.

| Compounds | ppm | Average Control % |
|---|---|---|
| Alphacypermethrin | 10 | 0 |
| I-1 | 0.4 | 0 |
| Alphacypermethrin + I-1 | 10 + 0.4 | 75* |

*synergistic control effect according to Colby's equation

1-15. (canceled)

16. A method for controlling pests of plants, comprising the step of contacting the plant, parts of it, its propagation material, the pests, their food supply, habitat, or breeding grounds with one or more compounds of formula (I) 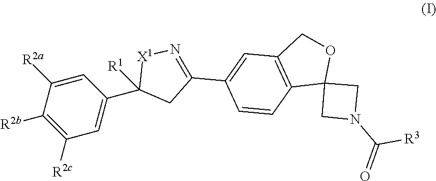
or a composition comprising one or more compounds of formula (I)
wherein
X¹ is O or CH₂;
R¹ halomethyl;
R^{2a} halogen, halomethyl, or halomethoxy;
R^{2b}, R^{2c} are independently H, or as defined for R^{2a};
R³ is selected from H, C₁-C₆-alkyl, C₁-C₆-haloalkyl, C₂-C₆-alkenyl, C₂-C₆-haloalkenyl, C₂-C₆-alkynyl, C₂-C₆-haloalkynyl which aliphatic groups are unsubstituted or substituted by one or more radicals R³¹; C₃-C₆-cycloalkyl, C₃-C₆-halocycloalkyl which cyclic groups are unsubstituted or substituted by one or more radicals R³²; C(═O)N(R³³)R³⁴, N(R³³)R³⁵, C(R³³)═NOR³⁵, C(R³³)═NN(R³³)C(=T)N(R³³)R³⁵; phenyl, 3- to 12-membered heterocyclyl, or hetaryl which rings are unsubstituted or partially or fully substituted by R^{A};
T is O, or S;
R³¹ is independently OH, cyano, C₁-C₆-alkoxy, C₁-C₆-haloalkoxy, S(O)ₙ—C₁-C₆-alkyl, S(O)ₙ—C₁-C₆-haloalkyl, C(═O)N(R³³)R³⁴, C(R³³)═NOR³⁵, C₃-C₆-cycloalkyl, or C₃-C₆-halocycloalkyl which cycles are unsubstituted or substituted by one or more R³¹¹; or
phenyl, 3- to 12-membered heterocyclyl or hetaryl which rings are unsubstituted or partially or fully substituted by R^{A};
R³¹¹ is independently OH, cyano, C₁-C₂-alkyl, or C₁-C₂-haloalkyl;
R³² C₁-C₆-alkyl, C₁-C₆-haloalkyl, or a group as defined for R³¹;
R³³ is H, or C₁-C₆-alkyl,
R³⁴ is H, C₁-C₆-alkyl, C₁-C₆-haloalkyl, C₂-C₆-alkenyl, C₂-C₆-haloalkenyl, C₂-C₆-alkynyl, C₂-C₆-haloalkynyl, or C₃-C₆-cycloalkyl, C₃-C₆-halocycloalkyl, C₃-C₆-cycloalkylmethyl, or C₃-C₆-halocycloalkylmethyl which rings are unsubstituted or substituted by a cyano;
R³⁵ H, C₁-C₆-alkyl, C₁-C₆-haloalkyl, C₂-C₄-alkenyl, C₂-C₄-alkynyl, CH₂—CN, C₃-C₆-cycloalkyl, C₃-C₆-halocycloalkyl, C₃-C₆-cycloalkylmethyl, C₃-C₆-halocycloalkylmethyl, phenyl, hetaryl, and hetarylmethyl which aromatic rings are unsubstituted or partially or fully substituted by R^{A};
R^{A} is independently selected from halogen, cyano, NO₂, C₁-C₄-alkyl, C₁-C₄-haloalkyl, C₂-C₄-alkenyl, C₂-C₄-haloalkenyl, C₂-C₄-alkynyl, C₂-C₄-haloalkynyl, C₃-C₆-cycloalkyl, C₃-C₆-halocycloalkyl, C₁-C₄-alkoxy, C₁-C₄-haloalkoxy, S(O)ₙ—C₁-C₄-alkyl, S(O)ₙ—C₁-C₄-haloalkyl, C₁-C₄-alkylcarbonyl, C₁-C₄-haloalkylcarbonyl, C(═O)N(R³³)R³⁴; or
two R^{A} present on the same carbon atom of a saturated or partially saturated ring may form together ═O or ═S; or
two R^{A} present on the same S or SO ring member of a heterocyclic ring may together form a group ═N(C₁-C₆-alkyl), ═NO(C₁-C₆-alkyl), ═NN(H)(C₁-C₆-alkyl) or ═NN(C₁-C₆-alkyl)₂;
or an N-oxide, stereoisomer or an agriculturally acceptable salt thereof.

17. The method according to claim 16, wherein the compounds of formula I are present in form of a mixture of compounds I.A and I.B, where compound I.A is present in an amount of more than 50% by weight, based on the total weight of compounds I.A and I.B.

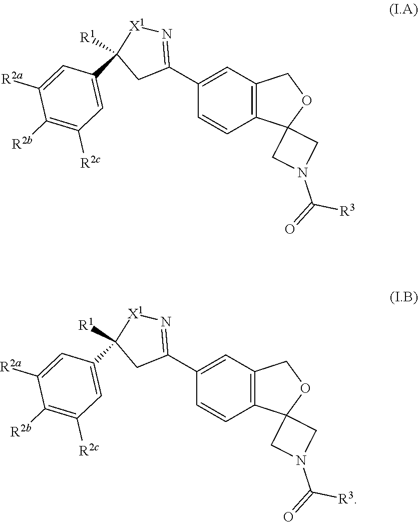

18. The method according to claim 16, wherein X¹ is O.

19. The method according to claim 16, wherein X¹ is CH₂.

20. The method according to claim 16, wherein in formula I
R¹ is CF₃;
R^{2a} is F, Cl, Br, CF₃ or OCF₃;
R^{2b} is H, F, Cl, Br, CF₃ or OCF₃;
R^{2c} is H, F, Cl, Br, CF₃ or OCF₃; and
R³ is selected from C₁-C₃-alkyl, CH₂CF₃, CH₂CH₂CF₃, CH₂OH, CH₂-c-C₃H₅; cyclopropyl,
1-CN-c-C₃H₄, 1-CF₃-c-C₃H₄, 1-OH-c-C₃H₄, 2,2, —F₂-c-C₃H₃, CH₂-c-C₃H₅, CH₂OCH₃, CH₂OC₂H₅, CH₂OCF₃, CH₂OCH₂CF₃, CH₂SOₙCH₃, CH₂SOₙC₂H₅, wherein n is 0, 1, or 2; CH₂C(CH₃)═N—OCH₃, C(R^{35a})═NN(R^{35a})C(=T)N(R^{35a})R^{35a}, CH═N—OR^{35a}, wherein R^{35a} is C₁-C₃-alkyl, or benzyl substituted with halogen; 1-pyrazolyl, 6,7-dihydro-4H-pyrazolo[5, 1-c][1,4]oxazine, 5,6-dihydro-4H-pyrrolo[1,2-b]pyrazole, 3-CH₃-1-pyrazolyl, 2-pyrazinyl,
2-pyridyl, 5-pyrimidinyl, 3-thietan-yl, 3-thietan-yl-S-oxide, and 3-thietan-yl-S-dioxide.

21. A method for controlling pests of plants, comprising the step of contacting the plant, parts of it, its propagation material, the pests, their food supply, habitat or breeding grounds with the composition comprising compound of formula I as defined in claim 16 and one or more other pesticides.

22. The method according to claim 21, wherein the other pesticides are selected from the class of pyrethroids.

23. The method according to claim 21, wherein the other pesticides are selected from lambda cyhalothrin, alpha-cypermethrin, bifenthrin, afidopyropen, broflanilide, flubendiamide, chlorfenapyr, ethiprole, dinotefuran, sulfoxaflor, clothianidin, thiacloprid, flupyradifuron, imidacloprid, fipronil, ivermectin, abamectin, spinosad, thiamethoxam, pyriprole, deltamethrin, metaflumizone, amitraz, avermectin, emamectin, ecdysone, tebufenozide, buprofezin, teflubenzuron, chlorantraniliprole, cyantraniliprole, tetraniliprole, cyclaniliprole, flonicamid, pymetrozine and spirotetramat.

24. The method according to claim 16, wherein the compounds of formula I or a composition comprising the compound of formula I are applied in an amount of from 1 to 500 g/ha.

25. The method according to claim 16, wherein the plant is a soybean plant.

26. The method according to claim 16, wherein the pests are selected from Plutella spp., Myzus spp., Megoura spp., Heliothis spp., Anthonomus spp., Ceratitis spp., Dichromothrips ssp., Nephotettix spp., Tetranychus spp., Spodoptera spp., Nezara spp., Euschistus spp., and Halyomorpha spp.

27. The method according to claim 16, wherein the pests are selected from aphids, and stink bugs.

28. The method according to claim 16 for protecting plant propagation material.

29. Plant propagation material coated with or containing at least a compound of formula I as defined in claim 16 in an amount of from 0.1 g to 10 kg per 100 kg.

30. The method according to claim 26, wherein the compounds of formula I are present in form of a mixture of compounds I.A and I.B, where compound I.A is present in an amount of more than 50% by weight, based on the total weight of compounds I.A and I.B.

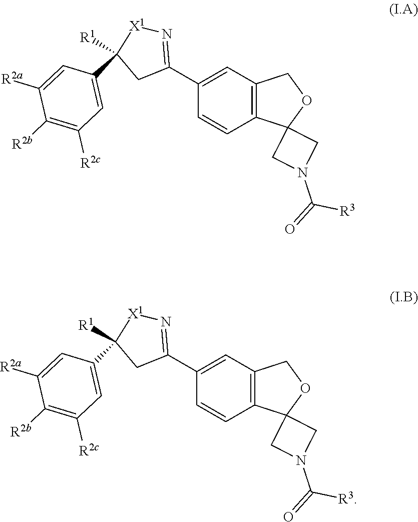

31. The method according to claim 26, wherein X¹ is O.

32. The method according to claim 26, wherein X¹ is CH₂.

33. The method according to claim 26, wherein in formula I
R¹ is CF₃;
R^{2a} is F, Cl, Br, CF₃ or OCF₃;
R^{2b} is H, F, Cl, Br, CF₃ or OCF₃;
R^{2c} is H, F, Cl, Br, CF₃ or OCF₃; and
R³ is selected from C₁-C₃-alkyl, CH₂CF₃, CH₂CH₂CF₃, CH₂OH, CH₂-c-C₃H₅; cyclopropyl,
1-CN-c-C₃H₄, 1-CF₃-c-C₃H₄, 1-OH-c-C₃H₄, 2,2, —F₂-c-C₃H₃, CH₂-c-C₃H₅, CH₂OCH₃, CH₂OC₂H₅, CH₂OCF₃, CH₂OCH₂CF₃, CH₂SOₙCH₃, CH₂SOₙC2H₅, wherein n is 0, 1, or 2; CH₂C(CH₃)═N—OCH₃, C(R^{35a})═NN(R^{35a})C(=T)N(R^{35a})R^{35a}, CH═N—OR^{35a}, wherein R^{35a} is C₁-C₃-alkyl, or benzyl substituted with halogen; 1-pyrazolyl, 6,7-dihydro-4H-zolyl, 2-pyrazinyl,
2-pyridyl, 5-pyrimidinyl, 3-thietan-yl, 3-thietan-yl-S-oxide, and 3-thietan-yl-S-dioxide.
